(19) United States
(12) Patent Application Publication
(10) Pub. No.: US 2018/0034736 A1
(43) Pub. Date: Feb. 1, 2018

(54) DIFFERENTIAL SCHEDULING FOR REAL-TIME COMMUNICATION SERVICES

(71) Applicant: QUALCOMM Incorporated, San Diego, CA (US)

(72) Inventors: Kirankumar Bhoja Anchan, San Diego, CA (US); Srinivasan Balasubramanian, San Diego, CA (US)

(21) Appl. No.: 15/660,841

(22) Filed: Jul. 26, 2017

Related U.S. Application Data
(60) Provisional application No. 62/368,093, filed on Jul. 28, 2016.
(60) Provisional application No. 62/368,144, filed on Jul. 28, 2016.

(51) Int. Cl. H04L 12/851; H04L 12/801; H04L 12/927

(52) U.S. Cl. CPC H04L 47/24; H04L 47/805; H04L 47/14; H04L 47/125

(57) ABSTRACT

Methods, systems, and devices for wireless communication are described that provide for scheduling different types of traffic within a data flow, and providing a different coverage enhancement (CE) levels for the different types of traffic. Lower priority traffic within the IP flow may be scheduled with a lower CE level and higher priority traffic within the data flow may be scheduled with a higher CE level. In some cases, the CE levels may be selected to allow for a delay budget that supports real-time communications, such as a voice over LTE (VoLTE) real-time voice communications for bandwidth limited devices or devices that are bandwidth unrestricted but having poor channel conditions.

### CROSS REFERENCES

The present application for patent claims priority to U.S. Provisional Patent Application No. 62/368,093 by Anchan, et al., entitled “Differential Scheduling For Real-Time Communication Services,” filed Jul. 28, 2016, assigned to the assignee hereof and to U.S. Provisional Patent Application No. 62/368,144 by Anchan, et al., entitled “Voice Activity Based Half-Duplex Calling,” filed Jul. 28, 2016, assigned to the assignee hereof, the entire contents of each of which is expressly incorporated herein by reference.

### BACKGROUND

The following relates generally to wireless communication, and more specifically to differential scheduling for real-time communication services.

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include code division multiple access (CDMA) systems, time division multiple access (TDMA) systems, frequency division multiple access (FDMA) systems, and orthogonal frequency division multiple access (OFDMA) systems, (e.g., a Long Term Evolution (LTE) system). A wireless multiple-access communications system may include a number of base stations, each simultaneously supporting communication for multiple communication devices, which may be otherwise known as user equipment (UE).

Some types of wireless devices may provide for automated communication. Automated wireless devices may include those implementing Machine-to-Machine (M2M) communication or Machine Type Communication (MTC). M2M or MTC may refer to data communication technologies that allow devices to communicate with one another or a base station without human intervention. For example, M2M or MTC may refer to communications from devices that integrate sensors or meters to measure or capture information and relay that information to a central server or application program that can make use of the information or present the information to humans interacting with the program or application.

MTC devices may be used to collect information or enable automated behavior of machines. Examples of applications for MTC devices include smart metering, inventory monitoring, water level monitoring, equipment monitoring, healthcare monitoring, alarm panels, control panels, wearable devices, weather and geological event monitoring, fleet management and tracking, remote security sensing, physical access control, and transaction-based business charging, to name a few non-exhaustive examples.

Some wireless communications systems may employ coverage enhancement (CE) techniques that increase system robustness. There may be different levels of coverage enhancement such that higher level coverage enhancement provide more reliable communications, particularly for devices that are located relatively far away from a base station or in locations where wireless transmissions are relatively highly attenuated (e.g., in a basement location), relative to lower level coverage enhancements. In many cases, CE relies on repetition of transmissions, which may impact timelines for transmitting and processing certain types of communications.

### SUMMARY

The described techniques relate to improved methods, systems, devices, or apparatuses that support differential scheduling for real-time communication services. Generally, the described techniques provide for scheduling different types of traffic within a single data flow (e.g., an IP flow), and providing a different coverage enhancement (CE) levels for the different types of traffic. Lower priority traffic within the IP flow may be scheduled with a lower CE level and higher priority traffic within the IP flow may be scheduled with a higher CE level. In some cases, the CE levels may be selected to allow for a delay budget that supports real-time communications, such as a voice over LTE (VoLTE) real-time voice communications for bandwidth limited devices or devices that are bandwidth unrestricted but having poor channel conditions.

The described techniques also relate to improved methods, systems, devices, or apparatuses that support voice activity based half-duplex calling. Generally, the described techniques may provide for initiating a voice call, transmitting one or more voice packets associated with the voice call, detecting the commencement of a silence period, and transitioning to a discontinuous transmission mode for the voice call when the commencement of the silence period is detected. During the silence period, transmission may be skipped for one or more non-voice frames (e.g., a silence indicator description (SID) frame or a real-time transport control protocol (RTCP) frame), thus reducing the need for the device transmit such non-voice frames. A receiving device may determine that the transmissions of the non-voice frames have been skipped, and may adjust one or more receive algorithms to account for the skipped frames.

A method of wireless communication is described. The method may include identifying a data flow containing real-time data, identifying traffic within the data flow with a first priority level and traffic within the data flow with a second priority level, the second priority level being greater than the first priority level, setting a first coverage enhancement level of the traffic with the first priority level to be lower than a second coverage enhancement level of the traffic with the second priority level, and transmitting data for the data flow based at least in part on the first coverage enhancement level and the second coverage enhancement level.

An apparatus for wireless communication is described. The apparatus may include means for identifying a data flow containing real-time data, means for identifying traffic within the data flow with a first priority level and traffic within the data flow with a second priority level, the second priority level being greater than the first priority level, means for setting a first coverage enhancement level of the traffic with the first priority level to be lower than a second coverage enhancement level of the traffic with the second priority level, and means for transmitting data for the data flow based at least in part on the first coverage enhancement level and the second coverage enhancement level.

Another apparatus for wireless communication is described. The apparatus may include a processor, memory in electronic communication with the processor, and instructions stored in the memory. The instructions may be operable to cause the processor to identify a data flow containing real-time data, identify traffic within the data flow with a first priority level and traffic within the data flow with a second priority level, the second priority level being greater than the first priority level, set a first coverage enhancement level of the traffic with the first priority level to be lower than a second coverage enhancement level of the traffic with the second priority level, and transmit data for the data flow based at least in part on the first coverage enhancement level and the second coverage enhancement level.

A non-transitory computer readable medium for wireless communication is described. The non-transitory computer-readable medium may include instructions operable to cause a processor to identify a data flow containing real-time data, identify traffic within the data flow with a first priority level and traffic within the data flow with a second priority level, the second priority level being greater than the first priority level, set a first coverage enhancement level of the traffic with the first priority level to be lower than a second coverage enhancement level of the traffic with the second priority level, and transmit data for the data flow based at least in part on the first coverage enhancement level and the second coverage enhancement level.

In some examples of the method, apparatus, and non-transitory computer-readable medium described above, the real-time data comprises voice data and wherein the traffic with the first priority level within the data flow comprises non-voice data and the traffic with the second priority level within the data flow comprises voice data.

In some examples of the method, apparatus, and non-transitory computer-readable medium described above, the traffic with the first priority level comprises one or more of a SID packet, RTCP data, or in-call signaling.

In some examples of the method, apparatus, and non-transitory computer-readable medium described above, the setting the first coverage enhancement level comprises: identifying one or more of an amount of other traffic other than the data for the data flow or a non-voice data metric based at least in part on one or more of: a packet size of the non-voice data, a differentiated services code point (DSCP) value of the non-voice data, deep packet inspection and finding a match with a partial set of data to deduce the presence of non-voice data, or an out-of-band indication from one or more upper layers of a protocol stack or an application layer. In some examples of the method, apparatus, and non-transitory computer-readable medium described above, one or more of: a quality-of-service class identifier (QCI), a UE category, an access point name (APN), an IP address, an IP subnet associated with the non-voice data, a SID packet, RTCP data, or in-call signaling. Some examples of the method, apparatus, and non-transitory computer-readable medium described above may further include processes, features, means, or instructions for setting the first coverage enhancement level based at least in part on the identified amount of other traffic or the non-voice data metric and for setting a DSCP value in at least one packet of the traffic within the data flow to indicate that the at least one packet comprises the traffic with the first priority level.

In some examples of the method, apparatus, and non-transitory computer-readable medium described above, the first coverage enhancement level may have a lower number of repetitions than the second coverage enhancement level. In some examples of the method, apparatus, and non-transitory computer-readable medium described above, the repetition may be achieved via transmission time interval (TTI) bundling schedule-based repetition or a Hybrid Automatic Repeat Request (HARQ) retransmission schedule. In some examples of the method, apparatus, and non-transitory computer-readable medium described above, the first coverage enhancement level allows the traffic with the second priority level within the data flow to have a higher likelihood of meeting timelines for voice data service.

Some examples of the method, apparatus, and non-transitory computer-readable medium described above may further include processes, features, means, or instructions for detecting a silence period or a commencement of a silence period in the voice data in a first direction and a talk period in the voice data in a second direction. Some examples of the method, apparatus, and non-transitory computer-readable medium described above may further include processes, features, means, or instructions for transitioning to a discontinuous transmission mode based at least in part on detecting the silence period.

In some examples of the method, apparatus, and non-transitory computer-readable medium described above, the detecting a silence period comprises: detecting one or more packets having a specific DSCP value that indicates the one or more packets belong to the data flow associated with the voice call, or having one or more of a specific QCI, or a specific APN, or finding a match with a partial set of data to deduce the presence of the non-voice data, or an out-of-band indication from one or more upper layers of a protocol stack or an application layer.

In some examples of the method, apparatus, and non-transitory computer-readable medium described above, may further include processes, features, means, or instructions for signaling that one or more SID packets may be omitted upon detecting the silence period, where the transitioning to the discontinuous transmission mode comprises: discontinuing periodic transmissions of one or more of a SID packet or a RTCP packet and skipping a scheduling request (SR) transmission.

In some examples of the method, apparatus, and non-transitory computer-readable medium described above, may further include processes, features, means, or instructions for dropping one or more packets of the first priority level in the first direction or the second direction based at least in part on detecting the silence period.

In some examples of the method, apparatus, and non-transitory computer-readable medium described above, may further include processes, features, means, or instructions for dropping one or more packets in the first direction or the second direction having a packet size that is below a threshold value based at least in part on detecting the silence period.

Some examples of the method, apparatus, and non-transitory computer-readable medium described above may further include processes, features, means, or instructions for detecting, following the detecting of the silence period, a talk period in the voice data. Some examples of the method, apparatus, and non-transitory computer-readable medium described above may further include processes, features, means, or instructions for transitioning to a transmit/receive mode from the discontinuous transmission mode. Some examples of the method, apparatus, and non-transitory computer-readable medium described above may further include processes, features, means, or instructions for resuming transmitting the voice data.

Some examples of the method, apparatus, and non-transitory computer-readable medium described above may further include processes, features, means, or instructions for determining, based at least in part on one or more of ongoing communication with a base station or on a measured channel quality that the voice call may be to be maintained in an absence of receiving one or more packets from the base station for a predetermined time period as a result of the discontinuous transmission mode during the voice call. Some examples of the method, apparatus, and non-transitory computer-readable medium described above may further include processes, features, means, or instructions for determining that a SID packet is omitted from a plurality of received voice packets and for adjusting an inactivity timer to account for the omitted SID packet. Some examples of the method, apparatus, and non-transitory computer-readable medium described above may further include processes, features, means, or instructions for generating comfort noise based at least in part on the determining that the SID packet may be omitted from the received voice packets.

Some examples of the method, apparatus, and non-transitory computer-readable medium described above may further include processes, features, means, or instructions for receiving a semi-persistent scheduling (SPS) resource allocation for transmitting the voice data. Some examples of the method, apparatus, and non-transitory computer-readable medium described above may further include processes, features, means, or instructions for transmitting, based at least in part on detecting the silence period, an indicator in an SPS uplink transmission that the SPS resource allocation can be released. Some examples of the method, apparatus, and non-transitory computer-readable medium described above may further include processes, features, means, or instructions for receiving a release of the SPS resource allocation. Some examples of the method, apparatus, and non-transitory computer-readable medium described above may further include processes, features, means, or instructions for transmitting a null data indication in a buffer status report (BSR) based at least in part on detecting the silence period.

Some examples of the method, apparatus, and non-transitory computer-readable medium described above may further include processes, features, means, or instructions for identifying a simultaneous talk period in the voice data and dropping one or more of voice packets of the voice data in a first direction or a second direction based at least in part on detecting the simultaneous talk period.

In some examples of the method, apparatus, and non-transitory computer-readable medium described above, the dropping one or more of voice packets is based at least in part on one or more of: a specific differentiated services code point (DSCP) value indicating which voice packets to drop, a prioritization of voice packets in the first direction relative to voice packets in the second direction for at least one period of time, a proportion of voice packets in the first direction relative to voice packets in the second direction, and a random selection of voice packets.

Some examples of the method, apparatus, and non-transitory computer-readable medium described above may further include processes, features, means, or instructions for adjusting an expected reception time of a RTCP data packet or a SID packet based at least in part on the second coverage enhancement level.

In some examples of the method, apparatus, and non-transitory computer-readable medium described above, the real-time data comprises a plurality of voice data frames, and wherein the method further comprises bundling two or more of the voice frames into one packet for transmission in the data flow.

Some examples of the method, apparatus, and non-transitory computer-readable medium described above may further include processes, features, means, or instructions for adjusting a size of a receive buffer associated with the data flow to accommodate a delay associated with the first coverage enhancement level or the second coverage enhancement level.

Some examples of the method, apparatus, and non-transitory computer-readable medium described above may further include processes, features, means, or instructions for bundling two or more real-time data frames into a bundled packet to be transmitted in the data flow. Some examples of the method, apparatus, and non-transitory computer-readable medium described above may further include processes, features, means, or instructions for configuring a base station to assign an initial SR grant of a minimum size to meet a transport block size of the bundled packet.

Some examples of the method, apparatus, and non-transitory computer-readable medium described above may further include processes, features, means, or instructions for signaling to one or more receivers of the data flow to indicate the data flow contains traffic with the first priority level and traffic with the second priority level, wherein the signaling may be transmitted to one or more of a receiving base station or a far-end UE that may be to receive the data flow. Some examples of the method, apparatus, and non-transitory computer-readable medium described above may further include processes, features, means, or instructions for adjusting an expected reception time of a RTCP data packet or a SID packet based at least in part on the second coverage enhancement level.

Some examples of the method, apparatus, and non-transitory computer-readable medium described above may further include processes, features, means, or instructions for adjusting a size of a receive buffer associated with the data flow to accommodate a delay associated with the first coverage enhancement level or the second coverage enhancement level.

In some examples of the method, apparatus, and non-transitory computer-readable medium described above, the signaling may be transmitted to one or more or a receiving base station or a far-end UE that may be to receive the data flow.

Some examples of the method, apparatus, and non-transitory computer-readable medium described above may further include processes, features, means, or instructions for determining that a UE that may be to communicate using the data flow containing real-time data may be a bandwidth restricted UE operating in a coverage enhancement mode or power limited mode, or that the UE may be a bandwidth unrestricted UE with a channel quality metric that may be less than a threshold value. Some examples of the method, apparatus, and non-transitory computer-readable medium described above may further include processes, features, means, or instructions for identifying the traffic with the first priority level and the traffic with the second priority level based at least in part on the determining.

In some examples of the method, apparatus, and non-transitory computer-readable medium described above, the determining comprises receiving a UE capability report that the UE may be a bandwidth or power limited device or operating in coverage enhancement mode, a channel measurement report from the UE that indicates the UE may be bandwidth restricted and operating in the coverage enhancement mode or that indicates the UE may be bandwidth unrestricted with the channel quality metric below the threshold value, or any combination thereof. Some examples of the method, apparatus, and non-transitory computer-readable medium described above may further include processes, features, means, or instructions for assigning a SR grant that accounts for a repetition level associated with the channel measurement report from the UE or a minimum required grant to accommodate a transport block size of the data flow.

Some examples of the method, apparatus, and non-transitory computer-readable medium described above may further include processes, features, means, or instructions for determining that an amount of the traffic of the data flow may be below a threshold value. Some examples of the method, apparatus, and non-transitory computer-readable medium described above may further include processes, features, means, or instructions for setting the first coverage enhancement level to be the same as the second coverage enhancement level.

In some examples of the method, apparatus, and non-transitory computer-readable medium described above, the transmitting the data for the data flow comprises transmitting the data for the data flow from a user equipment to a base station or transmitting the data for the IP flow from the base station to the UE.

Some examples of the method, apparatus, and non-transitory computer-readable medium described above may further include processes, features, means, or instructions for opportunistically transmitting a RTCP data packet during a period within the data flow that may be unoccupied by one or more of a real-time data packet or a SID packet.

A method of wireless communication is described. The method may include identifying a data flow containing real-time data, identifying a first coverage enhancement level for traffic with a first priority level within the data flow and a second coverage enhancement level for traffic with a second priority level within the data flow, the second priority level being greater than the first priority level, adjusting an expected reception time of the traffic with the first priority level based at least in part on the first coverage enhancement level, and receiving data for the data flow based at least in part on the first coverage enhancement level and the second coverage enhancement level.

An apparatus for wireless communication is described. The apparatus may include means for identifying a data flow containing real-time data, means for identifying a first coverage enhancement level for traffic with a first priority level within the data flow and a second coverage enhancement level for traffic with a second priority level within the data flow, the second priority level being greater than the first priority level, means for adjusting an expected reception time of the traffic with the first priority level based at least in part on the first coverage enhancement level, and means for receiving data for the data flow based at least in part on the first coverage enhancement level and the second coverage enhancement level.

Another apparatus for wireless communication is described. The apparatus may include a processor, memory in electronic communication with the processor, and instructions stored in the memory. The instructions may be operable to cause the processor to identify a data flow containing real-time data, identify a first coverage enhancement level for traffic with a first priority level within the data flow and a second coverage enhancement level for traffic with a second priority level within the data flow, the second priority level being greater than the first priority level, adjust an expected reception time of the traffic with the first priority level based at least in part on the first coverage enhancement level, and receive data for the data flow based at least in part on the first coverage enhancement level and the second coverage enhancement level.

A non-transitory computer readable medium for wireless communication is described. The non-transitory computer-readable medium may include instructions operable to cause a processor to identify a data flow containing real-time data, identify a first coverage enhancement level for traffic with a first priority level within the data flow and a second coverage enhancement level for traffic with a second priority level within the data flow, the second priority level being greater than the first priority level, adjust an expected reception time of the traffic with the first priority level based at least in part on the first coverage enhancement level, and receive data for the data flow based at least in part on the first coverage enhancement level and the second coverage enhancement level.

In some examples of the method, apparatus, and non-transitory computer-readable medium described above, the real-time data comprises voice data and wherein the traffic with the first priority level within the data flow comprises non-voice data and the traffic with the second priority level within the data flow comprises voice data.

In some examples of the method, apparatus, and non-transitory computer-readable medium described above, the traffic with the first priority level comprises one or more of a SID packet, or RTCP data.

In some examples of the method, apparatus, and non-transitory computer-readable medium described above, identifying the first coverage enhancement level and the second coverage enhancement level comprises: receiving signaling that indicates the data flow contains the traffic with the first priority level and the traffic with the second priority level.

In some examples of the method, apparatus, and non-transitory computer-readable medium described above, identifying the first coverage enhancement level and the second coverage enhancement level further comprises: determining that a UE that may be to communicate using the data flow containing real-time data may be a bandwidth restricted UE operating in a coverage enhancement mode or a power limited mode, or that the UE may be a bandwidth unrestricted UE with a channel quality metric that may be less than a threshold value. Some examples of the method, apparatus, and non-transitory computer-readable medium described above may further include processes, features, means, or instructions for identifying the traffic with the first priority level and the traffic with the second priority level based at least in part on the determining.

In some examples of the method, apparatus, and non-transitory computer-readable medium described above, adjusting the expected reception time comprises: adjusting an expected reception time of a RTCP data packet or a SID packet based at least in part on the second coverage enhancement level.

A method of wireless communication is described. The method may include formatting voice data into voice packets to be transmitted in a voice call over a packet-switched connection, initiating transmission of the voice packets, detecting a commencement of a silence period in the voice data, and transitioning to a discontinuous transmission mode for the transmission based at least in part on detecting the silence period.

An apparatus for wireless communication is described. The apparatus may include means for formatting voice data into voice packets to be transmitted in a voice call over a packet-switched connection, means for initiating transmission of the voice packets, means for detecting a commencement of a silence period in the voice data, and means for transitioning to a discontinuous transmission mode for the transmission based at least in part on detecting the silence period.

Another apparatus for wireless communication is described. The apparatus may include a processor, memory in electronic communication with the processor, and instructions stored in the memory. The instructions may be operable to cause the processor to format voice data into voice packets to be transmitted in a voice call over a packet-switched connection, initiate transmission of the voice packets, detect a commencement of a silence period in the voice data, and transition to a discontinuous transmission mode for the transmission based at least in part on detecting the silence period.

A non-transitory computer readable medium for wireless communication is described. The non-transitory computer-readable medium may include instructions operable to cause a processor to format voice data into voice packets to be transmitted in a voice call over a packet-switched connection, initiate transmission of the voice packets, detect a commencement of a silence period in the voice data, and transition to a discontinuous transmission mode for the transmission based at least in part on detecting the silence period.

In some examples of the method, apparatus, and non-transitory computer-readable medium described above, the transitioning to the discontinuous transmission mode comprises discontinuing periodic transmissions of one or more of a SID packet or a RTCP packet.

In some examples the method, apparatus, and non-transitory computer-readable medium described above may further include identifying that a UE may be operating in a bandwidth limited mode or a power limited mode, and transitioning to the discontinuous transmission mode based at least in part on the identifying.

In some examples of the method, apparatus, and non-transitory computer-readable medium described above, the UE may be a bandwidth restricted UE operating in a coverage enhancement mode or the UE may be a bandwidth unrestricted UE operating in the power limited mode or in a low battery mode. In some examples of the method, apparatus, and non-transitory computer-readable medium described above, the discontinuous transmission mode may be a receive-only mode or power save mode. In some examples of the method, apparatus, and non-transitory computer-readable medium described above, the voice call may be negotiated as a full-duplex or half-duplex voice over Internet protocol (VoIP) call.

Some examples of the method, apparatus, and non-transitory computer-readable medium described above may further include processes, features, means, or instructions for detecting, following the commencement of the silence period, a talk period in the voice data, transitioning to a transmit/receive mode from the discontinuous transmission mode, and resuming transmitting the voice packets.

Some examples of the method, apparatus, and non-transitory computer-readable medium described above may further include processes, features, means, or instructions for receiving voice packets over the packet-switched connection, determining that a voice packet may have not been received for a predetermined time period, and determining that a SID packet may be omitted from the received voice packets.

Some examples of the method, apparatus, and non-transitory computer-readable medium described above may further include processes, features, means, or instructions for determining, based at least in part on one or more of ongoing communication with a UE or a UE reported channel quality, that the voice call may be to be maintained in an absence of receiving one or more packets for a predetermined time period as a result of the discontinuous transmission mode. In some examples of the method, apparatus, and non-transitory computer-readable medium described above, the UE may be a bandwidth restricted UE operating in a coverage enhancement mode or the UE may be a bandwidth unrestricted UE operating in a power limited mode or in a low battery mode.

Some examples of the method, apparatus, and non-transitory computer-readable medium described above may further include processes, features, means, or instructions for determining, based at least in part on one or more of ongoing communication with a base station or on a measured channel quality that the voice call may be to be maintained in an absence of receiving one or more packets from the base station for a predetermined time period as a result of the discontinuous transmission mode during the voice call.

Some examples of the method, apparatus, and non-transitory computer-readable medium described above may further include processes, features, means, or instructions for adjusting an inactivity timer to account for the omitted SID packet. Some examples of the method, apparatus, and non-transitory computer-readable medium described above may further include processes, features, means, or instructions for generating comfort noise based at least in part on the determining that the SID packet may be omitted from the received voice packets.

Some examples of the method, apparatus, and non-transitory computer-readable medium described above may further include processes, features, means, or instructions for receiving a SPS resource allocation for transmitting the voice packets, and transmitting, based at least in part on detecting the silence period, an indicator in an SPS uplink transmission that the SPS resource allocation can be released. Some examples of the method, apparatus, and non-transitory computer-readable medium described above may further include processes, features, means, or instructions for receiving a release of the SPS resource allocation. Some examples of the method, apparatus, and non-transitory computer-readable medium described above may further include processes, features, means, or instructions for transmitting a null data indication in a BSR based at least in part on detecting the silence period. Some examples of the method, apparatus, and non-transitory computer-readable medium described above may further include processes, features, means, or instructions for skipping a SR transmission based at least in part on detecting the silence period.

In some examples of the method, apparatus, and non-transitory computer-readable medium described above, the initiating the voice call over the packet-switched connection further comprises signaling that one or more SID packets may be omitted upon detecting the silence period.

In some examples of the method, apparatus, and non-transitory computer-readable medium described above, a receiver may, based at least in part on the signaling that one or more SID packets may be omitted and upon detecting the commencement of the silence period in the voice data, transition to the discontinuous transmission mode or indicate in a DSCP transmission droppable packets.

A method of wireless communication is described. The method may include initiating a voice call over a packet-switched connection with a UE, transmitting voice data in downlink voice packets to the UE, detecting a commencement of a silence period in the voice data, and dropping one or more downlink packets based at least in part on detecting the silence period.

An apparatus for wireless communication is described. The apparatus may include means for initiating a voice call over a packet-switched connection with a UE, means for transmitting voice data in downlink voice packets to the UE, means for detecting a commencement of a silence period in the voice data, and means for dropping one or more downlink packets based at least in part on detecting the silence period.

Another apparatus for wireless communication is described. The apparatus may include a processor, memory in electronic communication with the processor, and instructions stored in the memory. The instructions may be operable to cause the processor to initiate a voice call over a packet-switched connection with a UE, transmit voice data in downlink voice packets to the UE, detect a commencement of a silence period in the voice data, and drop one or more downlink packets based at least in part on detecting the silence period.

A non-transitory computer readable medium for wireless communication is described. The non-transitory computer-readable medium may include instructions operable to cause a processor to initiate a voice call over a packet-switched connection with a UE, transmit voice data in downlink voice packets to the UE, detect a commencement of a silence period in the voice data, and drop one or more downlink packets based at least in part on detecting the silence period.

In some examples of the method, apparatus, and non-transitory computer-readable medium described above, the detecting the silence period comprises detecting one or more downlink packets having a packet size that may be below a threshold value, that meets a specific value, or that may be within a range of values.

In some examples of the method, apparatus, and non-transitory computer-readable medium described above, the detecting the silence period comprises detecting one or more downlink packets having a specific DSCP value that indicates the downlink packets belong to an IP flow associated with the voice call, and having one or more of a specific QCI or a specific APN. In some examples of the method, apparatus, and non-transitory computer-readable medium described above, the specific QCI comprises a QCI assigned for one or more of an IP flow associated with the voice call, a QCI assigned for bandwidth limited transmitters, a QCI assigned for power limited transmitters, or a QCI assigned for transmitters using coverage enhancement. In some examples of the method, apparatus, and non-transitory computer-readable medium described above, the APN comprises one or more of an APN assigned to an Internet protocol multimedia subsystem (IMS), an APN assigned for bandwidth limited transmitters, an APN assigned for power limited transmitters, or an APN assigned for transmitters using coverage enhancement.

Some examples of the method, apparatus, and non-transitory computer-readable medium described above may further include processes, features, means, or instructions for determining the UE may be a bandwidth restricted UE operating in a coverage enhancement mode, and wherein the detecting the commencement of the silence period and dropping the one or more downlink packets may be based at least in part on the determining.

In some examples of the method, apparatus, and non-transitory computer-readable medium described above, the determining comprises receiving one or more of a channel measurement report from the UE or signaling from the UE indicating that the UE may be bandwidth restricted and operating in the coverage enhancement mode.

In some examples of the method, apparatus, and non-transitory computer-readable medium described above, the determining further comprises determining that ongoing communications may be associated with a real-time data service based on at least in part on a QCI, APN, DSCP value, or IP flow data associated with the voice call. In some examples of the method, apparatus, and non-transitory computer-readable medium described above, the QCI comprises one or more of a QCI assigned for voice calls, a QCI assigned for bandwidth limited transmitters, a QCI assigned for power limited transmitters, or a QCI assigned for transmitters using coverage enhancement. In some examples of the method, apparatus, and non-transitory computer-readable medium described above, the APN comprises one or more of an APN assigned to an IMS, an APN assigned for bandwidth limited transmitters, an APN assigned for power limited transmitters, or an APN assigned for transmitters using coverage enhancement.

Some examples of the method, apparatus, and non-transitory computer-readable medium described above may further include processes, features, means, or instructions for determining the UE may be a power limited UE, and wherein the detecting the commencement of the silence period and dropping the one or more downlink packets may be based at least in part on the determining. In some examples of the method, apparatus, and non-transitory computer-readable medium described above, the dropping one or more downlink packets comprises dropping one or more SID packet transmissions to UE. In some examples of the method, apparatus, and non-transitory computer-readable medium described above, the dropping the one or more downlink packets comprises inserting a silence flag into a downlink voice packet transmitted to the UE, and discontinuing transmissions of downlink voice packets to the UE.

Some examples of the method, apparatus, and non-transitory computer-readable medium described above may further include processes, features, means, or instructions for detecting a talk period in voice data following the silence period, and resuming transmission of downlink packets to the UE.

Some examples of the method, apparatus, and non-transitory computer-readable medium described above may further include processes, features, means, or instructions for receiving one or more uplink voice packets from the UE, identifying a simultaneous talk period in the uplink voice packets and the downlink packets, and dropping one or more of the uplink voice packets or downlink packets based at least in part on the identifying the simultaneous talk period. In some examples of the method, apparatus, and non-transitory computer-readable medium described above, the dropping of one or more of the uplink voice packets or downlink packets may be based at least in part on one or more of: a specific DSCP value configured for dropping packets; a prioritization of uplink packets over downlink packets for a configured period of time; a proportion of uplink packets versus downlink packets; or a random selection of packets.

Some examples of the method, apparatus, and non-transitory computer-readable medium described above may further include processes, features, means, or instructions for providing a SPS resource allocation for uplink voice packets to be received from the UE, detecting the silence period in the uplink voice packets, and releasing the SPS resource allocation upon detection of the silence period in the uplink voice packets. In some examples of the method, apparatus, and non-transitory computer-readable medium described above, the detecting the silence period comprises receiving indication from the UE of the silence period in one of the uplink voice packets.

Some examples of the method, apparatus, and non-transitory computer-readable medium described above may further include processes, features, means, or instructions for receiving a BSR from the UE indicating a null buffer at the UE, and discontinuing scheduling of wireless resources for the UE based at least in part on the null buffer reported in the BSR.

Further scope of the applicability of the described methods and apparatuses will become apparent from the following detailed description, claims, and drawings. The detailed description and specific examples are given by way of illustration only, since various changes and modifications within the spirit and scope of the description will become apparent to those skilled in the art.

### BRIEF DESCRIPTION OF THE DRAWINGS

A further understanding of the nature and advantages of the present disclosure may be realized by reference to the following drawings. In the appended figures, similar components or features may have the same reference label. Further, various components of the same type may be distinguished by following the reference label by a dash and a second label that distinguishes among the similar components. If only the first reference label is used in the specification, the description is applicable to any one of the similar components having the same first reference label irrespective of the second reference label.

FIG. 1 illustrates an example of a system for wireless communication that supports differential scheduling for real-time communication services in accordance with aspects of the present disclosure.

FIG. 2 illustrates an example of a wireless communications system that supports differential scheduling for real-time communication services in accordance with aspects of the present disclosure.

FIG. 3 illustrates an example of uplink and downlink communications that supports differential scheduling for real-time communication services in accordance with aspects of the present disclosure.

FIG. 4 illustrates an example of a time delay budget that supports differential scheduling for real-time communication services in accordance with aspects of the present disclosure.

FIG. 5 illustrates an example of another time delay budget that supports differential scheduling for real-time communication services in accordance with aspects of the present disclosure.

FIG. 6 illustrates an example of another time delay budget that supports differential scheduling for real-time communication services in accordance with aspects of the present disclosure.

FIG. 7 illustrates an example of another time delay budget that supports differential scheduling for real-time communication services in accordance with aspects of the present disclosure.

FIG. 8 illustrates an example of another time delay budget that supports differential scheduling for real-time communication services in accordance with aspects of the present disclosure.

FIG. 9 illustrates an example of a process flow that supports differential scheduling for real-time communication services in accordance with aspects of the present disclosure.

FIG. 10 illustrates an example of a process flow that supports differential scheduling for real-time communication services and voice activity based half-duplex calling in accordance with aspects of the present disclosure.

FIGS. 11 through 13 show diagrams of a device that supports differential scheduling for real-time communication services in accordance with aspects of the present disclosure.

FIG. 14 illustrates a diagram of a system including a UE that supports differential scheduling for real-time communication services in accordance with aspects of the present disclosure.

FIGS. 15 through 17 show diagrams of a device that supports differential scheduling for real-time communication services in accordance with aspects of the present disclosure.

FIG. 18 illustrates a diagram of a system including a base station that supports differential scheduling for real-time communication services in accordance with aspects of the present disclosure.

FIGS. 19 through 29 illustrate methods for differential scheduling for real-time communication services in accordance with aspects of the present disclosure.

### DETAILED DESCRIPTION

Real-time communications with a wireless device may require that certain communications be completed within certain time periods, in order to prevent large gaps in the communication or a diminished user experience. For example, a real-time voice communication may generate voice packets every 20 ms, and if it consistently takes longer than an average of 20 ms to transmit the voice packets, delays may accumulate and result in a connection that may not be maintained. In deployments that use coverage enhancement (CE) techniques for certain transmissions that rely on repetitions of data, consistently meeting average time constraints may be difficult.

The present disclosure provides various techniques for supporting real-time communications for devices that may be bandwidth limited or that may rely on one or more CE techniques for reliable communications. Various described techniques provide for differential scheduling for real-time communication services, in which different types of traffic within a single data flow (e.g., an IP flow) may be scheduled differently with different CE levels for the different types of traffic. For example, lower priority traffic within the IP flow may be scheduled with a lower CE level and higher priority traffic within the IP flow may be scheduled with a higher CE level. In some cases, the CE levels may be selected to allow for a delay budget that supports real-time communications, such as a voice over LTE (VoLTE) real-time voice communications for bandwidth limited devices or devices that are bandwidth unrestricted but having poor channel conditions.

The present disclosure may also provide various techniques for supporting real-time communications for devices that may be bandwidth limited, that may be power limited, or that may rely on one or more CE techniques for reliable communications. Various described technique may provide for initiating a voice call, transmitting one or more voice packets associated with the voice call, detecting the commencement of a silence period, and transitioning to a discontinuous transmission mode for the voice call when the commencement of the silence period is detected. During the silence period, transmission may be skipped for one or more non-voice frames (e.g., a SID frame or a RTCP frame), thus reducing the need for the device transmit such non-voice frames. A receiving device may determine that the transmissions of the non-voice frames have been skipped, and may adjust one or more receive algorithms to account for the skipped frames.

As mentioned above, some types of wireless devices may provide for Machine-to-Machine (M2M) communication or Machine Type Communication (MTC). M2M or MTC may refer to data communication technologies that allow devices to communicate with one another or a base station without human intervention. For example, M2M or MTC may refer to communications from devices that integrate sensors or meters to measure or capture information and relay that information to a central server or application program that can make use of the information or present the information to humans interacting with the program or application. MTC devices are commonly implemented in LTE networks under a relatively new category of device, referred to as a CAT-M1 device, compared with traditional devices referred to as CAT-1 devices. CAT-M1 devices may have a reduced peak data rate relative to CAT-1 devices, may use a single receive antenna, operate using half duplex frequency division duplexing (FDD) and transmits using a reduced bandwidth of 1.4 MHz relative to a 20 MHz bandwidth of CAT-1 devices. CAT-M1 devices may use a MTC Physical Downlink Control Channel (MPDCCH) for certain downlink control transmissions.

Such CAT-M1 devices may also support deployment in locations with relatively poor channel conditions and may have UEs in a power class of 20 dBM with existing 23 dBM power class devices. Coverage enhancements may be selected that provide medium coverage enhancement (mode A CE support), or that provide large coverage enhancement (mode B CE support). Additionally, CAT-1 devices may optionally support one or more modes of coverage enhancement.

While various examples describe CAT-M1 devices as MTC or M2M devices, such devices may also include other types of UEs, such as narrowband wearable devices, alarm panels, display kiosks, and the like. Additionally, in some cases it may be desirable to that such UEs support real-time communications, such as voice communications, in addition to MTC communications. Such real-time communications may include, for example, voice over LTE (VoLTE) or voice over internet protocol (VoIP). Such real-time services may include other services than voice services, such as real-time monitoring, exchange of navigation data, or tracking data services, for example. Additionally, other types of UE, such as CAT-1 UEs, may employ techniques described herein in certain situations, such as in poor coverage situations where reliable service may benefit from CE techniques. Other types of UEs may also employ techniques described herein in certain situations, such as in power limited situations or when such a UE is trying to conserve battery power due to a low battery level.

As indicated above, in some cases when certain CE techniques are employed it may be difficult to support real-time communication such as VoLTE on bandwidth restricted devices (e.g., a UE with a LTE CAT M1 modem). For example, a CAT-M1 based UE operating in a CE mode may use packet repetition to meet a link budget. For example, to gain a service footprint comparable to a CAT-1 UE, an uplink repetition pattern of 32 or higher may be suitable to achieve a comparable link budget for a CAT-M1 UE power class. Such CE techniques may present difficulty to support certain real-time services due to, for example, timing requirements for the real-time service. For example, in a real-time VoLTE or VoIP service, voice packets may be generated every 20 ms. Packet repetitions, along with other constraints associated with bandwidth restricted devices, such as half-duplex operation in which time may be allotted for re-tuning between uplink/downlink transmissions, may result in scheduling delays for the real-time data packets.

Additionally, there may be minimum scheduling time constraints between resource allocation grants and scheduling of data transmissions, such as a minimum scheduling time between a MPDCCH grant assigned to a UE and scheduling of data on PDSCH or PUSCH for the UE. Furthermore, in addition to real-time data frames, certain frames may come from the other direction for the real-time IP flow. For example, in a voice IP flow, voice frames may be transmitted in one direction and silence frames may be transmitted from other direction. Furthermore, RTCP data and in-call signaling may further impact the delays. In some examples, two or more frames may be bundled, such as two or more 20 ms voice frames, into one medium access control (MAC) packet that may reduce some of the constraints. However with the current scheduling techniques it is may be likely that the scheduling will not meet the real-time data service timelines. For example, per ITU G.114, for good audio experience an end to end delay of less than 400 ms should be maintained. Current LTE networks with CAT 1 VoLTE devices are under and close to this 400 ms end-to-end delay mark, without leaving much scheduling time for CAT-M1 repetition based scheduling for certain CE modes. Various aspects of the disclosure provide techniques for scheduling such devices.

Various techniques may also provide for reducing certain transmissions, thereby alleviating some scheduling constraints and providing an enhanced likelihood that a device can comply with identified timelines. Furthermore, in addition to timing considerations, reducing certain transmissions may reduce power consumption at a device, and may allow a power limited device to operate with reduced power. Additionally, in some cases during a VoLTE or VoIP call, if two ends of the call talk simultaneously, since the underlying channel may be half duplex or bandwidth constrained, a channel might face resource starvation as a result of the control signaling and repetition overhead associated with concurrent talk frames. This may result in delayed packet delivery that propagates through the subsequent packet frame delivery, and may negatively impact performance of a system. In some examples, techniques are provided for dropping certain frames associated with simultaneous talking.

Aspects of the disclosure are initially described in the context of a wireless communications system. Aspects of the disclosure are further illustrated by and described with reference to apparatus diagrams, system diagrams, and flowcharts that relate to differential scheduling for real-time communication services.

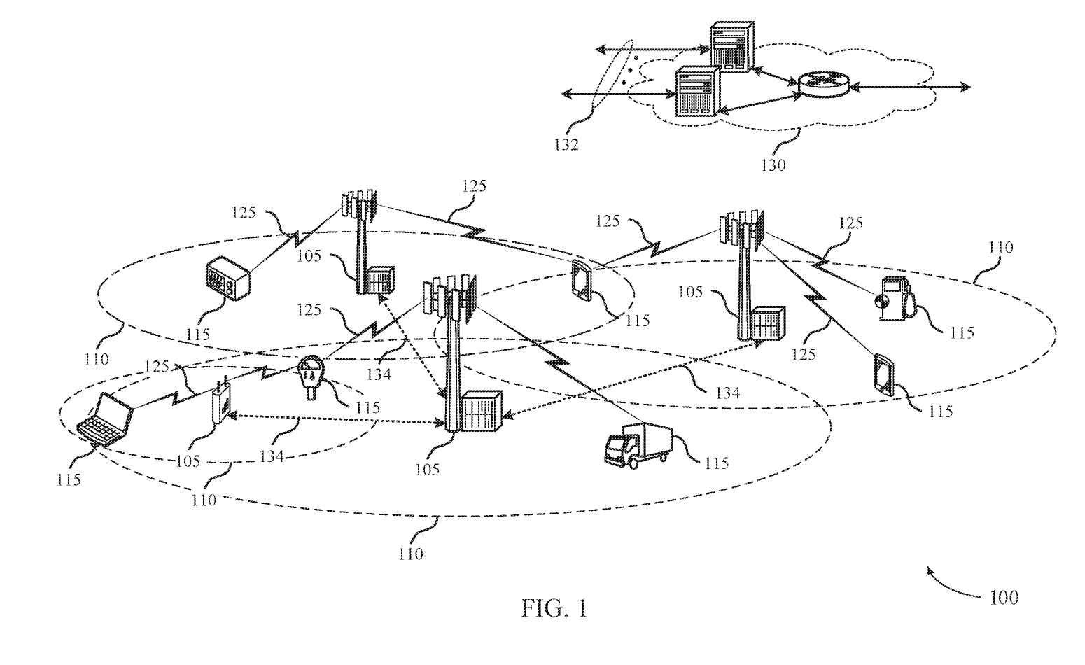

FIG. 1 illustrates an example of a wireless communications system 100 in accordance with various aspects of the present disclosure. The wireless communications system 100 includes base stations 105, UEs 115, and a core network 130. In some examples, the wireless communications system 100 may be a LTE (or LTE-Advanced) network. The system 100 may include one or more bandwidth restricted UEs 115 or UEs operating in a CE mode.

The UEs 115 and base stations 105 may employ techniques for real-time communications for devices that may be bandwidth limited or that may rely on one or more CE techniques for reliable communications. Various described techniques provide for differential scheduling for real-time communication services, in which different types of traffic within a single IP flow may be scheduled differently with different CE levels for the different types of traffic.

Base stations 105 and UEs 115 may, in some examples, provide for initiating a voice call, transmitting one or more voice packets associated with the voice call, detecting the commencement of a silence period, and transitioning to a discontinuous transmission mode for the voice call when the commencement of the silence period is detected. During the silence period, transmission may be skipped for one or more non-voice frames (e.g., a SID frame, a RTCP frame, in-call signaling), thus reducing the need for the device transmit such non-voice frames. A receiving base station 105 or UE 115 may determine that the transmissions of the non-voice frames have been skipped, and may adjust one or more receive algorithms to account for the skipped frames. Further, hysteresis in form of timer or voice signal activity may be provided in the detection of the commencement of the silence period to prevent false detection.

Base stations 105 may wirelessly communicate with UEs 115 via one or more base station antennas. Each base station 105 may provide communication coverage for a respective geographic coverage area 110. Communication links 125 shown in wireless communications system 100 may include UL transmissions from a UE 115 to a base station 105, or DL transmissions, from a base station 105 to a UE 115. UEs 115 may be dispersed throughout the wireless communications system 100, and each UE 115 may be stationary or mobile. A UE 115 may also be referred to as a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology. A UE 115 may also be a cellular phone, a personal digital assistant (PDA), a wireless modem, a wireless communication device, a handheld device, a tablet computer, a laptop computer, a cordless phone, a personal electronic device, a handheld device, a personal computer, a wireless local loop (WLL) station, an Internet of things (IoT) device, an Internet of Everything (IoE) device, a machine type communication (MTC) device, an appliance, an automobile, or the like. A UE 115 may be a device that includes a CAT-1 or CAT-M1 modem, in some examples.

Base stations 105 may communicate with the core network 130 and with one another. For example, base stations 105 may interface with the core network 130 through backhaul links 132 (e.g., S1, etc.). Base stations 105 may communicate with one another over backhaul links 134 (e.g., X2, etc.) either directly or indirectly (e.g., through core network 130). Base stations 105 may perform radio configuration and scheduling for communication with UEs 115, or may operate under the control of a base station controller (not shown). In some examples, base stations 105 may be macro cells, small cells, hot spots, or the like. Base stations 105 may also be referred to as eNodeBs (eNBs) 105.

As indicated above, some types of wireless devices may provide for automated communication. Automated wireless devices may include those implementing Machine-to-Machine (M2M) communication or machine type communication (MTC). M2M or MTC may refer to data communication technologies that allow devices to communicate with one another or a base station without human intervention. For example, M2M or MTC may refer to communications from devices that integrate sensors or meters to measure or capture information and relay that information to a central server or application program that can make use of the information or present the information to humans interacting with the program or application. Some UEs 115 may be MTC devices, such as those designed to collect information or enable automated behavior of machines. Examples of applications for MTC devices include smart metering, inventory monitoring, water level monitoring, equipment monitoring, healthcare monitoring, wildlife monitoring, weather and geological event monitoring, fleet management and tracking, remote security sensing, physical access control, and transaction-based business charging. An MTC device may operate using half-duplex (one-way) communications at a reduced peak rate. MTC devices may also be configured to enter a power saving “deep sleep” mode when not engaging in active communications.

In certain examples, CAT-M1 devices may have reduced peak data rates (e.g., a maximum transport block size may be 1000 bits). Additionally, such a device may have rank one transmission and one antenna for receiving. This may limit a CAT-M1 UE 115 to half-duplex communication (i.e., the device may not be capable of simultaneously transmitting and receiving). If a UE 115 is half-duplex, it may have relaxed switching time (e.g., from transmission (Tx) to reception (Rx) or vice versa). For example, a nominal switching time for a CAT-1 device may be 20 μs while a switching time for a CAT-M1 device may be 1 ms. MTC enhancements (eMTC) in a wireless system may allow narrowband MTC devices to effectively operate within wider system bandwidth operations (e.g., 1.4/3/5/10/15/20 MHz). For example, an MTC UE 115 may support 1.4 MHz bandwidth (i.e., 6 resource blocks in an LTE system), and may support a frequency hopping pattern within a 20 MHz bandwidth. In some instances, as discussed above, CE may be employed to provide more reliable communications. Coverage enhancements may include, for example, power boosting (e.g., of up to 15 dB), beam-forming, and bundling of transmit time intervals (TTIs) to provide redundant versions of a transmission.

Wireless communications system 100 may, for example, employ TTI bundling to improve a communication link 125 in relatively poor radio conditions or in deployments where UEs 115 may operate using a relatively narrow bandwidth or are in a coverage limited location, such as a basement or at a cell edge. TTI bundling may involve sending multiple redundant copies of the same information in a group of consecutive or non-consecutive TTIs rather than waiting for feedback indicating data was not received before retransmitting redundancy versions. For instance, various physical channels—including the PBCH and associated messages—may be associated with multiple redundant transmissions to a wireless communications device. In some cases, the number of redundant versions can be on the order of tens of subframes, and different channels may have different redundancy levels.

In some cases Long Term Evolution (LTE) networks may be designed for transfer of data packets, and may use a circuit switched fall back for voice communications. However, an LTE network may also be used for voice communications using a packet based system similar to various VoIP applications (e.g., Skype). This may be accomplished using VoLTE technology. There may be several differences between VoLTE and VoIP. For example, VoLTE service may include an explicit QoS target. To achieve the QoS threshold in poor radio conditions, VoLTE packets may utilize IMS and other network features to ensure low latency and improved error correction. In cases where a UE 115 is operating using one or more CE techniques, timelines for voice communications may be difficult to achieve. In various examples, differential scheduling of different types of data within an IP flow that supports a real-time voice call may help meet such timelines. In some cases, voice activity for a call flow may be used to reduce transmissions of certain non-voice data, which may help to achieve required VoLTE timelines and link budget requirements for certain bandwidth limited, power limited, half duplex FDD UEs 115.

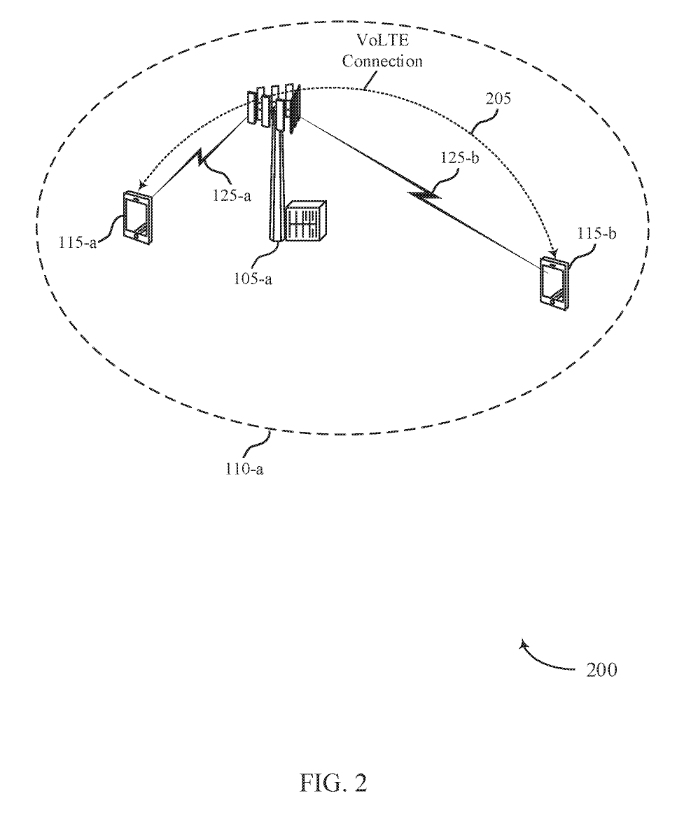

FIG. 2 illustrates an example of a wireless communications system 200 for differential scheduling for real-time communication services, in accordance with various aspects of the present disclosure. Wireless communications system 200 may include a first UE 115-a and a second UE 115-b, which may be examples of a UE 115 described with reference to FIG. 1. For example, as illustrated, one or more of the first UE 115-a or second UE 115-b may be bandwidth restricted or power restricted, or may be operating using one or more CE techniques. Wireless communications system 200 may also include a base station 105-a, which may be an example of a base station 105 described above with reference to FIG. 1. The base station 105-a may transmit control and data to any UE 115 within its geographic coverage area 110-a via a communication links 125. For example, communication link 125-a may allow for bidirectional communication between the first UE 115-a and the base station 105-a, and communication link 125-b may allow for bidirectional communication between the second UE 115-b and the base station 105-a. In some examples, a real-time connection may be established between the first UE 115-a and the second UE 115-b, such as VoLTE connection 205.

The VoLTE connection 205 may be established through a data flow, such as an IP flow, that may include voice packets and other packets such as one or more of a SID packet, RTCP data, or in-call signaling. In this description, a data flow may be described through the example of an IP flow, however it should be understood that details of the disclosure described with respect to an IP flow may also pertain to a data flow.

Timelines for real-time data communications may be achieved, in some examples, using differential scheduling for the IP flow, in which, for the same IP flow, some category of traffic is selected as “low priority” a priori. For example, in a VoLTE IP flow, the low category traffic may be non-voice frames such as SID frames, RTCP traffic, and in-call signaling. The selection of the low priority data may be based on packet size or a different DSCP in the IP flow indicating non voice data, in combination with one or more of a QCI, a UE category, an APN, an IP address, or an IP subnet associated with the non-voice data. The differential scheduling may reduce a number of CE repetitions for such low priority traffic, assuming a higher block error rate (BLER) may be sufficient to meet the link budget criteria. By reducing the repetition schedule for the low priority data (e.g., SID frames, RTCP packets, etc.), higher priority voice frames (or other real-time data frames) may be scheduled to meet the timelines for good real-time data service. In some cases, reducing the repetition may result in dropping the transmission of low priority data. In some examples, two or more voice packets may be bundled in a same MAC packet, and the base station 105-a may be configured to assign an initial SR grant of a minimum size to meet the transport block size of the bundled packets of the data flow.

As indicated, a higher BLER may result for the lower priority data, and a device, such as first UE 115-a that may be a CAT-M1 device or a CAT-1 device that is using CE, may provide signaling of differential scheduling capability to both the base station 105-a and the far-end second UE 115-b. Thus, the far-end second UE 115-b that may expect the SID frames or RTCP packets can adjust its algorithm accordingly. Such differential scheduling may apply to the first UE 115-a for uplink transmissions, and may apply to the base station 105-a for downlink transmissions. At the application layer, the first UE 115-a may, in some examples, opportunistically transmit uplink RTCP only when UE is in silence DTX and no SID frames are being transmitted, and may adjust to operate without SID, or with intermediate SID and RTCP messages.

In some examples, the voice communication may be negotiated as a full duplex or half duplex VoIP or VoLTE call. Timelines for real-time data communications may be achieved, in some examples, using voice activity based half-duplex calling, in which certain transmissions of non-voice data may be dropped. For example, the first UE 115-a may be bandwidth restricted or power limited (e.g., a CAT-M1 UE or a CAT-1 UE that is power limited). The first UE 115-a may establish VoLTE connection 205 with second UE 115-b, and may use one or more techniques to reduce certain non-voice transmissions based on voice activity over the VoLTE connection 205. For uplink transmissions, the first UE 115-a may determine that it is operating in a bandwidth limited or a power limited mode, and may perform voice activity detection to identify the commencement of a silence period. Such voice activity detection may include, for example, detecting a silence period where a microphone input (or differential microphone input) is below a level threshold for longer than an established time duration. Various voice activity detection algorithms may also include criteria for ignoring certain short duration sound bursts.

Once the commencement of the silence period is detected, the first UE 115-a may discontinue uplink transmissions, and transition to a discontinuous transmission mode. In the discontinuous transmission mode, the first UE 115-a may omit sending any voice or silence (e.g., SID) frames, and may go into receive-only mode or smarter power save mode. Subsequently, when the first UE 115-a detects voice, it switches to transmit/receive mode, receiving only when it is not transmitting in a half-duplex pattern. In such a manner, the first UE 115-a may reduce transmissions, which thus requires fewer wireless resources and increases wireless resources for other transmissions that may allow for voice call timelines to be more readily achieved. Additionally, reduced transmissions may also provide power savings for a power limited first UE 115-a, in some examples.

The base station 105-a, when transmitting downlink transmissions to the first UE 115-a, may determine that the first UE 115-a is operating in a bandwidth limited or a power limited mode based on signaling related to the first UE 115-a capability and signal strength reports, and may detect the commencement of a silence period in the downlink frames to be transmitted to the first UE 115-a, such as based on packet size on the voice IP flow of the received packets. When the base station 105-a detects such a commencement of a silence period in downlink data, the base station 105-a may drop the associated VoIP packets. Subsequently, when the base station 105-a detects voice based on packet size on the voice IP flow, it may again start transmitting the downlink voice frames to the first UE 115-a. The first UE 115-a, and the second UE 115-b, may determine that a silence period has commenced in the downlink transmissions and handle the voice inactivity without assistance from SID frames.

After detection of the commencement of a silence period, the base station 105-a may modify scheduling of wireless resources for the first UE 115-a or the second UE 115-b. In the event that semi-persistent scheduling (SPS) is configured for the first UE 115-a or the second UE 115-b, the base station 105-a may indicates a release of SPS via explicit SPS release signaling where the base station 105-a may, for example, configures one or more downlink control information (DCI) fields with specific values indicating to the first UE 115-a or the second UE 115-b that SPS has been released. At the first UE 115-a or second UE 115-b, for uplink transmissions, the UE 115 may send signaling in a uplink SPS transmission that may indicate transmission of empty PDUs. The signaling may be, for example, a predefined value of an “implicitReleaseAfter” parameter, that may be configured by the base station 105-a. In cases where SR-based scheduling is implemented, a UE 115 may report null data in a BSR message, or may not perform a SR for new non-voice frames, such as new SID frames. Additionally, for SR-based scheduling, the base station 105-a, upon detection of commencement of a silence period in downlink voice transmissions, may simply not schedule downlink traffic on the physical downlink shared channel (PDSCH).

In some examples, base station 105-a, based on ongoing communication with the first UE 115-a on the downlink or based on UE's reported channel quality, may deduce that the link to the UE is still maintained even though packets have not been received for a predetermined time period as a result of discontinuous transmission operation during a voice call. Similarly, the first UE 115-a or second UE 115-b, based on ongoing communication with the base station 105-a on the uplink, or based on measured channel quality, may deduce that the link to the base station is still maintained even though packets have not been received for a predetermined time period as a result of discontinuous transmission operation during a voice call.

In certain examples, when the VoLTE connection 205 is established, signaling may be provided indicating that one or more SID packets or RTCP packets may be omitted upon detecting the silence period. In some examples, the UE 115 on the other end of the VoLTE connection 205 from the bandwidth restricted or power limited device may, on receipt of signaling, also drop one or more transmissions upon commencement of a silence period, or may indicate, through a specific DSCP transmission value, droppable packets such as silence or terminating voice frame.

The base station 105-a, in some examples, may detect the commencement of a silence period through detecting one or more downlink packets having a packet size that is below a threshold value or meets a specific value or is within a range of values, through detecting one or more downlink packets having a specific DSCP that belong the VoIP flow and have a specific QCI value and a specific APN, all of which may be configured at the base station 105-a. In some cases, the QCI may be a QCI assigned for VoIP or a specific QCI for bandwidth limited UEs 115, power limited UEs 115, or coverage enhancement UEs 115. Similarly, the APN may be an APN assigned to an Internet protocol multimedia subsystem (IMS), an APN assigned for bandwidth limited transmitters, an APN assigned for power limited transmitters, or an APN assigned for transmitters using coverage enhancement.

Additionally, as indicated above, in some examples simultaneous voice data for each UE 115 may be detected and one or more such packets prioritized or dropped by the base station 105-a. In such examples, the base station 105-a may receive uplink voice packets from the UEs 115, may identify a simultaneous talk period in the uplink voice packets and the downlink voice packets, and drop one or more of the uplink voice packets or downlink voice packets based at least in part on the identifying the simultaneous talk period. In some examples, the dropping of one or more of the uplink voice packets or downlink voice packets may be based on a specific DSCP value configured for dropping on uplink or downlink, prioritizing of uplink packets over downlink for a configured period of time thereby dropping the downlink packets in that period to achieve the half duplex mode, proportionately dropping series of packets first from the direction (e.g., UL or DL) that is dormant while continuing the current transmission in the current direction, followed by switching to the dormant link and dropping packets from the direction that was active prior to the current direction switch, randomly dropping packets on either link proportionately until the link returns to one way transmission, or any combination thereof.

In some examples, the base station 105-a may adjust a CE for either, or both, the lower priority data and the higher priority data (e.g., select a CE with a repetition count of 2, 4, 8, 16, 32, etc.) based on a channel quality indicator (CQI) reported by the UE. For example, the base station 105-a may select a CE with 32 repetitions when first UE 115-a is located at an edge of coverage area 110-a, and may select a CE with fewer repetitions when the first UE 115-a is located closer to the base station 105-a. In some examples, different CE levels may be set for the different priority levels of data. The CE level may be selected, for example, based on identifying one or more of an amount of other traffic other than the voice data for the VoLTE IP flow, or a non-voice data metric. The non-voice data matric may, in some examples, be based at least in part on a packet size of the non-voice data, a DSCP value of the non-voice data, deep packet inspection and finding a match with a partial set of data to deduce the presence of non-voice data, an out-of-band indication from one or more upper layers of a protocol stack or an application layer, and one or more of a QCI, a UE category, an APN, an IP address, an IP subnet associated with the non-voice data, a SID packet, RTCP data, in-call signaling, or the like. In some examples, deep packet inspection may involve reading a header and at least some of the contents of a packet to deduce that the packet includes non-voice data based on a comparison with a partial set of data. The partial set of data may include information that has one or more characteristics of non-voice data.

The base station 105-a, in some examples, may schedule grants that fit the required timelines with half-duplex and accounting for talk/listen/silence frames. For example, base station 105-a may schedule downlink SID frames with 2 repetitions and uplink voice frames with 16 repetitions. Additionally, packets may be bundled to help reduce some time constraints. For example, two or more 20 ms voice frames may be bundled into one MAC packet to help reduce some of the time constraints. Furthermore, in some examples, a larger static or dynamic buffer with a rebuffering logic after every SID receipt may improve perceived voice jitter. Additionally, some digital signal processing techniques may be used, such as known time warping techniques, which may help reduce some delays, but may add processing delay, impair voice fidelity, or both.

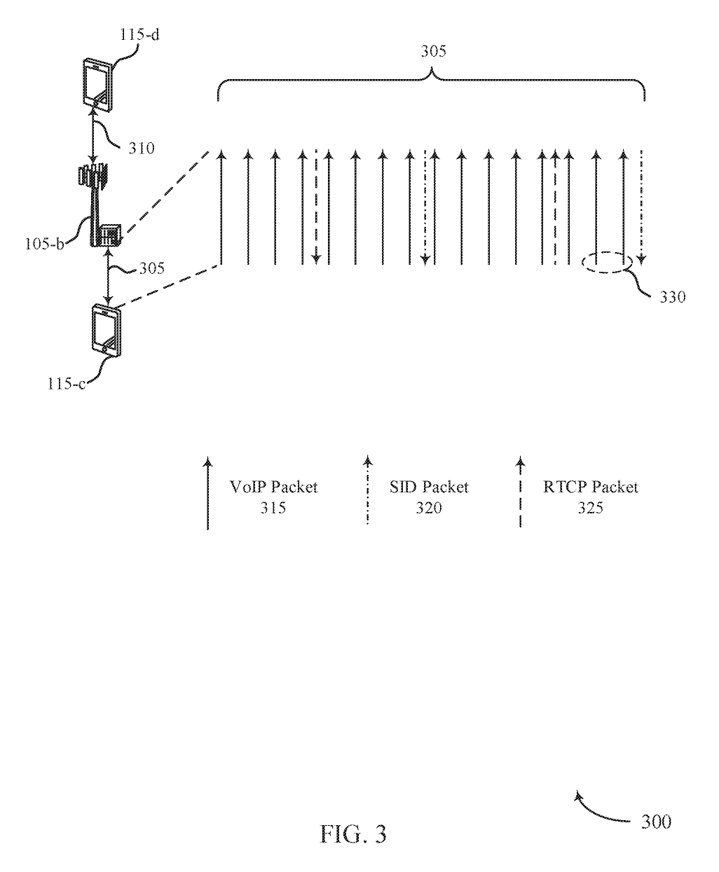

As indicated above, in the event that non-voice packets are repeatedly transmitted by a UE, timelines for voice communications may be negatively impacted. FIG. 3 illustrates an example of uplink and downlink communications 300 for differential scheduling for real-time communication services in which non-voice data may be transmitted. The uplink and downlink communications 300 may utilize differential scheduling techniques, voice activity half-duplex calling techniques, or some combination thereof, employed within the systems 100 or 200 of FIG. 1 or 2. In this example, a first UE 115-c may have bidirectional communications 305 with base station 105-b. Similarly, a second UE 115-d may have bidirectional communications 310 with base station 105-b. Communications 305 may include uplink voice packets 315, downlink SID packets 320, and both uplink and downlink RTCP packets 325. Additionally, two or more uplink voice packets 330 may be bundled in one MAC packet. The first UE 115-c, second UE 115-d, and base station 105-b, may be examples of a UE 115 and base station 105 of FIG. 1 or 2. One or both UEs 115 may be bandwidth restricted, power limited, or use CE techniques which may impact real-time IP flow timelines or available power for transmissions.

Various models for real-time communications may have assumptions on the amounts of types of traffic that may be present. For example, in a voice call, it may be assumed that 40% of the time a UE 115 will have talk data and will transmit voice packets 315, 40% of the time the UE 115 will receive listen data and will receive voice packets 315, and 20% of the time there will be silence, which may be indicated in SID packets 320. While the example of FIG. 3 shows voice packets 315 in uplink transmissions, it will be readily understood that the same techniques may be applied on downlink packets, and the same techniques may also apply to both uplink and downlink communications for the second UE 115-d.

During talk periods at the first UE 115-c, a VoIP packet 315 may be generated every 20 millisecond (ms). Size of the VoIP packet 315 may depend on a Vocoder used at the device. For an AMR12.2 Vocoder, the packet size is 31 bytes, for example. Furthermore, during a listen state, a UE 115, such as second UE 115-d, may generate SID packets 320 every 160 ms, and thus during a talk state a SID packet 320 may be received every 160 ms. RTCP packets 325 may be generated once every 5 seconds on each UE to report RTP packet statistics. SID packets 320 contain information on background noise of a UE 115. On the receiving side, on receipt of SID packets 320, the receiver (e.g., first UE 115-c) may generate noise with information based on the SID packets 320. This process is called comfort noise generation, and without the comfort noise the received audio may be unpleasant for a user. As indicated above, SID packets 320 and RTCP packets 325 may be identified as lower priority data and may have a reduced CE level relative to voice packets 315 that may be higher priority data with a higher CE level. Thus, the likelihood of a SID packet 320 or RTCP packet 325 not being successfully received may be relatively high. In some examples a UE 115 may adjust an expected reception time of the lower priority data, such as a 160 ms periodicity for SID frames, for example. In some examples, if SID frame 320 is not received at an expected reception time, the UE 115 may generate the comfort noise in the absence of a received SID frame 320 based on its detections of DTX during a deduced silence interval. The UE 115 may adjust an inactivity timer to have a larger value to account for any omitted SID packets or other non-voice packets Additionally, link activity can be based on a larger inactivity timer, much larger than the 160 ms SID interval, to avoid a determination of a premature call failure. Thus SID packets 320 and RTCP packets 325 can be “sacrificed” in the interest of meeting the scheduling delays. In some examples, the UE 115 may adjust a size of a receive buffer associated with the IP flow to accommodate a delay associated with the first coverage enhancement level, the second coverage enhancement level, or both.

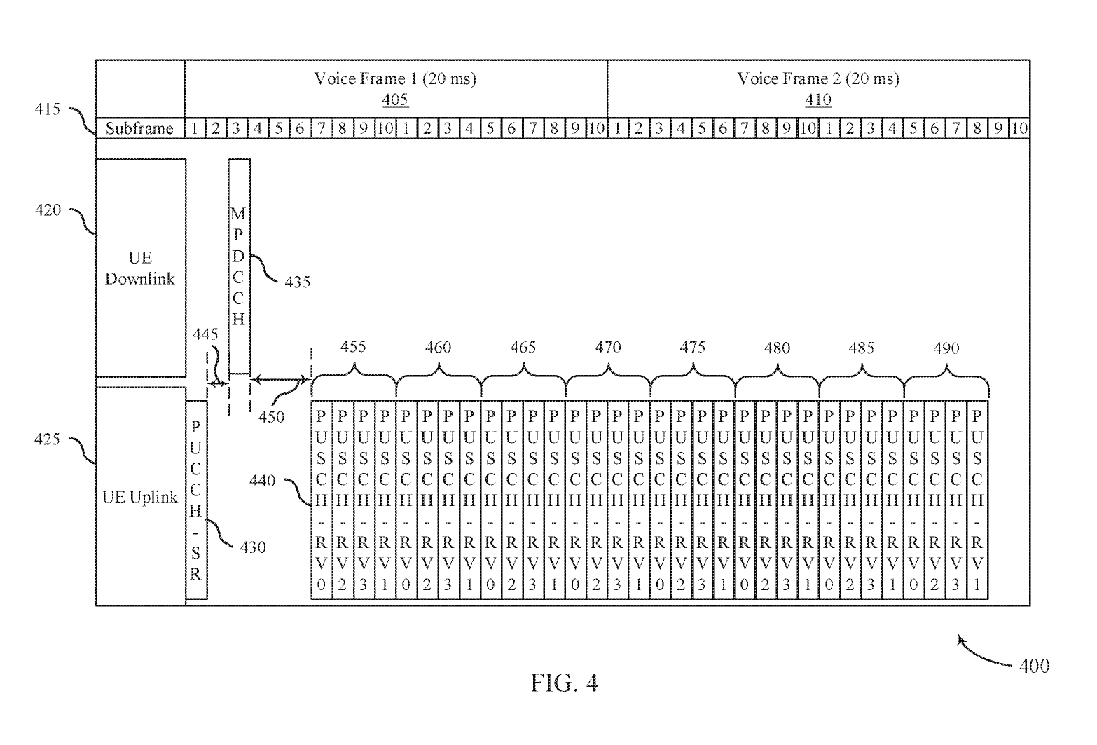

FIG. 4 illustrates an example of a time delay budget 400 for differential scheduling for real-time communication services. The time delay budget 400 in this example may utilize a first CE level employed within the systems 100 or 200 of FIG. 1 or 2. In this example, a first 20 ms voice frame 405 and a second 20 ms voice frame 410 are illustrated. In some examples, as discussed above, voice packets are generated for each 20 ms voice frame 405-410. In certain examples, voice packets from the first voice frame 405 and the second voice frame 410 may be bundled into a single MAC packet that may be transmitted according to a set CE level.

Data may be transmitted in subframes 415 associated with each voice frame 405-410 as its expected transmission completion time to meet the VoIP timelines, which may include half-duplex UE downlink transmissions 420 and UE uplink transmissions 425. In this example, the UE (e.g., a UE 115 of FIGS. 1-3) may bundle voice packets from two voice frames and transmit a SR in a PUCCH transmission 430. After a first tuning gap 445, the UE may receive an MPDCCH transmission 435 that may include an allocation for uplink resources to transmit the voice data. After a second tuning gap 450, PUSCH transmissions 440 may be transmitted. In this example, the CE level provides for 32 repetitions of the PUSCH data, which may be performed through four redundancy versions (RV) of the data that may be repeated eight times as PUSCH transmissions 455-490. In this example, the PUSCH transmissions are completed by the end of the second voice frame 410, and thus timelines for the IP flow are met.

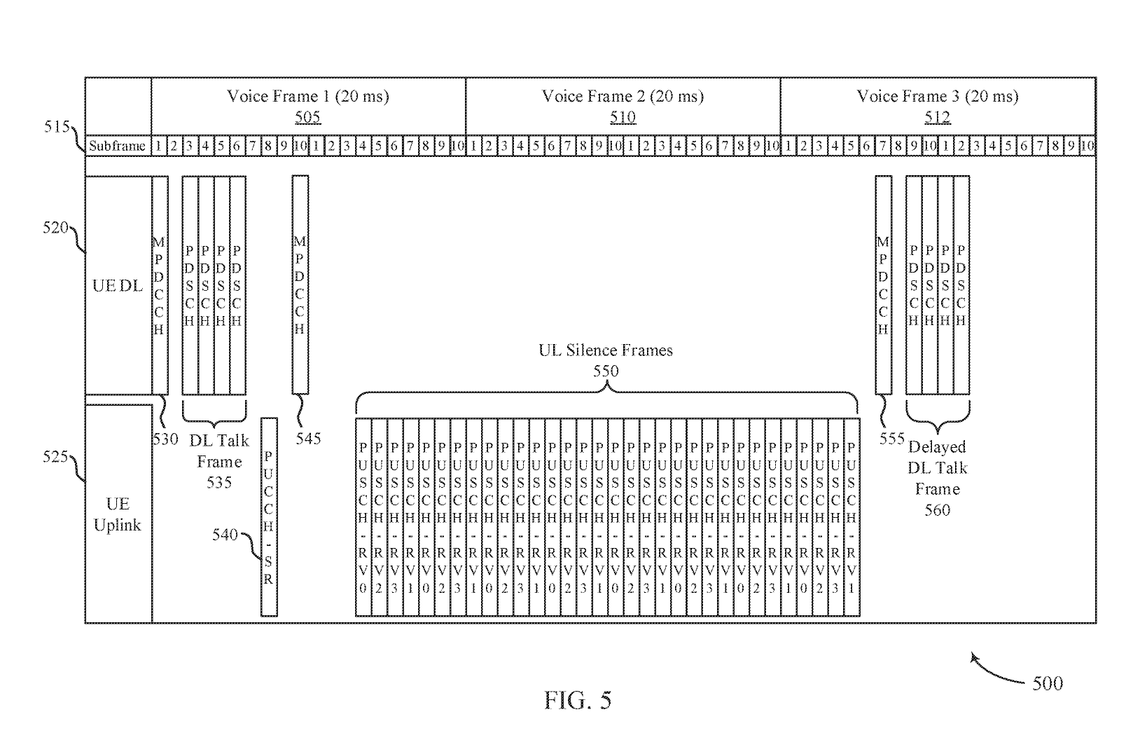

However, in the event that a SID packet may be transmitted, the timelines for the IP flow may be negatively impacted. An illustration of such a situation is provided in FIG. 5, which illustrates an example of another time delay budget 500 in which voice data, such as full duplex voice data, and SID data are transmitted. The time delay budget 500 in this example may utilize a first CE level employed within the systems 100 or 200 of FIG. 1 or 2 for both voice data and SID packets. In this example, a first 20 ms voice frame 505, a second 20 ms voice frame 510, and a third 20 ms voice frame 512 are illustrated.

In this example, downlink talk data may be received at a UE. Data may be transmitted in subframes 515 associated with each voice frame 505-512, which may include half-duplex UE downlink transmissions 520 and UE uplink transmissions 525. In this example, the UE (e.g., a UE 115 of FIGS. 1-3) may receive bundle voice packets from two voice frames and receive a resource allocation in a MPDCCH transmission 530. After a cross subframe scheduling delay, PDSCH transmissions 535 with a downlink talk frame may be received at the UE. In this example, the UE may have a SID packet to be transmitted, and may transmit a SR 540 via a PUCCH transmission after a tuning gap. The UE may receive an MPDCCH transmission 545, and after a tuning gap may transmit uplink silence frames 550 using a PUSCH. In this example, the CE level provides for 32 repetitions of the PUSCH data, which may be performed through four redundancy versions (RV) of the data that may be repeated eight times to provide 32 repetitions. In this example, the PUSCH transmissions for the uplink silence frames 550 are completed after the end of the second voice frame 510. A second MPDCCH downlink transmission 555 may then be received at the UE, followed by a second downlink talk frame 560. Because the PUSCH transmissions for the uplink silence frames 550 are completed after the end of the second voice frame 510, the second downlink talk frame 560 is delayed well into the third voice frame 512, and thus timelines for the IP flow are not met for the second downlink talk frame 560. In the event that multiple such delays are encountered, the call quality for the voice call may suffer. Furthermore, if other low priority traffic, such as RTCP is to be transmitted, the second downlink talk frame 560 would be delayed further.

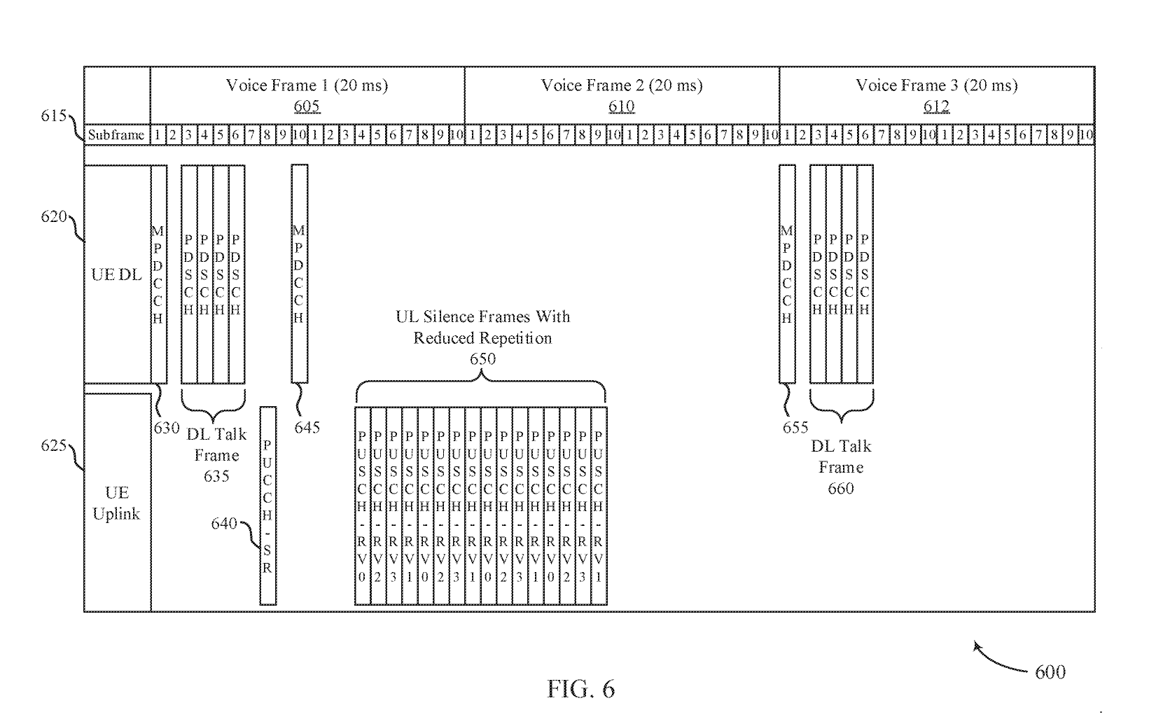

FIG. 6 illustrates an example of another time delay budget 600 for differential scheduling for real-time communication services. The time delay budget 600 in this example may utilize a first CE level for higher priority data, and a second CE level for lower priority data, and may be employed within the systems 100 or 200 of FIG. 1 or 2 for both voice data and other lower priority data. In this example, a first 20 ms voice frame 605, a second 20 ms voice frame 610, and a third 20 ms voice frame 612 are illustrated.

In this example, downlink talk data may be received at a UE. Data may be transmitted in subframes 615 associated with each voice frame 605-612, which may include half-duplex UE downlink transmissions 620 and UE uplink transmissions 625. In this example, the UE (e.g., a UE 115 of FIGS. 1-3) may receive bundled voice packets from two voice frames and receive a resource allocation in a MPDCCH transmission 630. After a cross subframe scheduling delay, PDSCH transmissions 635 with a downlink talk frame may be received at the UE. In this example, the UE may have a SID packet to be transmitted, and may transmit a SR 640 via a PUCCH transmission after a tuning gap. The UE may receive an MPDCCH transmission 645, and after a tuning gap may transmit uplink silence frames 650 using a PUSCH. In this example, a lower CE level is used for SID packets, in which voice data may have a first CE level that provides for 32 repetitions, and SID packets may have a second CE level that provides 16 repetitions. The UE may mark the lower priority traffic with a separate preconfigured DSCP to help any other entities like the eNB or the far-end UE to identify such packets as low priority and a second CE level. Thus, in this example, uplink silence frames 650 may be transmitted through four redundancy versions (RVs) of the data that may be repeated four times to provide 16 repetitions. In this example, the PUSCH transmissions for the uplink silence frames 650 are completed before the end of the second voice frame 610. A second MPDCCH downlink transmission 655 may then be received at the UE at the start of the third voice frame 612, followed by a second downlink talk frame 660. Because the PUSCH transmissions for the uplink silence frames 650 are completed before the end of the second voice frame 610, the timelines for the IP flow are met for the second downlink talk frame 660.

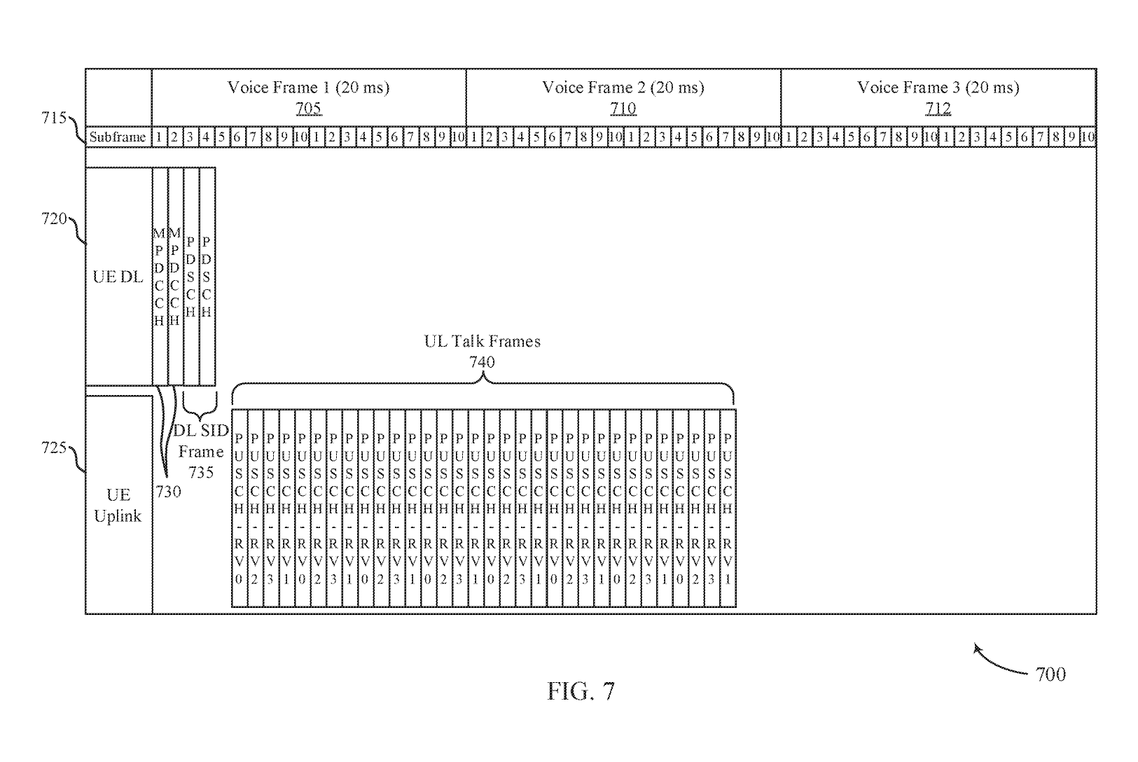

Similar techniques may be used for downlink SID transmissions. FIG. 7 illustrates an example of another time delay budget 700 for differential scheduling for real-time communication services. The time delay budget 700 in this example may utilize a first CE level for higher priority data, and a second CE level for lower priority data, and may be employed within the systems 100 or 200 of FIG. 1 or 2 for both voice data and other lower priority data. In this example, a first 20 ms voice frame 705, a second 20 ms voice frame 710, and a third 20 ms voice frame 712 are illustrated.

In this example, downlink SID data may be received at a UE. Data may be transmitted in subframes 715 associated with each voice frame 705-712, which may include half-duplex UE downlink transmissions 720 and UE uplink transmissions 725. In this example, the UE (e.g., a UE 115 of FIGS. 1-3) may receive bundled voice packets from two voice frames and receive a resource allocation in a MPDCCH transmission 730. PDSCH transmissions 735 may include a downlink SID frame and may be received at the UE. In this example, the UE may have uplink talk frames 740 to be transmitted, which may be transmitted following a tuning gap after the downlink SID frame 735. In this example, a lower CE level is used for SID packets, in which voice data may have a first CE level that provides for 32 repetitions, and SID packets may have a second CE level that provides fewer repetitions. Wireless resources of the third voice frame 712 are thus free for additional transmissions, and the timelines for the IP flow are met.

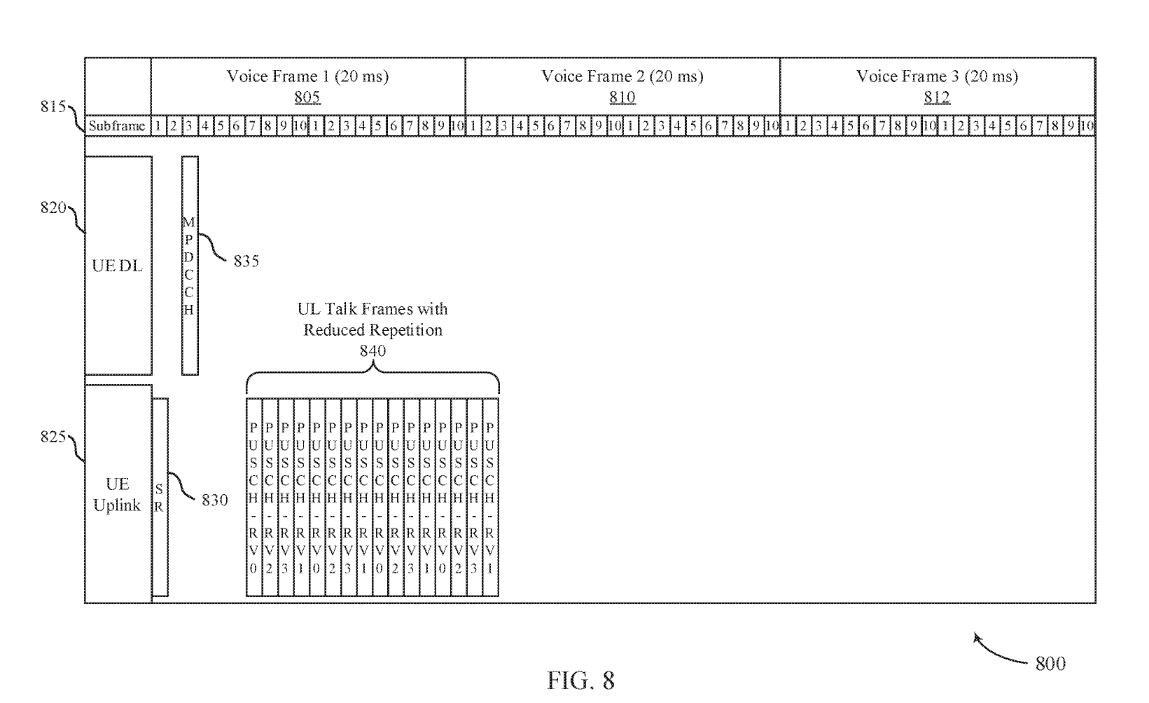

As indicated above, in some examples CE levels for higher priority data and lower priority data may be selected based on channel conditions at a UE, and reduced CE levels may be selected in cases where a UE is experiencing relatively favorable channel conditions. FIG. 8 illustrates such an example of a time delay budget 800 for differential scheduling for real-time communication services. The time delay budget 800 in this example may utilize a first CE level for higher priority data, and a second CE level for lower priority data, and may be employed within the systems 100 or 200 of FIG. 1 or 2 for both voice data and other lower priority data. In this example, a first 20 ms voice frame 805, a second 20 ms voice frame 810, and a third 20 ms voice frame 812 are illustrated.

In this example, the first CE level may be a reduced CE level that is selected based on channel conditions at the UE. In this example, the UE may bundle voice packets from two voice frames and transmit a SR in a PUCCH transmission 830. After a tuning gap the UE may receive an MPDCCH transmission 835 that may include an allocation for uplink resources to transmit the voice data. After a second tuning gap PUSCH transmissions 840 may be transmitted. In this example, the reduced CE level provides for 16 repetitions of the PUSCH data, which may be performed through four redundancy versions (RV) of the data that may be repeated four times. In this example, the PUSCH transmissions 840 are completed early in the second voice frame 810, and thus timelines for the IP flow are met, and remaining wireless resources of the second voice frame 810 and third voice frame 812 are thus free for additional transmissions, and the timelines for the IP flow are met.

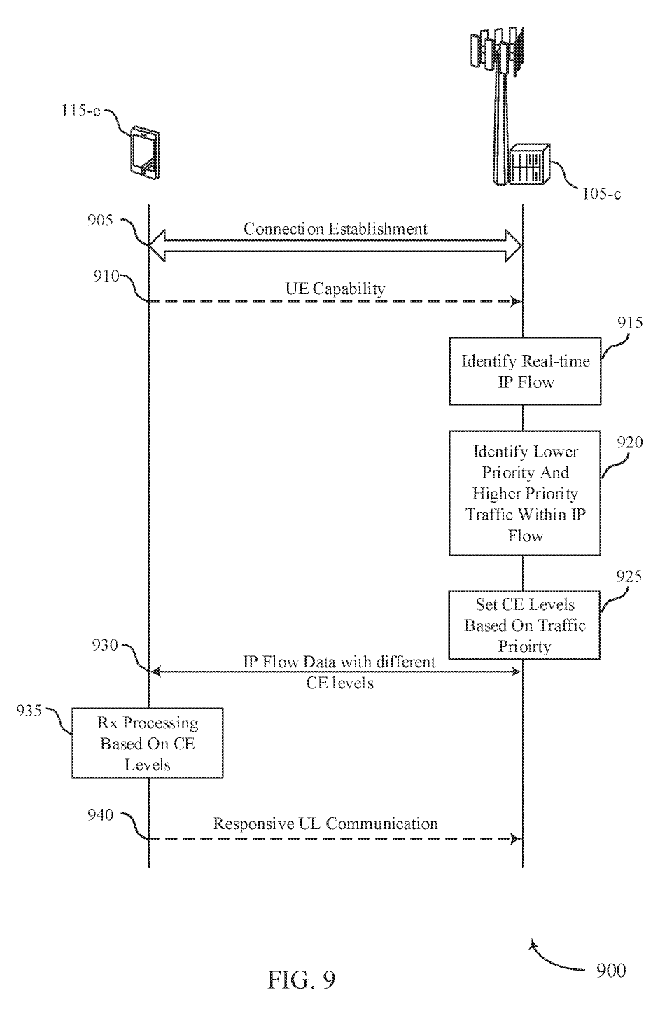

FIG. 9 illustrates an example of a process flow 900 for differential scheduling for real-time communication services and voice activity based half-duplex calling. The diagram 900 may illustrate aspects of differential scheduling techniques employed within the systems 100 or 200 of FIG. 1 or 2. The diagram 900 includes a UE 115-e and a base station 105-c, which may be examples of a UE 115 and base station 105 of FIGS. 1-3. The UE 115-e may be an CAT-M1 device or may have a channel quality metric that is below a threshold value (e.g., signal to noise (SNR) ratio falls between a SNR threshold), and thus the UE 115-e and the base station 105-c may be employing CE techniques. The UE 115-e and base station 105-c may establish a connection 905. Optionally, UE 115-e may transmit a UE capability indication 910, which may be in response to a UE capability inquiry received from the base station 105-c.

At block 915, the base station 105-c may identify a real-time IP flow, such as a VoLTE IP flow, that is to be initiated between the base station 105-c and the UE 115-e. Such a real-time IP flow may be identified, for example, based on a request received from the UE 115-e to initiate a real-time data service, such as a voice call.

At block 920, the base station 105-c may identify lower priority traffic and higher priority traffic within the IP flow. In examples that have voice data in the real-time IP flow, the lower priority traffic may include, for example, SID packets, or RTCP data packets, and the higher priority traffic may include voice data packets.

At block 925, the base station 105-c may set CE levels for the different priority traffic. For example, voice data packets may be set to have a higher CE level, thus making successful transmission are receipt of such packets more likely and reliable, while SID or RTCP packets may be set to have a lower CE level. In the event that the lower priority data is not successfully received at the UE 115-e, the UE 115-e and base station 105-c may still meet real-time timelines, and the UE 115-e may adjust one or more operations to account for missing lower priority data (e.g., by inserting comfort noise in the event of a missing SID packet). The IP flow 930 may be initiated with the different CE levels for the different priorities of data.

At block 935, the UE 115-e may perform receive processing based on the associated CE levels of the data. Such receive processing may include, for example, demodulation and decoding of received transmissions, combining of related transmissions according to a CE level of the transmissions, HARQ processing, etc. The UE 115-e may transmit, in some cases, one or more responsive uplink communications 940 (e.g., HARQ ACK/NACK feedback) based on the receive processing.

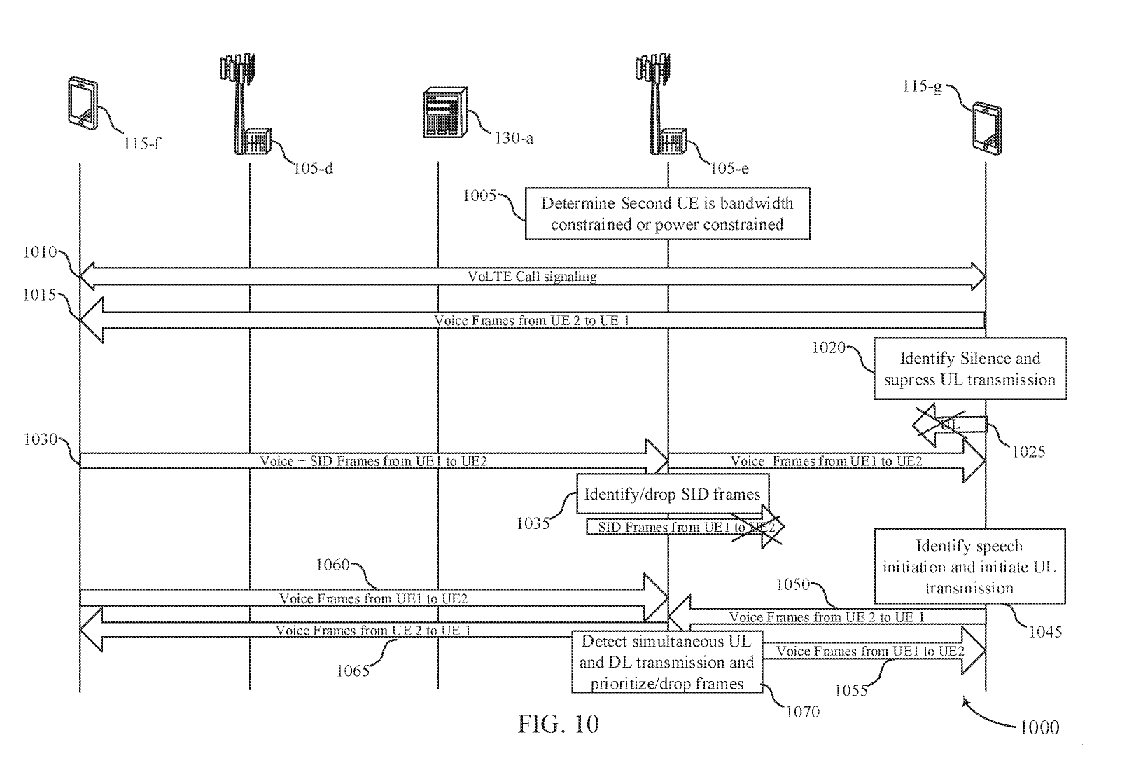

FIG. 10 illustrates an example of a process flow 1000 for voice activity based half-duplex calling. The diagram 1000 may illustrate aspects of voice activity based half-duplex calling employed within the systems 100 or 200 of FIG. 1 or 2. The diagram 1000 includes a first UE 115-f, a second UE 115-g, a first base station 105-d, a second base station 105-e, and a core network component 130-a, which may be examples of a UE 115, base station 105, and core network 130 of FIGS. 1-2. The second UE 115-g may be an CAT-M1 device or may be a power limited device, and thus the second UE 115-g and the second base station 105-e may employ voice activity based half duplex calling techniques.

The second base station 105-e may, at block 1005, determine that the second UE 115-g is bandwidth constrained or power constrained. Such a determination may be made based on signaling from the second UE 115-g, similarly as discussed above. The first UE 115-f, first base station 105-d, core network 130-a, second base station 105-e and second UE 115-g may establish a data flow (e.g., VoLTE connection) via VoLTE call signaling 1010. In some examples, the VoLTE call signaling may also indicate that non-voice frames, such as SID frames, may be omitted upon detection of the commencement of a silence period. The first UE 115-f and second UE 115-g may then exchange voice frames 1015 via the data flow. At block 1020, the second UE 115-g may identify silence, and suppress uplink transmissions 1025 of non-voice data (e.g., SID frames) that would otherwise be transmitted via the data flow. During the silence period, the first UE 115-f may continue to transmit voice and/or non-voice (e.g., SID) frames 1030 via the data flow. The second base station 105-e, at block 1035, may identify and drop the non-voice or SID frames transmitted by the first UE 115-f, such that only voice frames are transmitted to the second UE 115-g via the data flow.

At block 1045, the second UE 115-g may identify speech initiation and initiate uplink voice packet transmissions 1050 from the second UE 115-g to the first UE 115-f via the data flow. In some examples, both the first UE 115-f and the second UE 115-g may have simultaneous uplink and downlink voice frame transmissions 1050-1065. As indicated above, such simultaneous uplink and downlink voice frame transmissions 1050-1065 may starve a link budget due to all of the signaling, data and tuning gaps that are needed for the multiple uplink and downlink transmissions to each UE 115.

At block 1070, the second base station 105-e may detect the simultaneous uplink and downlink transmissions 1050-1065, and prioritize and drop frames to meet a link budget. In some examples, the dropping of one or more of the uplink voice packets or downlink voice packets may be based on a specific DSCP value configured for dropping on uplink or downlink, prioritizing of uplink packets over downlink for a configured period of time thereby dropping the downlink packets in that period to achieve the half duplex mode, proportionately dropping series of packets first from the direction (e.g., UL or DL) that is dormant while continuing the current transmission in the current direction, followed by switching to the dormant link and dropping packets from the direction that was active prior to the current direction switch, randomly dropping packets on either link proportionately until the link returns to one way transmission, or any combination thereof.

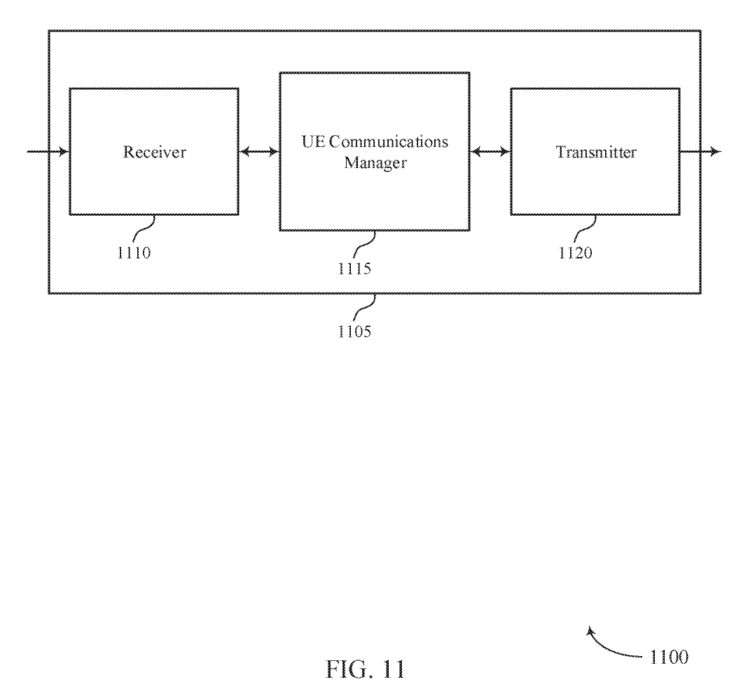

FIG. 11 shows a diagram 1100 of a wireless device 1105 that supports differential scheduling for real-time communication services and voice activity based half-duplex calling in accordance with various aspects of the present disclosure. Wireless device 1105 may be an example of aspects of a UE 115 or base station 105 as described with reference to FIGS. 1-3, 9, and 10. Wireless device 1105 may include receiver 1110, UE communications manager 1115, and transmitter 1120. Wireless device 1105 may also include a processor. Each of these components may be in communication with one another (e.g., via one or more buses).

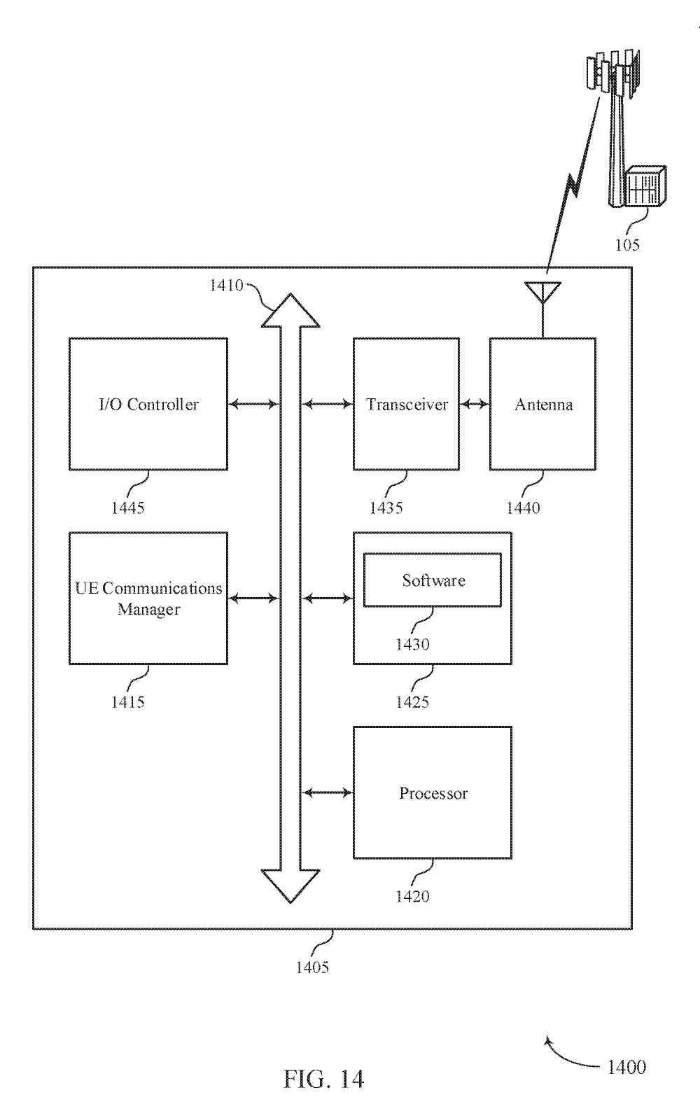

Receiver 1110 may receive information such as packets, user data, or control information associated with various information channels (e.g., control channels, data channels, information related to voice activity based half-duplex calling, and information related to differential scheduling for real-time communication services, etc.). Information may be passed on to other components of the device. The receiver 1110 may be an example of aspects of the transceiver 1435 described with reference to FIG. 14.

UE communications manager 1115 may be an example of aspects of the UE communications manager 1415 described with reference to FIG. 14.

UE communications manager 1115 may identify an IP flow containing real-time data to be transmitted to a receiver, identify traffic within the IP flow with a first priority level and traffic within the IP flow with a second priority level, the second priority level being greater than the first priority level, set a first coverage enhancement level of the traffic with the first priority level to be lower than a second coverage enhancement level of the traffic with the second priority level, and transmit data for the IP flow based on the first coverage enhancement level and the second coverage enhancement level. In some cases, the UE communications manager 1115 may also identify an IP flow containing real-time data to be received at a receiver, identify a first coverage enhancement level for traffic with a first priority level within the IP flow and a second coverage enhancement level for traffic with a second priority level within the IP flow, the second priority level being greater than the first priority level, adjust an expected reception time of the traffic with the first priority level based on the first coverage enhancement level, and receive data for the IP flow based on the first coverage enhancement level and the second coverage enhancement level.

In some cases, UE communications manager 1115 may format voice data into voice packets to be transmitted to a receiver in a voice call over a packet-switched connection, initiate transmission of voice packets to the receiver, detect a commencement of a silence period in the voice data, and transition to a discontinuous transmission mode based on detecting the silence period.

Transmitter 1120 may transmit signals generated by other components of the device. In some examples, the transmitter 1120 may be collocated with a receiver 1110 in a transceiver module. For example, the transmitter 1120 may be an example of aspects of the transceiver 1435 described with reference to FIG. 14. The transmitter 1120 may include a single antenna, or it may include a set of antennas.

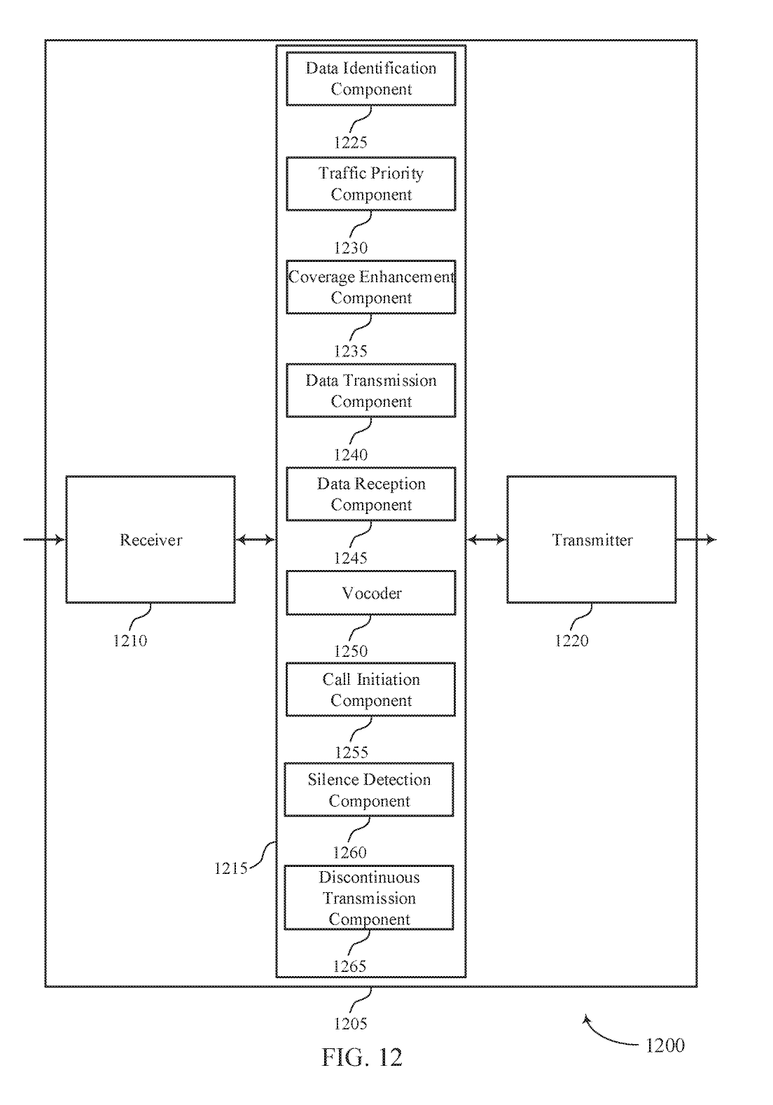

FIG. 12 shows a diagram 1200 of a wireless device 1205 that supports differential scheduling for real-time communication services and voice activity based half-duplex calling in accordance with various aspects of the present disclosure. Wireless device 1205 may be an example of aspects of a wireless device 1105 or a UE 115 or base station 105 as described with reference to FIGS. 1-3 and 9-11. Wireless device 1205 may include receiver 1210, UE communications manager 1215, and transmitter 1220. Wireless device 1205 may also include a processor. Each of these components may be in communication with one another (e.g., via one or more buses).

Receiver 1210 may receive information such as packets, user data, or control information associated with various information channels (e.g., control channels, data channels, information related to voice activity based half-duplex calling, and information related to differential scheduling for real-time communication services, etc.). Information may be passed on to other components of the device. The receiver 1210 may be an example of aspects of the transceiver 1435 described with reference to FIG. 14.

UE communications manager 1215 may be an example of aspects of the communications manager 1415 described with reference to FIG. 14. UE communications manager 1215 may also include data identification component 1225, traffic priority component 1230, coverage enhancement component 1235, data transmission component 1240, data reception component 1245, vocoder 1250, call initiation component 1255, silence detection component 1260, and discontinuous transmission component 1265.

Data identification component 1225 may identify an IP flow containing real-time data to be transmitted to a receiver and identify an IP flow containing real-time data to be received at a receiver.

Traffic priority component 1230 may identify traffic within the IP flow with a first priority level and traffic within the IP flow with a second priority level, the second priority level being greater than the first priority level. In some cases, the traffic priority component 1230 may set the first coverage enhancement level based on the identified packets of non-voice data, and set a second coverage enhancement level for voice data traffic with a second priority level within the IP flow, the second priority level being greater than the first priority level. In some cases, the real-time data includes voice data and where the lower priority traffic within the IP flow includes non-voice data and the higher priority traffic within the IP flow includes voice data. In some cases, the lower priority traffic includes one or more of a SID packet, or RTCP data. In some cases, the real-time data includes voice data and where the lower priority traffic within the IP flow includes non-voice data and the higher priority traffic within the IP flow includes voice data. In some cases, the lower priority traffic includes one or more of a SID packet, or RTCP data.

Coverage enhancement component 1235 may set a first coverage enhancement level of the traffic with the first priority level to be lower than a second coverage enhancement level of the traffic with the second priority level, adjust an expected reception time of the traffic with the first priority level based on the first coverage enhancement level, or set the first coverage enhancement level based on the identified amount of other traffic or the non-voice data metric. In some cases, coverage enhancement component 1235 may identify one or more of an amount of other traffic other than the data for the IP flow or a non-voice data metric based on a DSCP value of the non-voice data and one or more of a QCI, a UE category, an APN, an IP address, or an IP subnet associated with the non-voice data. In some cases, coverage enhancement component 1235 may identify packets of non-voice data based on deep packet inspection and find a match with a partial set of data to deduce the presence of non-voice data, where the non-voice data may be associated with one or more of a QCI, a UE category, an APN, an IP address, or an IP subnet. In some cases, coverage enhancement component 1235 may identify non-voice data based on an out-of-band indication from one or more upper layers of a protocol stack or an application layer, where the non-voice data may be associated with one or more of a QCI, a UE category, an APN, an IP address, or an IP subnet, set the first coverage enhancement level based on the identified non-voice data. In further cases, coverage enhancement component 1235 may identify one or more of an amount of other traffic other than the data for the IP flow or a non-voice data metric based on a packet size of the non-voice data and one or more of a QCI, a UE category, an APN, an IP address, or an IP subnet associated with the non-voice data.

In some cases, the identifying the first coverage enhancement level and the second coverage enhancement level includes receiving signaling that indicates the IP flow contains the traffic with the first priority level and the traffic with the second priority level. In some cases, the first coverage enhancement level has a lower number of repetitions than the second coverage enhancement level. In some cases, the repetition is achieved via TTI bundling schedule-based repetition or a HARQ retransmission schedule. In some cases, the first coverage enhancement level allows the traffic with the second priority level within the IP flow to have a higher likelihood of meeting timelines for voice data service. In some cases, the adjusting an expected reception time includes adjusting an expected reception time of a RTCP data packet or a SID packet based on the second coverage enhancement level.

Data transmission component 1240 may transmit data for the IP flow based on the first coverage enhancement level and the second coverage enhancement level and opportunistically transmit a RTCP data packet during a period within the IP flow that is unoccupied by one or more of a real-time data packet or a SID packet. In some cases, the transmitting the data for the IP flow includes transmitting the data for the IP flow from a UE to a base station or transmitting the data for the IP flow from the base station to the UE.

Data reception component 1245 may receive data for the IP flow based on the first coverage enhancement level and the second coverage enhancement level.

Vocoder 1250 may format voice data into voice packets to be transmitted to a receiver in a voice call over a packet-switched connection. Various different vocoders may be used, such as, for example, an AMR12.2 Vocoder that may provide voice packets with a packet size of 31 bytes. Call initiation component 1255 may initiate transmission of the voice packets to a receiving device. Such call initiation may be performed through VoLTE call signaling, for example.

Silence detection component 1260 may detect a commencement of a silence period in the voice data and detect, following the commencement of the silence period, a talk period in the voice data. Silence detection may be performed according to one or more established and known techniques for detection of the commencement and ending of silence periods, such as based on sound level and duration thresholds for detection silence and talking.

Discontinuous transmission component 1265 may transition the device 1205 to a discontinuous transmission mode based on detecting the silence period and transition to a transmit/receive mode from the discontinuous transmission mode. In some cases, the transitioning to the discontinuous transmission mode includes discontinuing periodic transmissions of one or more of a SID packet or a RTCP packet. In some cases, the discontinuous transmission mode is a receive-only mode or power save mode.

Transmitter 1220 may transmit signals generated by other components of the device. In some examples, the transmitter 1220 may be collocated with a receiver 1210 in a transceiver module. For example, the transmitter 1220 may be an example of aspects of the transceiver 1435 described with reference to FIG. 14. The transmitter 1220 may include a single antenna, or it may include a set of antennas.

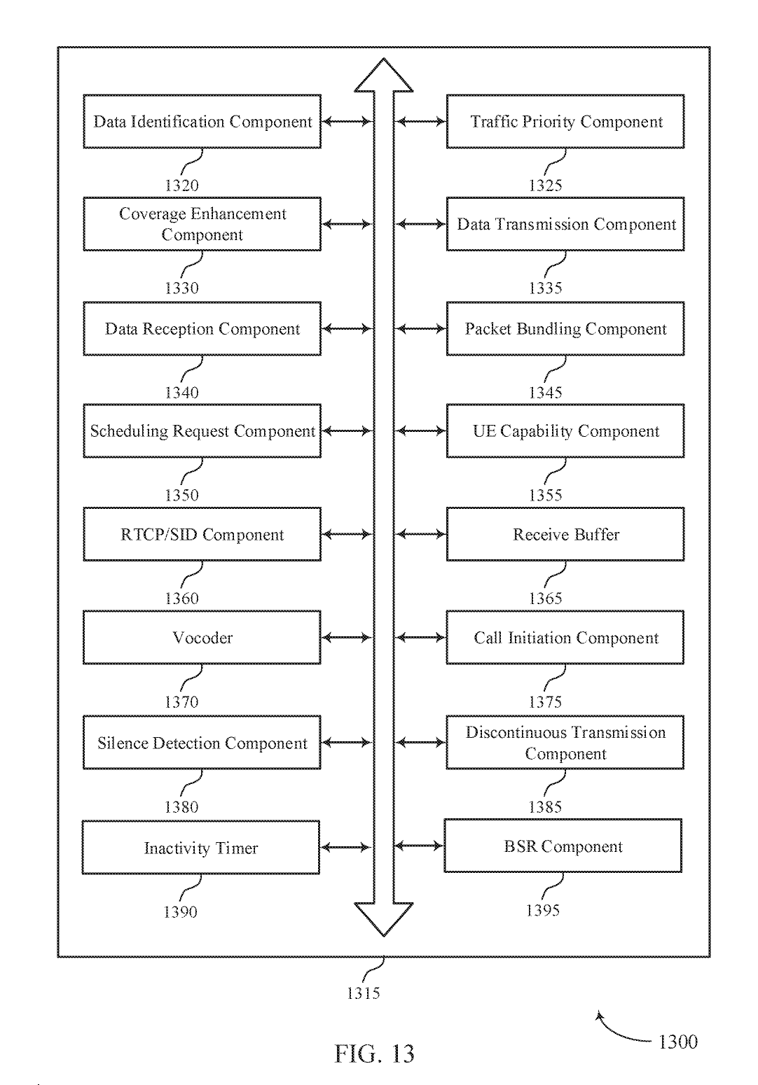

FIG. 13 shows a diagram 1300 of a communications manager 1315 that supports differential scheduling for real-time communication services and voice activity based half-duplex calling in accordance with various aspects of the present disclosure. The communications manager 1315 may be an example of aspects of a communications manager 1115, UE communications manager 1215, or a communications manager 1415 described with reference to FIGS. 11, 12, and 14. The communications manager 1315 may include data identification component 1320, traffic priority component 1325, coverage enhancement component 1330, data transmission component 1335, data reception component 1340, packet bundling component 1345, scheduling request component 1350, UE capability component 1355, RTCP/SID component 1360, receive buffer 1365, vocoder 1370, call initiation component 1375, silence detection component 1380, discontinuous transmission component 1385, inactivity timer 1390, and BSR component 1395. Each of these modules may communicate, directly or indirectly, with one another (e.g., via one or more buses).

Data identification component 1320 may identify an IP flow containing real-time data to be transmitted to a receiver and identify an IP flow containing real-time data to be received at a receiver.

Traffic priority component 1325 may identify traffic within the IP flow with a first priority level and traffic within the IP flow with a second priority level, the second priority level being greater than the first priority level, set the first coverage enhancement level based on the identified packets of non-voice data, and identify the traffic with the first priority level and the traffic with the second priority level. In some cases, the real-time data includes voice data and where the lower priority traffic within the IP flow includes non-voice data and the higher priority traffic within the IP flow includes voice data. In some cases, the lower priority traffic includes one or more of a SID packet, or RTCP data.

Coverage enhancement component 1330 may set a first coverage enhancement level of the traffic with the first priority level to be lower than a second coverage enhancement level of the traffic with the second priority level, adjust an expected reception time of the traffic with the first priority level based on the first coverage enhancement level, or set the first coverage enhancement level based on the identified amount of other traffic or the non-voice data metric. In some cases, coverage enhancement component 1330 may identify one or more of an amount of other traffic other than the data for the IP flow or a non-voice data metric based on a DSCP value of the non-voice data and one or more of a QCI, a UE category, an APN, an IP address, or an IP subnet associated with the non-voice data. In some cases, coverage enhancement component 1330 may identify packets of non-voice data based on deep packet inspection and find a match with a partial set of data to deduce the presence of non-voice data, where the non-voice data may be associated with one or more of a QCI, a UE category, an APN, an IP address, or an IP subnet. In some cases, coverage enhancement component 1330 may identify non-voice data based on an out-of-band indication from one or more upper layers of a protocol stack or an application layer, where the non-voice data may be associated with one or more of a QCI, a UE category, an APN, an IP address, or an IP subnet, set the first coverage enhancement level based on the identified non-voice data. In further cases, coverage enhancement component 1330 may identify one or more of an amount of other traffic other than the data for the IP flow or a non-voice data metric based on a packet size of the non-voice data and one or more of a QCI, a UE category, an APN, an IP address, or an IP subnet associated with the non-voice data. Once coverage enhancement component 1330 identifies the data, it may mark the packet with a separate DSCP value to assist other nodes in the route to identify the traffic with a first priority level. In further cases, coverage enhancement component 1330 may identify that the amount of traffic level on IP flow for voice service is low (e.g., amount of traffic of the data fall is below or does not satisfy a threshold value) and that scheduler may be able to accommodate the traffic with the first priority level with the same coverage enhancement as the second coverage enhancement level temporarily in such cases.

In some cases, the identifying the first coverage enhancement level and the second coverage enhancement level includes receiving signaling that indicates the IP flow contains the traffic with the first priority level and the traffic with the second priority level. In some cases, the first coverage enhancement level has a lower number of repetitions than the second coverage enhancement level. In some cases, the repetition is achieved via TTI bundling schedule-based repetition or a HARQ retransmission schedule. In some cases, the first coverage enhancement level allows the traffic with the second priority level within the IP flow to have a higher likelihood of meeting timelines for voice data service. In some cases, the adjusting an expected reception time includes adjusting an expected reception time of a RTCP data packet or a SID packet based on the second coverage enhancement level.

Data transmission component 1335 may transmit data for the IP flow based on the first coverage enhancement level and the second coverage enhancement level and opportunistically transmit a RTCP data packet during a period within the IP flow that is unoccupied by one or more of a real-time data packet or a SID packet. In some cases, the transmitting the data for the IP flow includes transmitting the data for the IP flow from a UE to a base station or transmitting the data for the IP flow from the base station to the UE.

Data transmission component 1335 may provide voice packets to a transmitter to be transmitted to a receiving device, and in some examples may transmit, based on detecting a silence period, an indicator in an SPS uplink transmission that the SPS resource allocation can be released.

Data reception component 1340 may receive data for the IP flow based on the first coverage enhancement level and the second coverage enhancement level. In some cases, data reception component 1340 may receive voice packets over the packet-switched connection, determine that a voice packet has not been received for a predetermined time period, determine, based on one or more of ongoing communication with a UE or a UE reported channel quality, that the voice call is to be maintained in an absence of receiving one or more voice packets for a predetermined time period as a result of the discontinuous transmission mode, and determine, based on one or more of ongoing communication with a base station or on a measured channel quality that a data flow for the voice call is to be maintained in an absence of receiving one or more voice packets from the base station for a predetermined time period as a result of the discontinuous transmission mode during the data flow.

Packet bundling component 1345 may bundle two or more real-time data frames into a bundled packet to be transmitted in the IP flow.

Scheduling request component 1350 may configure a base station to assign an initial SR grant of a minimum size to meet a transport block size of the bundled packet, a repetition level associated with the channel measurement report from the UE or a minimum required grant to accommodate a transport block size of the IP flow. In some cases, scheduling request component 1350 may receive a SPS resource allocation for transmitting the voice packets to the receiver, receive a release of the SPS resource allocation, and/or skip a SR transmission based on detecting the silence period.

UE capability component 1355 may signal to one or more receivers of the IP flow to indicate the IP flow contains the traffic with the first priority level and the traffic with the second priority level, determine that a UE that is to communicate using the IP flow containing real-time data is a bandwidth restricted UE operating in a coverage enhancement mode or power limited mode, or that the UE is a bandwidth unrestricted UE with a channel quality metric that is less than a threshold value. In some cases, the signaling is transmitted to one or more of a receiving base station or a far-end UE that is to receive the IP flow. In some cases, the determining includes receiving a UE capability report that the UE is a bandwidth or power limited device or operating in coverage enhancement mode, a channel measurement report from the UE that indicates the UE is bandwidth restricted and operating in the coverage enhancement mode or that indicates the UE is bandwidth unrestricted with the channel quality metric below the threshold value, or any combination thereof. In some cases, the initiating the voice call over the packet-switched connection further includes signaling that one or more SID packets may be omitted upon detecting the silence period.

RTCP/SID component 1360 may adjust an expected reception time of a RTCP data packet or a SID packet based on the second coverage enhancement level. RTCP/SID component 1360 may determine that a SID packet is omitted from the received voice packets and generate comfort noise based on the determining that the SID packet is omitted from the received voice packets. In some cases, the receiver may, based on the signaling that one or more SID packets may be omitted and upon detecting the commencement of the silence period in the voice data, transition to the discontinuous transmission mode or indicate in a DSCP transmission droppable packets.

Receive buffer 1365 may adjust a size of a receive buffer 1365 associated with the IP flow to accommodate a delay associated with the first coverage enhancement level or the second coverage enhancement level.

Vocoder 1370 may format voice data into voice packets to be transmitted to a receiver in a voice call over a packet-switched connection. Call initiation component 1375 may initiate transmission of the voice packets to the receiver. In some cases, the voice call is negotiated as a full-duplex or half-duplex voice over Internet protocol (VoIP) call. Silence detection component 1380 may detect a commencement of a silence period in the voice data and detect, following the commencement of the silence period, a talk period in the voice data.

Discontinuous transmission component 1385 may transition to a discontinuous transmission mode based on detecting the silence period and transition to a transmit/receive mode from the discontinuous transmission mode. In some cases, the transitioning to the discontinuous transmission mode includes discontinuing periodic transmissions of one or more of a SID packet or a RTCP packet. In some cases, the discontinuous transmission mode is a receive-only mode or power save mode.

Inactivity timer 1390 may maintain and adjust a timer to account for the omitted SID packets or other non-voice packets. BSR component 1395 may transmit a null data indication in a BSR based on detecting the silence period for SR-based scheduling.

FIG. 14 shows a diagram of a system 1400 including a device 1405 that supports differential scheduling for real-time communication services and voice activity based half-duplex calling in accordance with various aspects of the present disclosure. Device 1405 may be an example of or include the components of wireless device 1105, wireless device 1205, or a UE 115 as described above, (e.g., with reference to FIGS. 1, 11 and 12). Device 1405 may include components for bi-directional voice and data communications including components for transmitting and receiving communications, including UE communications manager 1415, processor 1420, memory 1425, software 1430, transceiver 1435, antenna 1440, and I/O controller 1445. These components may be in electronic communication via one or more busses (e.g., bus 1410). Device 1405 may communicate wirelessly with one or more base stations 105.

Processor 1420 may include an intelligent hardware device, (e.g., a general-purpose processor, a digital signal processor (DSP), a central processing unit (CPU), a microcontroller, an application-specific integrated circuit (ASIC), an field-programmable gate array (FPGA), a programmable logic device, a discrete gate or transistor logic component, a discrete hardware component, or any combination thereof). In some cases, processor 1420 may be configured to operate a memory array using a memory controller. In other cases, a memory controller may be integrated into processor 1420. Processor 1420 may be configured to execute computer-readable instructions stored in a memory to perform various functions (e.g., functions or tasks supporting differential scheduling for real-time communication services or voice activity based half-duplex calling).

Memory 1425 may include random access memory (RAM) and read only memory (ROM). The memory 1425 may store computer-readable, computer-executable software 1430 including instructions that, when executed, cause the processor to perform various functions described herein. In some cases, the memory 1425 may contain, among other things, a basic input/output system (BIOS) which may control basic hardware and/or software operation such as the interaction with peripheral components or devices.

Software 1430 may include code to implement aspects of the present disclosure, including code to support differential scheduling for real-time communication services and voice activity based half-duplex calling. Software 1430 may be stored in a non-transitory computer-readable medium such as system memory or other memory. In some cases, the software 1430 may not be directly executable by the processor but may cause a computer (e.g., when compiled and executed) to perform functions described herein.

Transceiver 1435 may communicate bi-directionally, via one or more antennas, wired, or wireless links as described above. For example, the transceiver 1435 may represent a wireless transceiver and may communicate bi-directionally with another wireless transceiver. The transceiver 1435 may also include a modem to modulate the packets and provide the modulated packets to the antennas for transmission, and to demodulate packets received from the antennas.

In some cases, the wireless device may include a single antenna 1440. However, in some cases the device may have more than one antenna 1440, which may be capable of concurrently transmitting or receiving multiple wireless transmissions.

I/O controller 1445 may manage input and output signals for device 1405. I/O controller 1445 may also manage peripherals not integrated into device 1405. In some cases, I/O controller 1445 may represent a physical connection or port to an external peripheral. In some cases, I/O controller 1445 may utilize an operating system such as iOS®, ANDROID®, MS-DOS®, MS-WINDOWS®, OS/2®, UNIX®, LINUX®, or another known operating system.

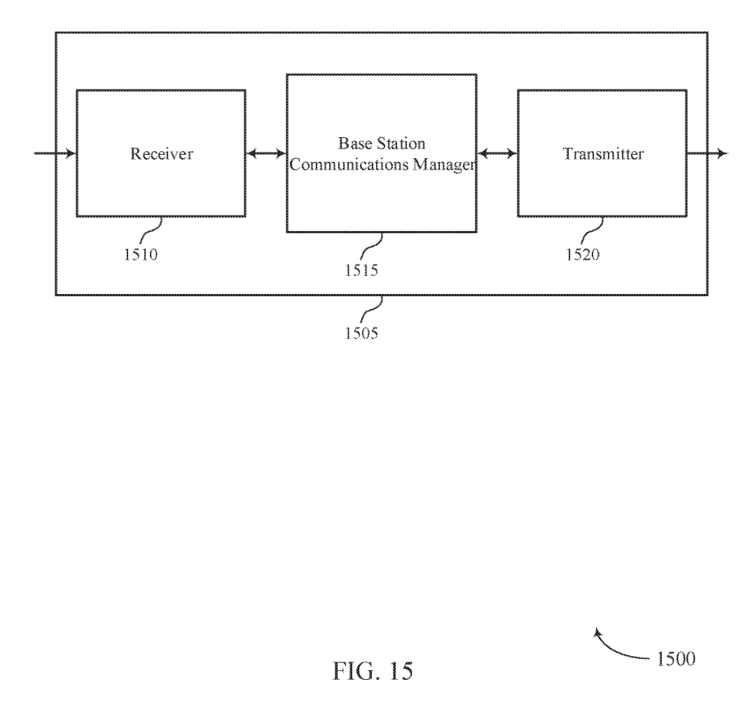

FIG. 15 shows a diagram 1500 of a wireless device 1505 that supports differential scheduling for real-time communication services and voice activity based half-duplex calling in accordance with various aspects of the present disclosure. Wireless device 1505 may be an example of aspects of a base station 105 as described with reference to FIG. 1. Wireless device 1505 may include receiver 1510, base station communications manager 1515, and transmitter 1520. Wireless device 1505 may also include a processor. Each of these components may be in communication with one another (e.g., via one or more buses).

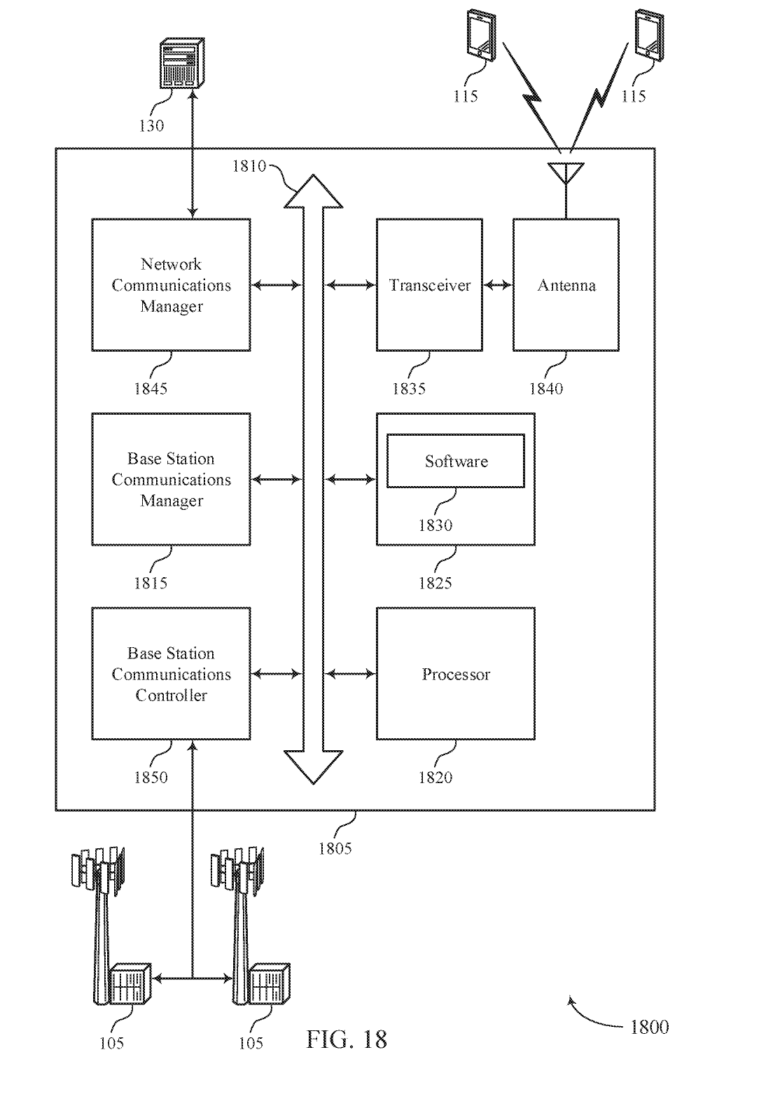

Receiver 1510 may receive information such as packets, user data, or control information associated with various information channels (e.g., control channels, data channels, information related to voice activity based half-duplex calling, and information related to differential scheduling for real-time communication services, etc.). Information may be passed on to other components of the device. The receiver 1510 may be an example of aspects of the transceiver 1835 described with reference to FIG. 18.

Base station communications manager 1515 may be an example of aspects of the base station communications manager 1815 described with reference to FIG. 18. Base station communications manager 1515 may manage communications with other base stations 105, and may include a controller or scheduler for controlling communications with UEs 115 in cooperation with other base stations 105. For example, the base station communications manager 1515 may coordinate scheduling for transmissions to UEs 115 for various interference mitigation techniques such as beamforming or joint transmission. In some examples, base station communications manager 1515 may provide an X2 interface within an Long Term Evolution (LTE)/LTE-A wireless communication network technology to provide communication between base stations 105.

In some cases, base station communications manager 1515 may initiate a voice call over a packet-switched connection with a UE, transmit voice data in downlink voice packets to the UE, detect a commencement of a silence period in the voice data, and drop one or more downlink packets based on detecting the silence period.

Transmitter 1520 may transmit signals generated by other components of the device. In some examples, the transmitter 1520 may be collocated with a receiver 1510 in a transceiver module. For example, the transmitter 1520 may be an example of aspects of the transceiver 1835 described with reference to FIG. 18. The transmitter 1520 may include a single antenna, or it may include a set of antennas.

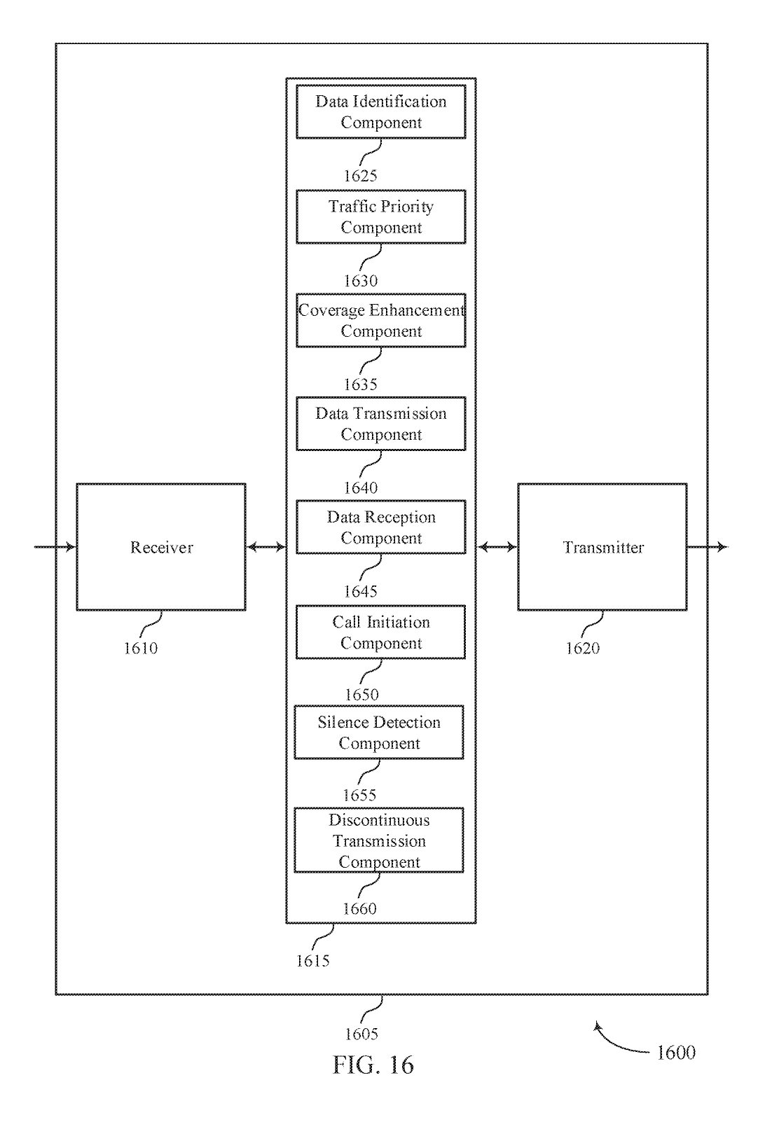

FIG. 16 shows a diagram 1600 of a wireless device 1605 that supports differential scheduling for real-time communication services and voice activity based half-duplex calling in accordance with various aspects of the present disclosure. Wireless device 1605 may be an example of aspects of a wireless device 1505 or a base station 105 as described with reference to FIGS. 1 and 15. Wireless device 1605 may include receiver 1610, base station communications manager 1615, and transmitter 1620. Wireless device 1605 may also include a processor. Each of these components may be in communication with one another (e.g., via one or more buses).

Receiver 1610 may receive information such as packets, user data, or control information associated with various information channels (e.g., control channels, data channels, information related to voice activity based half-duplex calling, and information related to differential scheduling for real-time communication services, etc.). Information may be passed on to other components of the device. The receiver 1610 may be an example of aspects of the transceiver 1835 described with reference to FIG. 18.

Base station communications manager 1615 may be an example of aspects of the base station communications manager 1815 described with reference to FIG. 18.

Base station communications manager 1615 may also include data identification component 1625, traffic priority component 1630, coverage enhancement component 1635, data transmission component 1640, data reception component 1645, call initiation component 1650, silence detection component 1655, and discontinuous transmission component 1660.

Data identification component 1625 may identify an IP flow containing real-time data to be transmitted to a receiver and identify an IP flow containing real-time data to be received at a receiver.

Traffic priority component 1630 may identify traffic within the IP flow with a first priority level and traffic within the IP flow with a second priority level, the second priority level being greater than the first priority level. In some cases, the traffic priority component 1630 may set the first coverage enhancement level based on the identified packets of non-voice data, and set a second coverage enhancement level for voice data traffic with a second priority level within the IP flow, the second priority level being greater than the first priority level. In some cases, the real-time data includes voice data and where the lower priority traffic within the IP flow includes non-voice data and the higher priority traffic within the IP flow includes voice data. In some cases, the lower priority traffic includes one or more of a SID packet, or RTCP data. In some cases, the real-time data includes voice data and where the lower priority traffic within the IP flow includes non-voice data and the higher priority traffic within the IP flow includes voice data. In some cases, the lower priority traffic includes one or more of a SID packet, or RTCP data.

Coverage enhancement component 1635 may set a first coverage enhancement level of the traffic with the first priority level to be lower than a second coverage enhancement level of the traffic with the second priority level, adjust an expected reception time of the traffic with the first priority level based on the first coverage enhancement level, or set the first coverage enhancement level based on the identified amount of other traffic or the non-voice data metric. In some cases, coverage enhancement component 1635 may identify one or more of an amount of other traffic other than the data for the IP flow or a non-voice data metric based on a DSCP value of the non-voice data and one or more of a QCI, a UE category, an APN, an IP address, or an IP subnet associated with the non-voice data.

In some cases, the identifying the first coverage enhancement level and the second coverage enhancement level includes transmitting signaling that indicates the IP flow contains the traffic with the first priority level and the traffic with the second priority level. In some cases, the first coverage enhancement level has a lower number of repetitions than the second coverage enhancement level. In some cases, the repetition is achieved via TTI bundling schedule-based repetition or a HARQ retransmission schedule. In some cases, the first coverage enhancement level allows the traffic with the second priority level within the IP flow to have a higher likelihood of meeting timelines for voice data service. In some cases, the adjusting an expected reception time includes adjusting an expected reception time of a RTCP data packet or a SID packet based on the second coverage enhancement level.

Data transmission component 1640 may transmit data for the IP flow based on the first coverage enhancement level and the second coverage enhancement level and opportunistically transmit a RTCP data packet during a period within the IP flow that is unoccupied by one or more of a real-time data packet or a SID packet. In some cases, the transmitting the data for the IP flow includes transmitting the data for the IP flow from the base station to the UE. In some cases, data transmission component 1640 may transmit voice data in downlink voice packets to the UE and resume transmission of downlink packets to the UE. In some cases, the dropping the one or more downlink packets includes inserting a silence flag into a downlink voice packet transmitted to the UE.

Data reception component 1645 may receive data for the IP flow based on the first coverage enhancement level and the second coverage enhancement level. The receiving the data for the IP flow includes receiving the data for the IP flow from the UE. In some cases, data reception component 1640 may receive voice data in uplink voice packets from the UE.

Call initiation component 1650 may initiate a voice call over a packet-switched connection with a UE.

Silence detection component 1655 may detect a commencement of a silence period in the voice data, determine the UE is a bandwidth restricted UE operating in a coverage enhancement mode, and detect a talk period in voice data following the silence period. In some cases, the detecting the silence period includes receiving indication from the UE of the silence period in one of the uplink voice packets. In some cases, the detecting the silence period includes detecting one or more downlink packets having a specific DSCP value that indicates the downlink packets belong to an IP flow associated with the voice call, and having one or more of a specific QCI or a specific APN. In some cases, the specific QCI includes a QCI assigned for one or more of an IP flow associated with the voice call, a QCI assigned for bandwidth limited transmitters, a QCI assigned for power limited transmitters, or a QCI assigned for transmitters using coverage enhancement.

In some cases, the APN includes one or more of an APN assigned to an Internet protocol multimedia subsystem (IMS), an APN assigned for bandwidth limited transmitters, an APN assigned for power limited transmitters, or an APN assigned for transmitters using coverage enhancement. In some cases, the detecting the silence period includes detecting one or more downlink packets having a packet size that is below a threshold value, that meets a specific value, or that is within a range of values. In some cases, the determining further includes determining that ongoing communications are associated with a real-time data service based on at least in part on a QCI, APN, DSCP value, or IP flow data associated with the voice call. In some cases, the QCI includes one or more of a QCI assigned for voice calls, a QCI assigned for bandwidth limited transmitters, a QCI assigned for power limited transmitters, or a QCI assigned for transmitters using coverage enhancement. In some cases, the APN includes one or more of an APN assigned to an IMS, an APN assigned for bandwidth limited transmitters, an APN assigned for power limited transmitters, or an APN assigned for transmitters using coverage enhancement. In some cases, the determining includes receiving one or more of a channel measurement report from the UE or signaling from the UE indicating that the UE is bandwidth restricted and operating in the coverage enhancement mode.

Discontinuous transmission component 1660 may drop one or more downlink packets based on detecting the silence period. In some cases, the dropping one or more downlink packets includes dropping one or more SID packet transmissions to UE.

Transmitter 1620 may transmit signals generated by other components of the device. In some examples, the transmitter 1620 may be collocated with a receiver 1610 in a transceiver module. For example, the transmitter 1620 may be an example of aspects of the transceiver 1835 described with reference to FIG. 18. The transmitter 1620 may include a single antenna, or it may include a set of antennas.

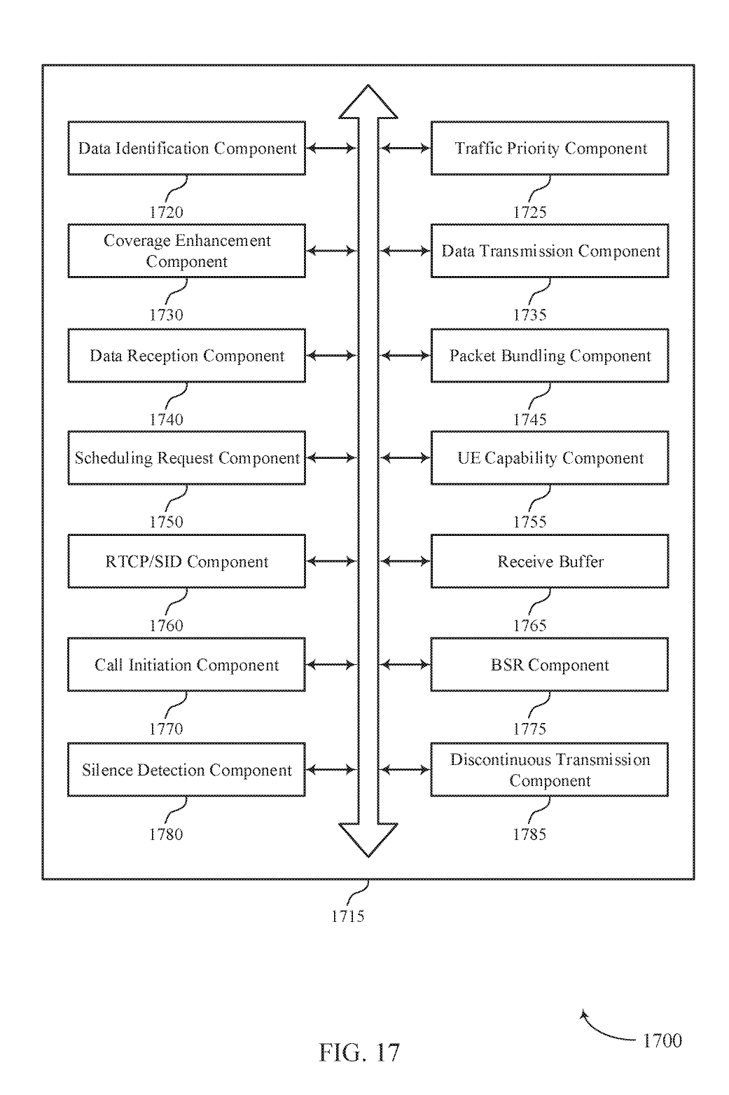

FIG. 17 shows a diagram 1700 of a base station communications manager 1715 that supports differential scheduling for real-time communication services and voice activity based half-duplex calling in accordance with various aspects of the present disclosure. The base station communications manager 1715 may be an example of aspects of a base station communications manager 1515, 1615, and 1815 described with reference to FIGS. 15, 16, and 18 respectively. The base station communications manager 1715 may include data identification component 1720, traffic priority component 1725, coverage enhancement component 1730, data transmission component 1735, data reception component 1740, packet bundling component 1745, scheduling request component 1750, UE capability component 1755, RTCP/SID component 1760, receive buffer 1765, call initiation component 1770, BSR component 1775, silence detection component 1780, and discontinuous transmission component 1785. Each of these modules may communicate, directly or indirectly, with one another (e.g., via one or more buses).

Data identification component 1720 may identify an IP flow containing real-time data to be transmitted to a receiver and identify an IP flow containing real-time data to be received at a receiver.

In some examples, data identification component 1720 may identify a simultaneous talk period in the uplink voice packets and the downlink packets and drop one or more of the uplink voice packets or downlink packets based on the identifying the simultaneous talk period. In some cases, the dropping of one or more of the uplink voice packets or downlink packets may be based on one or more of: a specific DSCP value configured for dropping packets; a prioritization of uplink packets over downlink packets for a configured period of time; a proportion of uplink packets versus downlink packets; or a random selection of packets.

Traffic priority component 1725 may identify traffic within the IP flow with a first priority level and traffic within the IP flow with a second priority level, the second priority level being greater than the first priority level, set the first coverage enhancement level based on the identified packets of non-voice data, and identify the traffic with the first priority level and the traffic with the second priority level. In some cases, the real-time data includes voice data and where the lower priority traffic within the IP flow includes non-voice data and the higher priority traffic within the IP flow includes voice data. In some cases, the lower priority traffic includes one or more of a SID packet, or RTCP data.

Coverage enhancement component 1730 may set a first coverage enhancement level of the traffic with the first priority level to be lower than a second coverage enhancement level of the traffic with the second priority level, adjust an expected reception time of the traffic with the first priority level based on the first coverage enhancement level, or set the first coverage enhancement level based on the identified amount of other traffic or the non-voice data metric. In further cases, coverage enhancement component 1730 may identify that the amount of traffic level on IP flow for voice service is low and that scheduler may be able to accommodate the traffic with the first priority level with the same coverage enhancement as the second coverage enhancement level temporarily in such cases.

Data transmission component 1735 may transmit data for the IP flow based on the first coverage enhancement level and the second coverage enhancement level and opportunistically transmit a RTCP data packet during a period within the IP flow that is unoccupied by one or more of a real-time data packet or a SID packet. In some cases, the transmitting the data for the IP flow includes transmitting the data for the IP flow from the base station to the UE. In some cases, data transmission component 1735 may transmit voice data in downlink voice packets to the UE and resume transmission of downlink packets to the UE. In some cases, the dropping the one or more downlink packets includes inserting a silence flag into a downlink voice packet transmitted to the UE.

Data reception component 1740 may receive data for the IP flow based on the first coverage enhancement level and the second coverage enhancement level. In some cases, data reception component 1740 may receive one or more uplink voice packets or non-voice packets from the UE based on the first coverage enhancement level and the second coverage enhancement level.

Packet bundling component 1745 may bundle two or more real-time data frames into a bundled packet to be transmitted in the IP flow.

Scheduling request component 1750 may be configured by a UE to assign an initial SR grant of a minimum size to meet a transport block size of the bundled packet, a repetition level associated with the channel measurement report from the UE or a minimum required grant to accommodate a transport block size of the IP flow. In some cases, scheduling request component 1750 may provide a SPS resource allocation for uplink voice packets to be received from the UE, release the SPS resource allocation upon detection of the silence period in the uplink voice packets, and discontinue scheduling of wireless resources for the UE based on the null buffer reported in the BSR.

UE capability component 1755 may signal to one or more receivers of the IP flow to indicate the IP flow contains the traffic with the first priority level and the traffic with the second priority level, determine that a UE that is to communicate using the IP flow containing real-time data is a bandwidth restricted UE operating in a coverage enhancement mode or power limited mode, or that the UE is a bandwidth unrestricted UE with a channel quality metric that is less than a threshold value. In some cases, the signaling is transmitted to one or more of a receiving base station or a far-end UE that is to receive the IP flow. In some cases, the determining includes receiving a UE capability report that the UE is a bandwidth or power limited device or operating in coverage enhancement mode, a channel measurement report from the UE that indicates the UE is bandwidth restricted and operating in the coverage enhancement mode or that indicates the UE is bandwidth unrestricted with the channel quality metric below the threshold value, or any combination thereof. In some cases, UE capability component 1755 may determine the UE is a power limited UE.

RTCP/SID component 1760 may adjust an expected reception time of a RTCP data packet or a SID packet based on the second coverage enhancement level. In some cases, RTCP/SID component 1760 may determine one or more RTCP or SID packets are dropped, and in some examples may add comfort noise in response to a dropped SID.

Receive buffer 1765 may adjust a size of a receive buffer 1765 associated with the IP flow to accommodate a delay associated with the first coverage enhancement level or the second coverage enhancement level.

Call initiation component 1770 may initiate a voice call over a packet-switched connection with a UE. BSR component 1775 may receive a BSR from the UE indicating a null buffer at the UE.

Silence detection component 1780 may detect a commencement of a silence period in the voice data, determine the UE is a bandwidth restricted UE operating in a coverage enhancement mode, and, detect a talk period in voice data following the silence period. In some cases, the detecting the silence period includes receiving indication from the UE of the silence period in one of the uplink voice packets. In some cases, the detecting the silence period includes detecting one or more downlink packets having a specific DSCP value that indicates the downlink packets belong to an IP flow associated with the voice call, and having one or more of a specific QCI or a specific APN. In some cases, the specific QCI includes a QCI assigned for one or more of an IP flow associated with the voice call, a QCI assigned for bandwidth limited transmitters, a QCI assigned for power limited transmitters, or a QCI assigned for transmitters using coverage enhancement. In some cases, the APN includes one or more of an APN assigned to an IMS, an APN assigned for bandwidth limited transmitters, an APN assigned for power limited transmitters, or an APN assigned for transmitters using coverage enhancement. In some cases, the detecting the silence period includes detecting one or more downlink packets having a packet size that is below a threshold value, that meets a specific value, or that is within a range of values.

In some cases, the determining further includes determining that ongoing communications are associated with a real-time data service based on at least in part on a QCI, APN, DSCP value, or IP flow data associated with the voice call. In some cases, the QCI includes one or more of a QCI assigned for voice calls, a QCI assigned for bandwidth limited transmitters, a QCI assigned for power limited transmitters, or a QCI assigned for transmitters using coverage enhancement. In some cases, the APN includes one or more of an APN assigned to an IMS, an APN assigned for bandwidth limited transmitters, an APN assigned for power limited transmitters, or an APN assigned for transmitters using coverage enhancement. In some cases, the determining includes receiving one or more of a channel measurement report from the UE or signaling from the UE indicating that the UE is bandwidth restricted and operating in the coverage enhancement mode.

Discontinuous transmission component 1785 may drop one or more downlink packets based on detecting the silence period. In some cases, the dropping one or more downlink packets includes dropping one or more SID packet transmissions to UE.

FIG. 18 shows a diagram of a system 1800 including a device 1805 that supports differential scheduling for real-time communication services and voice activity based half-duplex calling in accordance with various aspects of the present disclosure. Device 1805 may be an example of or include the components of wireless device 1205, wireless device 1305, or a base station 105 as described above, (e.g., with reference to FIGS. 1, 12 and 13). Device 1805 may include components for bi-directional voice and data communications including components for transmitting and receiving communications, including base station communications manager 1815, processor 1820, memory 1825, software 1830, transceiver 1835, antenna 1840, network communications manager 1845, and base station communications controller 1850. These components may be in electronic communication via one or more busses (e.g., bus 1810). Device 1805 may communicate wirelessly with one or more UEs 115.

Base station communications manager 1815 may manage communications with other base station 105, and may include a controller or scheduler for controlling communications with UEs 115 in cooperation with other base stations 105. For example, the base station communications manager 1815 may coordinate scheduling for transmissions to UEs 115 for various interference mitigation techniques such as beamforming or joint transmission. In some examples, base station communications manager 1815 may provide an X2 interface within an Long Term Evolution (LTE)/LTE-A wireless communication network technology to provide communication between base stations 105.

Processor 1820 may include an intelligent hardware device, (e.g., a general-purpose processor, a DSP, a CPU, a microcontroller, an ASIC, an FPGA, a programmable logic device, a discrete gate or transistor logic component, a discrete hardware component, or any combination thereof). In some cases, processor 1820 may be configured to operate a memory array using a memory controller. In other cases, a memory controller may be integrated into processor 1820. Processor 1820 may be configured to execute computer-readable instructions stored in a memory to perform various functions (e.g., functions or tasks supporting differential scheduling for real-time communication services).

Memory 1825 may include RAM and ROM. The memory 1825 may store computer-readable, computer-executable software 1830 including instructions that, when executed, cause the processor to perform various functions described herein. In some cases, the memory 1825 may contain, among other things, a BIOS which may control basic hardware and/or software operation such as the interaction with peripheral components or devices.

Software 1830 may include code to implement aspects of the present disclosure, including code to support differential scheduling for real-time communication services. Software 1830 may be stored in a non-transitory computer-readable medium such as system memory or other memory. In some cases, the software 1830 may not be directly executable by the processor but may cause a computer (e.g., when compiled and executed) to perform functions described herein.

Transceiver 1835 may communicate bi-directionally, via one or more antennas, wired, or wireless links as described above. For example, the transceiver 1835 may represent a wireless transceiver and may communicate bi-directionally with another wireless transceiver. The transceiver 1835 may also include a modem to modulate the packets and provide the modulated packets to the antennas for transmission, and to demodulate packets received from the antennas.

In some cases, the wireless device may include a single antenna 1840. However, in some cases the device may have more than one antenna 1840, which may be capable of concurrently transmitting or receiving multiple wireless transmissions.

Network communications manager 1845 may manage communications with the core network (e.g., via one or more wired backhaul links). For example, the network communications manager 1845 may manage the transfer of data communications for client devices, such as one or more UEs 115.

Base station communications controller 1850 may manage communications with other base station 105, and may include a controller or scheduler for controlling communications with UEs 115 in cooperation with other base stations 105. For example, the base station communications controller 1850 may coordinate scheduling for transmissions to UEs 115 for various interference mitigation techniques such as beamforming or joint transmission. In some examples, base station communications controller 1850 may provide an X2 interface within an LTE/LTE-A wireless communication network technology to provide communication between base stations 105.

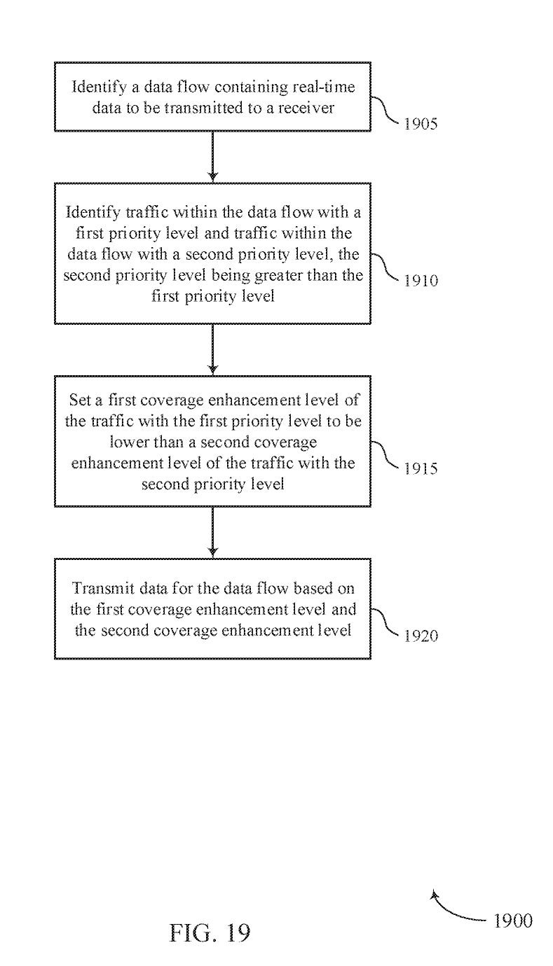

FIG. 19 shows a flowchart illustrating a method 1900 for differential scheduling for real-time communication services and voice activity based half-duplex calling in accordance with various aspects of the present disclosure. The operations of method 1900 may be implemented by a UE 115 or base station 105 or its components as described herein. For example, the operations of method 1900 may be performed by a UE communications manager as described with reference to FIGS. 11 through 13. In some examples, a UE 115 or base station 105 may execute a set of codes to control the functional elements of the device to perform the functions described below. Additionally or alternatively, the UE 115 or base station 105 may perform aspects of the functions described below using special-purpose hardware.

At block 1905 the UE 115 or base station 105 may identify a data flow containing real-time data to be transmitted to a receiver. The operations of block 1905 may be performed according to the methods described with reference to FIGS. 1 through 10. In certain examples, aspects of the operations of block 1905 may be performed by a data identification component as described with reference to FIGS. 11 through 13.

At block 1910 the UE 115 or base station 105 may identify traffic within the data flow with a first priority level and traffic within the data flow with a second priority level, the second priority level being greater than the first priority level. The operations of block 1910 may be performed according to the methods described with reference to FIGS. 1 through 10. In certain examples, aspects of the operations of block 1910 may be performed by a traffic priority component as described with reference to FIGS. 11 through 13.

At block 1915 the UE 115 or base station 105 may set a first coverage enhancement level of the traffic with the first priority level to be lower than a second coverage enhancement level of the traffic with the second priority level. The operations of block 1915 may be performed according to the methods described with reference to FIGS. 1 through 10. In certain examples, aspects of the operations of block 1915 may be performed by a coverage enhancement component as described with reference to FIGS. 11 through 13. Further, the coverage enhancement component may identify that the amount of traffic level on data flow for voice service is low and that a scheduler may be able to accommodate the traffic with the first priority level, and may in such cases temporarily use the same coverage enhancement as the second coverage enhancement level.

At block 1920 the UE 115 or base station 105 may transmit data for the data flow based at least in part on the first coverage enhancement level and the second coverage enhancement level. The operations of block 1920 may be performed according to the methods described with reference to FIGS. 1 through 10. In certain examples, aspects of the operations of block 1920 may be performed by a data transmission component as described with reference to FIGS. 11 through 13.

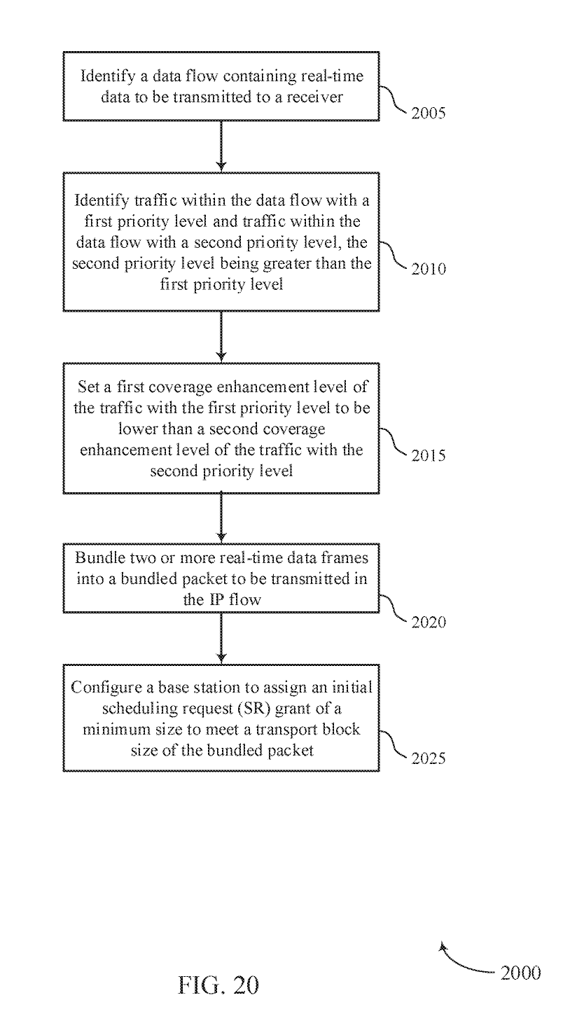

FIG. 20 shows a flowchart illustrating a method 2000 for differential scheduling for real-time communication services and voice activity based half-duplex calling in accordance with various aspects of the present disclosure. The operations of method 2000 may be implemented by a UE 115 or base station 105 or its components as described herein. For example, the operations of method 2000 may be performed by a UE communications manager as described with reference to FIGS. 11 through 13. In some examples, a UE 115 or base station 105 may execute a set of codes to control the functional elements of the device to perform the functions described below. Additionally or alternatively, the UE 115 or base station 105 may perform aspects of the functions described below using special-purpose hardware.

At block 2005 the UE 115 or base station 105 may identify a data flow containing real-time data to be transmitted to a receiver. The operations of block 2005 may be performed according to the methods described with reference to FIGS. 1 through 10. In certain examples, aspects of the operations of block 2005 may be performed by a data identification component as described with reference to FIGS. 11 through 13.

At block 2010 the UE 115 or base station 105 may identify traffic within the data flow with a first priority level and traffic within the data flow with a second priority level, the second priority level being greater than the first priority level. The operations of block 2010 may be performed according to the methods described with reference to FIGS. 1 through 10. In certain examples, aspects of the operations of block 2010 may be performed by a traffic priority component as described with reference to FIGS. 11 through 13.

At block 2015 the UE 115 or base station 105 may set a first coverage enhancement level of the traffic with the first priority level to be lower than a second coverage enhancement level of the traffic with the second priority level. The operations of block 2015 may be performed according to the methods described with reference to FIGS. 1 through 10. In certain examples, aspects of the operations of block 2015 may be performed by a coverage enhancement component as described with reference to FIGS. 11 through 13.

At block 2020 the UE 115 or base station 105 may bundle two or more real-time data frames into a bundled packet to be transmitted in the data flow. The operations of block 2020 may be performed according to the methods described with reference to FIGS. 1 through 10. In certain examples, aspects of the operations of block 2020 may be performed by a packet bundling component as described with reference to FIGS. 11 through 13.

At block 2025 the UE 115 or base station 105 may configure a base station to assign an initial SR grant of a minimum size to meet a transport block size of the bundled packet. The operations of block 2025 may be performed according to the methods described with reference to FIGS. 1 through 10. In certain examples, aspects of the operations of block 2025 may be performed by a scheduling request component as described with reference to FIGS. 11 through 13.

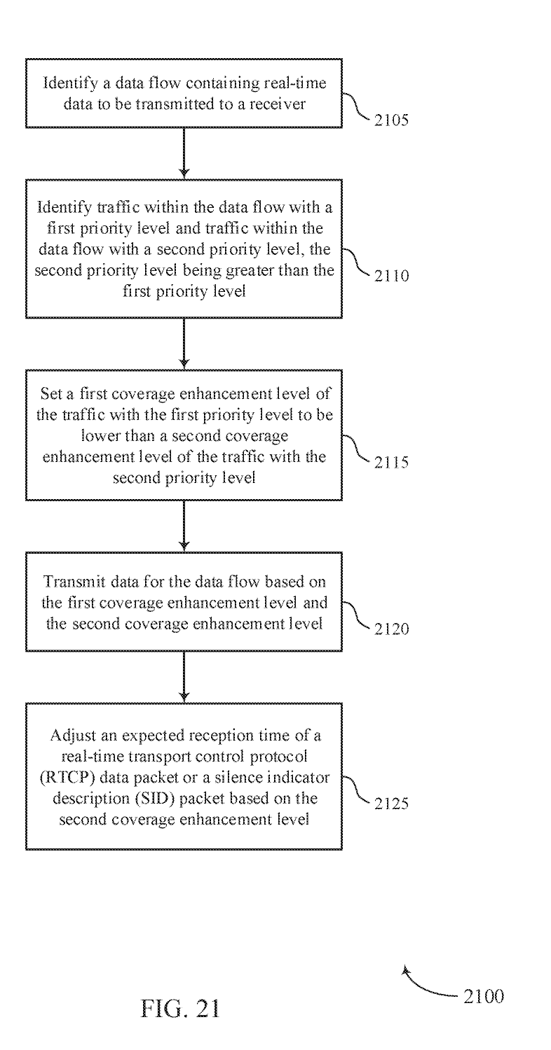

FIG. 21 shows a flowchart illustrating a method 2100 for differential scheduling for real-time communication services and voice activity based half-duplex calling in accordance with various aspects of the present disclosure. The operations of method 2100 may be implemented by a UE 115 or base station 105 or its components as described herein. For example, the operations of method 2100 may be performed by a UE communications manager as described with reference to FIGS. 11 through 13. In some examples, a UE 115 or base station 105 may execute a set of codes to control the functional elements of the device to perform the functions described below. Additionally or alternatively, the UE 115 or base station 105 may perform aspects of the functions described below using special-purpose hardware.

At block 2105 the UE 115 or base station 105 may identify a data flow containing real-time data to be transmitted to a receiver. The operations of block 2105 may be performed according to the methods described with reference to FIGS. 1 through 10. In certain examples, aspects of the operations of block 2105 may be performed by a data identification component as described with reference to FIGS. 11 through 13.

At block 2110 the UE 115 or base station 105 may identify traffic within the data flow with a first priority level and traffic within the data flow with a second priority level, the second priority level being greater than the first priority level. The operations of block 2110 may be performed according to the methods described with reference to FIGS. 1 through 10. In certain examples, aspects of the operations of block 2110 may be performed by a traffic priority component as described with reference to FIGS. 11 through 13.

At block 2115 the UE 115 or base station 105 may set a first coverage enhancement level of the traffic with the first priority level to be lower than a second coverage enhancement level of the traffic with the second priority level. The operations of block 2115 may be performed according to the methods described with reference to FIGS. 1 through 10. In certain examples, aspects of the operations of block 2115 may be performed by a coverage enhancement component as described with reference to FIGS. 11 through 13.

At block 2120 the UE 115 or base station 105 may transmit data for the data flow based at least in part on the first coverage enhancement level and the second coverage enhancement level. The operations of block 2120 may be performed according to the methods described with reference to FIGS. 1 through 10. In certain examples, aspects of the operations of block 2120 may be performed by a data transmission component as described with reference to FIGS. 11 through 13.

At block 2125 the UE 115 or base station 105 may adjust an expected reception time of a RTCP data packet or a SID packet based at least in part on the second coverage enhancement level. The operations of block 2125 may be performed according to the methods described with reference to FIGS. 1 through 10. In certain examples, aspects of the operations of block 2125 may be performed by a RTCP/SID component as described with reference to FIGS. 11 through 13.

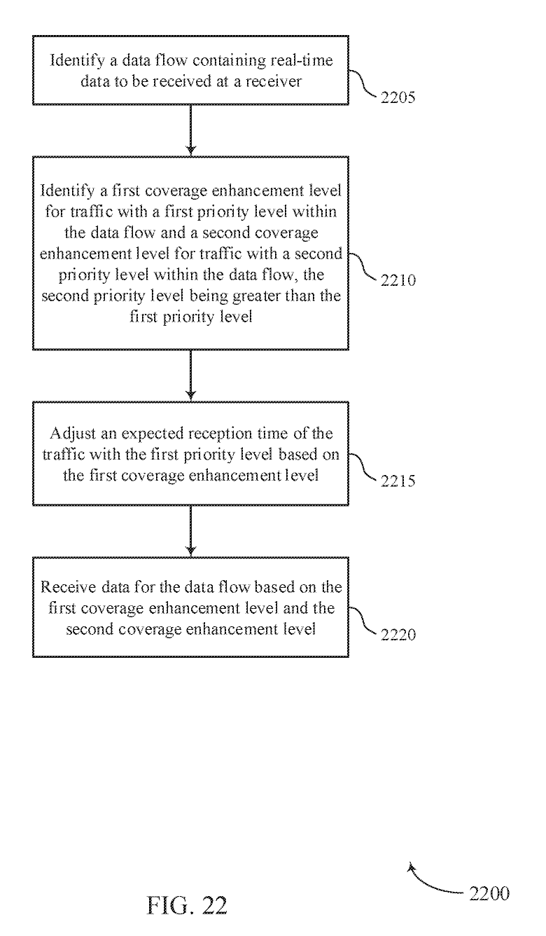

FIG. 22 shows a flowchart illustrating a method 2200 for differential scheduling for real-time communication services and voice activity based half-duplex calling in accordance with various aspects of the present disclosure. The operations of method 2200 may be implemented by a UE 115 or base station 105 or its components as described herein. For example, the operations of method 2200 may be performed by a communications manager as described with reference to FIGS. 11 through 13. In some examples, a UE 115 or base station 105 may execute a set of codes to control the functional elements of the device to perform the functions described below. Additionally or alternatively, the UE 115 or base station 105 may perform aspects of the functions described below using special-purpose hardware.

At block 2205 the UE 115 or base station 105 may identify a data flow containing real-time data to be received at a receiver. The operations of block 2205 may be performed according to the methods described with reference to FIGS. 1 through 10. In certain examples, aspects of the operations of block 2205 may be performed by a data identification component as described with reference to FIGS. 11 through 13.

At block 2210 the UE 115 or base station 105 may identify a first coverage enhancement level for traffic with a first priority level within the data flow and a second coverage enhancement level for traffic with a second priority level within the data flow, the second priority level being greater than the first priority level. The operations of block 2210 may be performed according to the methods described with reference to FIGS. 1 through 10. In certain examples, aspects of the operations of block 2210 may be performed by a traffic priority component as described with reference to FIGS. 11 through 13.

At block 2215 the UE 115 or base station 105 may adjust an expected reception time of the traffic with the first priority level based at least in part on the first coverage enhancement level. The operations of block 2215 may be performed according to the methods described with reference to FIGS. 1 through 10. In certain examples, aspects of the operations of block 2215 may be performed by a coverage enhancement component as described with reference to FIGS. 11 through 13.

At block 2220 the UE 115 or base station 105 may receive data for the data flow based at least in part on the first coverage enhancement level and the second coverage enhancement level. The operations of block 2220 may be performed according to the methods described with reference to FIGS. 1 through 10. In certain examples, aspects of the operations of block 2220 may be performed by a data reception component as described with reference to FIGS. 11 through 13.

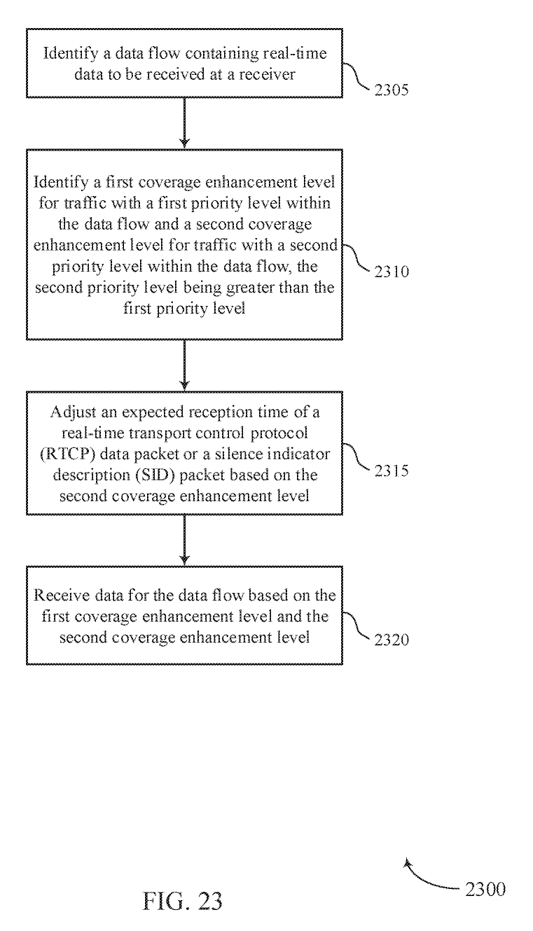

FIG. 23 shows a flowchart illustrating a method 2300 for differential scheduling for real-time communication services and voice activity based half-duplex calling in accordance with various aspects of the present disclosure. The operations of method 2300 may be implemented by a UE 115 or base station 105 or its components as described herein. For example, the operations of method 2300 may be performed by a communications manager as described with reference to FIGS. 11 through 13. In some examples, a UE 115 or base station 105 may execute a set of codes to control the functional elements of the device to perform the functions described below. Additionally or alternatively, the UE 115 or base station 105 may perform aspects of the functions described below using special-purpose hardware.

At block 2305 the UE 115 or base station 105 may identify a data flow containing real-time data to be received at a receiver. The operations of block 2305 may be performed according to the methods described with reference to FIGS. 1 through 10. In certain examples, aspects of the operations of block 2305 may be performed by a data identification component as described with reference to FIGS. 11 through 13.

At block 2310 the UE 115 or base station 105 may identify a first coverage enhancement level and the second coverage enhancement level by receiving signaling that indicates the data flow contains the traffic with the first priority level and the traffic with the second priority level. In some cases, the identifying the first coverage enhancement level and the second coverage enhancement level comprises receiving signaling that indicates the data flow contains the traffic with the first priority level and the traffic with the second priority level. The operations of block 2310 may be performed according to the methods described with reference to FIGS. 1 through 10. In certain examples, aspects of the operations of block 2310 may be performed by a coverage enhancement component as described with reference to FIGS. 11 through 13.

At block 2315 the UE 115 or base station 105 may adjust an expected reception time of the traffic with the first priority level based at least in part on the first coverage enhancement level. The operations of block 2315 may be performed according to the methods described with reference to FIGS. 1 through 10. In certain examples, aspects of the operations of block 2315 may be performed by a coverage enhancement component as described with reference to FIGS. 11 through 13.

At block 2320 the UE 115 or base station 105 may receive data for the data flow based at least in part on the first coverage enhancement level and the second coverage enhancement level. The operations of block 2320 may be performed according to the methods described with reference to FIGS. 1 through 10. In certain examples, aspects of the operations of block 2320 may be performed by a data reception component as described with reference to FIGS. 11 through 13.

It should be noted that the methods described above describe possible implementations, and that the operations and the steps may be rearranged or otherwise modified and that other implementations are possible. Furthermore, aspects from two or more of the methods may be combined.

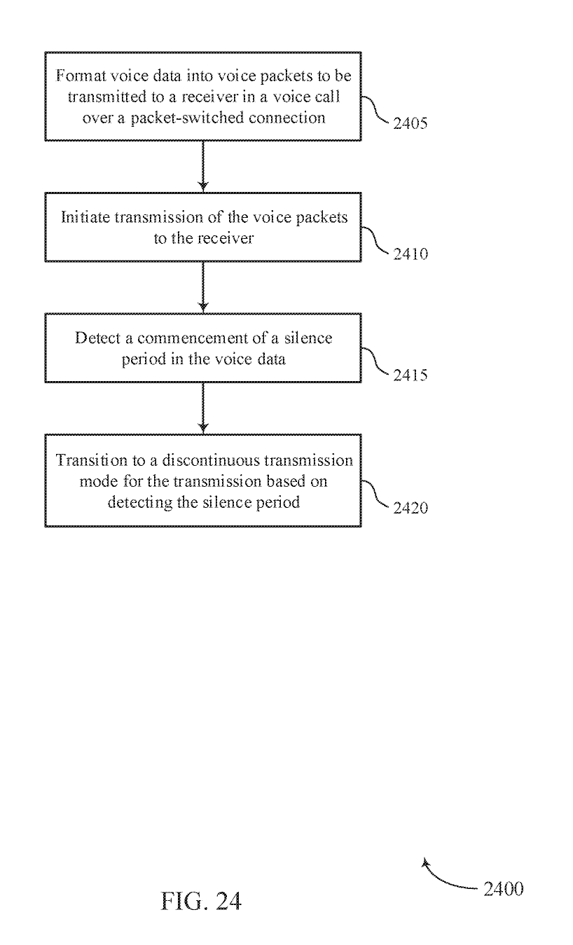

FIG. 24 shows a flowchart illustrating a method 2400 for voice activity based half-duplex calling in accordance with various aspects of the present disclosure. The operations of method 2400 may be implemented by a UE 115 or its components as described herein. For example, the operations of method 2400 may be performed by a UE communications manager as described with reference to FIGS. 11 through 13. In some examples, a UE 115 may execute a set of codes to control the functional elements of the device to perform the functions described below. Additionally or alternatively, the UE 115 may perform aspects the functions described below using special-purpose hardware.

At block 2405 the UE 115 may format voice data into voice packets to be transmitted to a receiver in a voice call over a packet-switched connection. The operations of block 2405 may be performed according to the methods described with reference to FIGS. 1 through 10. In certain examples, aspects of the operations of block 2405 may be performed by a vocoder as described with reference to FIGS. 11 through 13.

At block 2410 the UE 115 may initiate transmission of the voice packets to the receiver. The operations of block 2410 may be performed according to the methods described with reference to FIGS. 1 through 10. In certain examples, aspects of the operations of block 2410 may be performed by a call initiation component as described with reference to FIGS. 11 through 13.

At block 2415 the UE 115 may detect a commencement of a silence period in the voice data. The operations of block 2415 may be performed according to the methods described with reference to FIGS. 1 through 10. In certain examples, aspects of the operations of block 2415 may be performed by a silence detection component as described with reference to FIGS. 11 through 13.

At block 2420 the UE 115 may transition to a discontinuous transmission mode for the transmission based at least in part on detecting the silence period. The operations of block 2420 may be performed according to the methods described with reference to FIGS. 1 through 10. In certain examples, aspects of the operations of block 2420 may be performed by a discontinuous transmission component as described with reference to FIGS. 11 through 13.

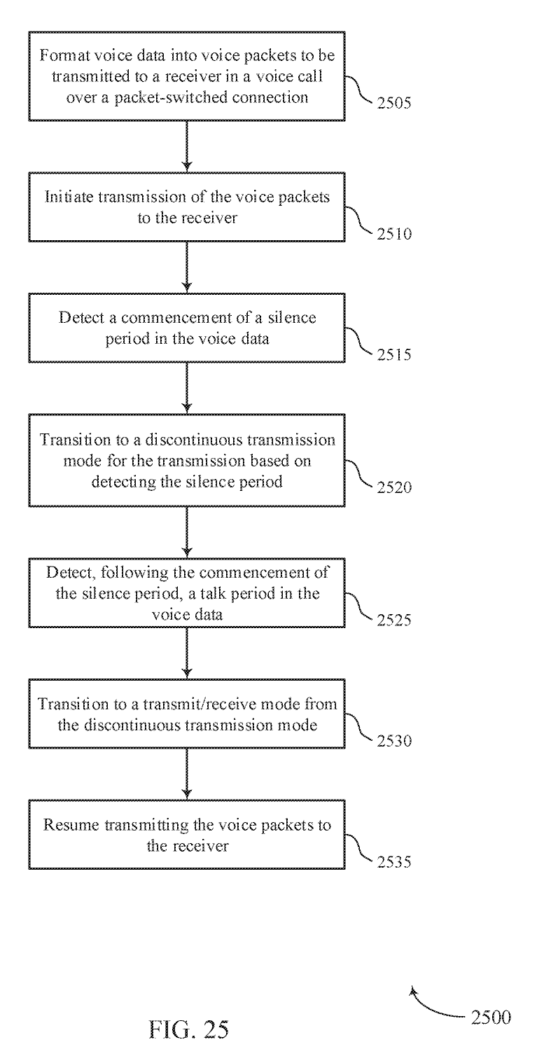

FIG. 25 shows a flowchart illustrating a method 2500 for voice activity based half-duplex calling in accordance with various aspects of the present disclosure. The operations of method 2500 may be implemented by a UE 115 or its components as described herein. For example, the operations of method 2500 may be performed by a UE communications manager as described with reference to FIGS. 11 through 13. In some examples, a UE 115 may execute a set of codes to control the functional elements of the device to perform the functions described below. Additionally or alternatively, the UE 115 may perform aspects the functions described below using special-purpose hardware.

At block 2505 the UE 115 may format voice data into voice packets to be transmitted to a receiver in a voice call over a packet-switched connection. The operations of block 2505 may be performed according to the methods described with reference to FIGS. 1 through 10. In certain examples, aspects of the operations of block 2505 may be performed by a vocoder as described with reference to FIGS. 11 through 13.

At block 2510 the UE 115 may initiate transmission of the voice packets to the receiver. The operations of block 2510 may be performed according to the methods described with reference to FIGS. 1 through 10. In certain examples, aspects of the operations of block 2510 may be performed by a call initiation component as described with reference to FIGS. 11 through 13.

At block 2515 the UE 115 may detect a commencement of a silence period in the voice data. The operations of block 2515 may be performed according to the methods described with reference to FIGS. 1 through 10. In certain examples, aspects of the operations of block 2515 may be performed by a silence detection component as described with reference to FIGS. 11 through 13.

At block 2520 the UE 115 may transition to a discontinuous transmission mode for the transmission based at least in part on detecting the silence period. The operations of block 2520 may be performed according to the methods described with reference to FIGS. 1 through 10. In certain examples, aspects of the operations of block 2520 may be performed by a discontinuous transmission component as described with reference to FIGS. 11 through 13.

At block 2525 the UE 115 may detect, following the commencement of the silence period, a talk period in the voice data. The operations of block 2525 may be performed according to the methods described with reference to FIGS. 1 through 10. In certain examples, aspects of the operations of block 2525 may be performed by a silence detection component as described with reference to FIGS. 11 through 13.

At block 2530 the UE 115 may transition to a transmit/receive mode from the discontinuous transmission mode. The operations of block 2530 may be performed according to the methods described with reference to FIGS. 1 through 10. In certain examples, aspects of the operations of block 2530 may be performed by a discontinuous transmission component as described with reference to FIGS. 11 through 13.

At block 2535 the UE 115 may resume transmitting the voice packets to the receiver. The operations of block 2535 may be performed according to the methods described with reference to FIGS. 1 through 10. In certain examples, aspects of the operations of block 2535 may be performed by a data transmission component as described with reference to FIGS. 11 through 13.

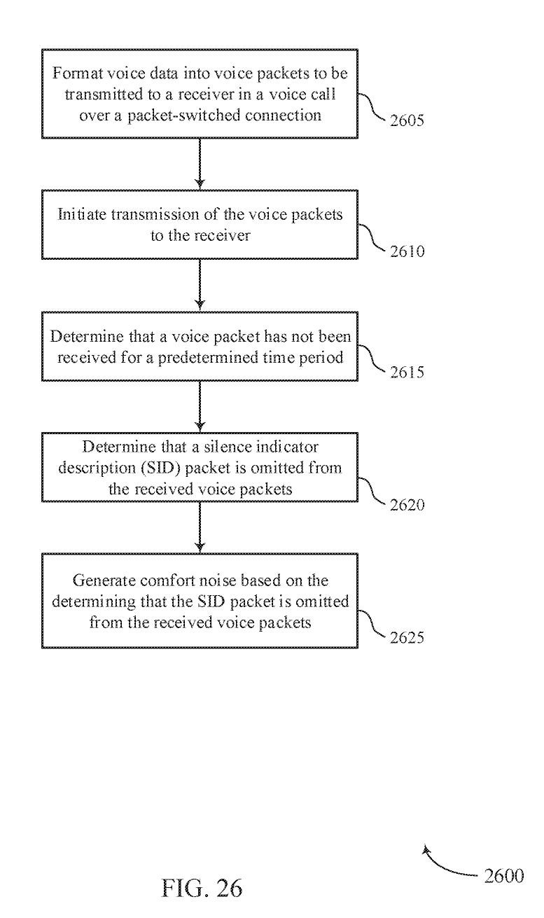

FIG. 26 shows a flowchart illustrating a method 2600 for voice activity based half-duplex calling in accordance with various aspects of the present disclosure. The operations of method 2600 may be implemented by a UE 115 or its components as described herein. For example, the operations of method 2600 may be performed by a UE communications manager as described with reference to FIGS. 11 through 13. In some examples, a UE 115 may execute a set of codes to control the functional elements of the device to perform the functions described below. Additionally or alternatively, the UE 115 may perform aspects the functions described below using special-purpose hardware.

At block 2605 the UE 115 may format voice data into voice packets to be transmitted to a receiver in a voice call over a packet-switched connection. The operations of block 2605 may be performed according to the methods described with reference to FIGS. 1 through 10. In certain examples, aspects of the operations of block 2605 may be performed by a vocoder as described with reference to FIGS. 11 through 13.

At block 2610 the UE 115 may initiate transmission of the voice packets to the receiver. The operations of block 2610 may be performed according to the methods described with reference to FIGS. 1 through 10. In certain examples, aspects of the operations of block 2610 may be performed by a call initiation component as described with reference to FIGS. 11 through 13.

At block 2615 the UE 115 may determine that a voice packet has not been received for a predetermined time period. The operations of block 2615 may be performed according to the methods described with reference to FIGS. 1 through 10. In certain examples, aspects of the operations of block 2615 may be performed by a data reception component as described with reference to FIGS. 11 through 13.

At block 2620 the UE 115 may determine that a SID packet is omitted from the received voice packets. The operations of block 2620 may be performed according to the methods described with reference to FIGS. 1 through 10. In certain examples, aspects of the operations of block 2620 may be performed by a RTCP/SID component as described with reference to FIGS. 11 through 13.

At block 2625 the UE 115 may generate comfort noise based at least in part on the determining that the SID packet is omitted from the received voice packets. The operations of block 2625 may be performed according to the methods described with reference to FIGS. 1 through 10. In certain examples, aspects of the operations of block 2625 may be performed by a RTCP/SID component as described with reference to FIGS. 11 through 13.

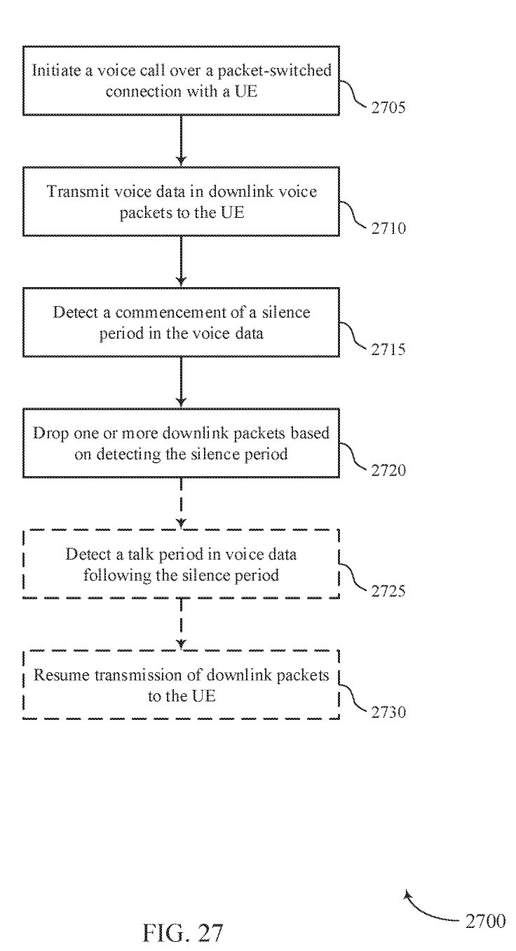

FIG. 27 shows a flowchart illustrating a method 2700 for voice activity based half-duplex calling in accordance with various aspects of the present disclosure. The operations of method 2700 may be implemented by a base station 105 or its components as described herein. For example, the operations of method 2700 may be performed by a base station communications manager as described with reference to FIGS. 15 through 17. In some examples, a base station 105 may execute a set of codes to control the functional elements of the device to perform the functions described below. Additionally or alternatively, the base station 105 may perform aspects the functions described below using special-purpose hardware.

At block 2705 the base station 105 may initiate a voice call over a packet-switched connection with a UE. The operations of block 2705 may be performed according to the methods described with reference to FIGS. 1 through 10. In certain examples, aspects of the operations of block 2705 may be performed by a call initiation component as described with reference to FIGS. 15 through 17.

At block 2710 the base station 105 may transmit voice data in downlink voice packets to the UE. The operations of block 2710 may be performed according to the methods described with reference to FIGS. 1 through 10. In certain examples, aspects of the operations of block 2710 may be performed by a data transmission component as described with reference to FIGS. 15 through 17.

At block 2715 the base station 105 may detect a commencement of a silence period in the voice data. The operations of block 2715 may be performed according to the methods described with reference to FIGS. 1 through 10. In certain examples, aspects of the operations of block 2715 may be performed by a silence detection component as described with reference to FIGS. 15 through 17.

At block 2720 the base station 105 may drop one or more downlink packets based at least in part on detecting the silence period. The operations of block 2720 may be performed according to the methods described with reference to FIGS. 1 through 10. In certain examples, aspects of the operations of block 2720 may be performed by a discontinuous transmission component as described with reference to FIGS. 15 through 17.

At optional block 2725 the base station 105 may detect a talk period in voice data following the silence period. The operations of block 2725 may be performed according to the methods described with reference to FIGS. 1 through 10. In certain examples, aspects of the operations of block 2725 may be performed by a silence detection component as described with reference to FIGS. 15 through 17.

At optional block 2730 the base station 105 may resume transmission of downlink packets to the UE. The operations of block 2730 may be performed according to the methods described with reference to FIGS. 1 through 10. In certain examples, aspects of the operations of block 2730 may be performed by a data transmission component as described with reference to FIGS. 15 through 17.

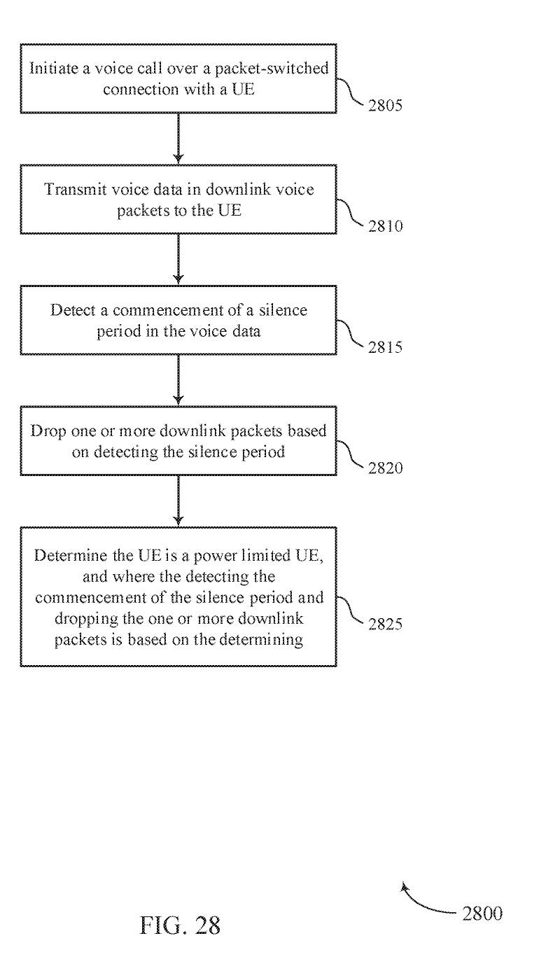

FIG. 28 shows a flowchart illustrating a method 2800 for voice activity based half-duplex calling in accordance with various aspects of the present disclosure. The operations of method 2800 may be implemented by a base station 105 or its components as described herein. For example, the operations of method 2800 may be performed by a base station communications manager as described with reference to FIGS. 15 through 17. In some examples, a base station 105 may execute a set of codes to control the functional elements of the device to perform the functions described below. Additionally or alternatively, the base station 105 may perform aspects the functions described below using special-purpose hardware.

At block 2805 the base station 105 may initiate a voice call over a packet-switched connection with a UE. The operations of block 2805 may be performed according to the methods described with reference to FIGS. 1 through 10. In certain examples, aspects of the operations of block 2805 may be performed by a call initiation component as described with reference to FIGS. 15 through 17.

At block 2810 the base station 105 may transmit voice data in downlink voice packets to the UE. The operations of block 2810 may be performed according to the methods described with reference to FIGS. 1 through 10. In certain examples, aspects of the operations of block 2810 may be performed by a data transmission component as described with reference to FIGS. 15 through 17.

At block 2815 the base station 105 may detect a commencement of a silence period in the voice data. The operations of block 2815 may be performed according to the methods described with reference to FIGS. 1 through 10. In certain examples, aspects of the operations of block 2815 may be performed by a silence detection component as described with reference to FIGS. 15 through 17.

At block 2820 the base station 105 may drop one or more downlink packets based at least in part on detecting the silence period. The operations of block 2820 may be performed according to the methods described with reference to FIGS. 1 through 10. In certain examples, aspects of the operations of block 2820 may be performed by a discontinuous transmission component as described with reference to FIGS. 15 through 17.

At block 2825 the base station 105 may determine the UE is a power limited UE, and wherein the detecting the commencement of the silence period and dropping the one or more downlink packets is based at least in part on the determining. The operations of block 2825 may be performed according to the methods described with reference to FIGS. 1 through 10. In certain examples, aspects of the operations of block 2825 may be performed by a UE capability component as described with reference to FIGS. 15 through 17.

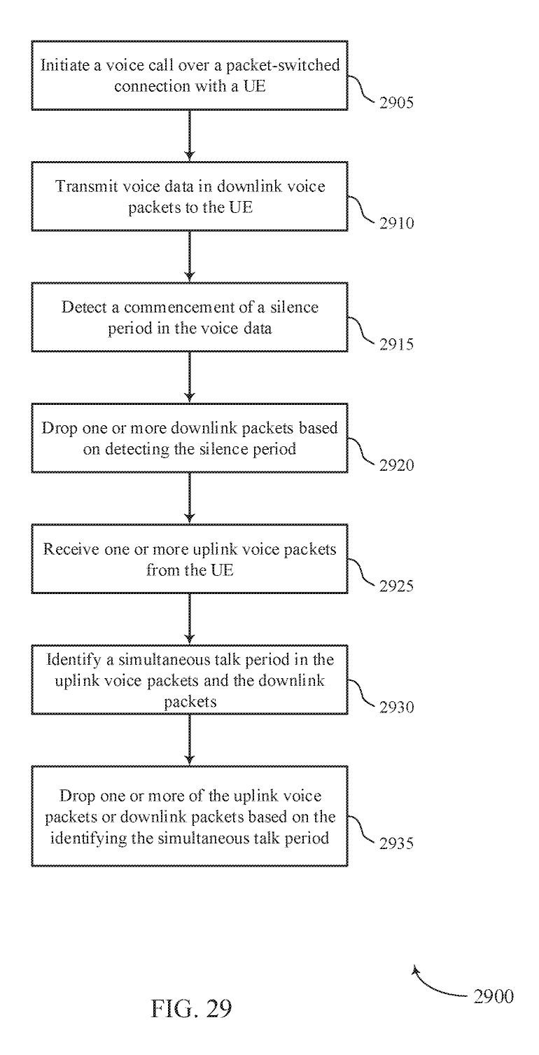

FIG. 29 shows a flowchart illustrating a method 2900 for voice activity based half-duplex calling in accordance with various aspects of the present disclosure. The operations of method 2900 may be implemented by a base station 105 or its components as described herein. For example, the operations of method 2900 may be performed by a base station communications manager as described with reference to FIGS. 15 through 17. In some examples, a base station 105 may execute a set of codes to control the functional elements of the device to perform the functions described below. Additionally or alternatively, the base station 105 may perform aspects the functions described below using special-purpose hardware.

At block 2905 the base station 105 may initiate a voice call over a packet-switched connection with a UE. The operations of block 2905 may be performed according to the methods described with reference to FIGS. 1 through 10. In certain examples, aspects of the operations of block 2905 may be performed by a call initiation component as described with reference to FIGS. 15 through 17.

At block 2910 the base station 105 may transmit voice data in downlink voice packets to the UE. The operations of block 2910 may be performed according to the methods described with reference to FIGS. 1 through 10. In certain examples, aspects of the operations of block 2910 may be performed by a data transmission component as described with reference to FIGS. 15 through 17.

At block 2915 the base station 105 may detect a commencement of a silence period in the voice data. The operations of block 2915 may be performed according to the methods described with reference to FIGS. 1 through 10. In certain examples, aspects of the operations of block 2915 may be performed by a silence detection component as described with reference to FIGS. 15 through 17.

At block 2920 the base station 105 may drop one or more downlink packets based at least in part on detecting the silence period. The operations of block 2920 may be performed according to the methods described with reference to FIGS. 1 through 10. In certain examples, aspects of the operations of block 2920 may be performed by a discontinuous transmission component as described with reference to FIGS. 15 through 17.

At block 2925 the base station 105 may receive one or more uplink voice packets from the UE. The operations of block 2925 may be performed according to the methods described with reference to FIGS. 1 through 10. In certain examples, aspects of the operations of block 2925 may be performed by a data reception component as described with reference to FIGS. 15 through 17.

At block 2930 the base station 105 may identify a simultaneous talk period in the uplink voice packets and the downlink packets. The operations of block 2930 may be performed according to the methods described with reference to FIGS. 1 through 10. In certain examples, aspects of the operations of block 2930 may be performed by a data identification component as described with reference to FIGS. 15 through 17.

At block 2935 the base station 105 may drop one or more of the uplink voice packets or downlink packets based at least in part on the identifying the simultaneous talk period. The operations of block 2935 may be performed according to the methods described with reference to FIGS. 1 through 10. In certain examples, aspects of the operations of block 2935 may be performed by a data identification component as described with reference to FIGS. 15 through 17.

Techniques described herein may be used for various wireless communications systems such as code division multiple access (CDMA), time division multiple access (TDMA), frequency division multiple access (FDMA), orthogonal frequency division multiple access (OFDMA), single carrier frequency division multiple access (SC-FDMA), and other systems. The terms “system” and “network” are often used interchangeably. A code division multiple access (CDMA) system may implement a radio technology such as CDMA2000, Universal Terrestrial Radio Access (UTRA), etc. CDMA2000 covers IS-2000, IS-95, and IS-856 standards. IS-2000 Releases may be commonly referred to as CDMA2000 1×, 1×, etc. IS-856 (TIA-856) is commonly referred to as CDMA2000 1×EV-DO, High Rate Packet Data (HRPD), etc. UTRA includes Wideband CDMA (WCDMA) and other variants of CDMA. A time division multiple access (TDMA) system may implement a radio technology such as Global System for Mobile Communications (GSM).

An orthogonal frequency division multiple access (OFDMA) system may implement a radio technology such as Ultra Mobile Broadband (UMB), Evolved UTRA (E-UTRA), Institute of Electrical and Electronics Engineers (IEEE) 802.11 (Wi-Fi), IEEE 802.16 (WiMAX), IEEE 802.20, Flash-OFDM, etc. UTRA and E-UTRA are part of Universal Mobile Telecommunications system (UMTS). 3GPP Long Term Evolution (LTE) and LTE-Advanced (LTE-A) are new releases of Universal Mobile Telecommunications System (UMTS) that use E-UTRA. UTRA, E-UTRA, UMTS, LTE, LTE-A, and Global System for Mobile communications (GSM) are described in documents from the organization named “3rd Generation Partnership Project” (3GPP). CDMA2000 and UMB are described in documents from an organization named “3rd Generation Partnership Project 2” (3GPP2). The techniques described herein may be used for the systems and radio technologies mentioned above as well as other systems and radio technologies. While aspects an LTE system may be described for purposes of example, and LTE terminology may be used in much of the description, the techniques described herein are applicable beyond LTE applications.

In LTE/LTE-A networks, including such networks described herein, the term evolved node B (eNB) may be generally used to describe the base stations. The wireless communications system or systems described herein may include a heterogeneous LTE/LTE-A network in which different types of evolved node B (eNBs) provide coverage for various geographical regions. For example, each eNB or base station may provide communication coverage for a macro cell, a small cell, or other types of cell. The term “cell” may be used to describe a base station, a carrier or component carrier associated with a base station, or a coverage area (e.g., sector, etc.) of a carrier or base station, depending on context.

Base stations may include or may be referred to by those skilled in the art as a base transceiver station, a radio base station, an access point, a radio transceiver, a NodeB, eNodeB (eNB), Home NodeB, a Home eNodeB, or some other suitable terminology. The geographic coverage area for a base station may be divided into sectors making up only a portion of the coverage area. The wireless communications system or systems described herein may include base stations of different types (e.g., macro or small cell base stations). The UEs described herein may be able to communicate with various types of base stations and network equipment including macro eNBs, small cell eNBs, relay base stations, and the like. There may be overlapping geographic coverage areas for different technologies.

A macro cell generally covers a relatively large geographic area (e.g., several kilometers in radius) and may allow unrestricted access by UEs with service subscriptions with the network provider. A small cell is a lower-powered base station, as compared with a macro cell, that may operate in the same or different (e.g., licensed, unlicensed, etc.) frequency bands as macro cells. Small cells may include pico cells, femto cells, and micro cells according to various examples. A pico cell, for example, may cover a small geographic area and may allow unrestricted access by UEs with service subscriptions with the network provider. A femto cell may also cover a small geographic area (e.g., a home) and may provide restricted access by UEs having an association with the femto cell (e.g., UEs in a closed subscriber group (CSG), UEs for users in the home, and the like). An eNB for a macro cell may be referred to as a macro eNB. An eNB for a small cell may be referred to as a small cell eNB, a pico eNB, a femto eNB, or a home eNB. An eNB may support one or multiple (e.g., two, three, four, and the like) cells (e.g., component carriers). A UE may be able to communicate with various types of base stations and network equipment including macro eNBs, small cell eNBs, relay base stations, and the like.

The wireless communications system or systems described herein may support synchronous or asynchronous operation. For synchronous operation, the base stations may have similar frame timing, and transmissions from different base stations may be approximately aligned in time. For asynchronous operation, the base stations may have different frame timing, and transmissions from different base stations may not be aligned in time. The techniques described herein may be used for either synchronous or asynchronous operations.

The downlink transmissions described herein may also be called forward link transmissions while the uplink transmissions may also be called reverse link transmissions. Each communication link described herein—including, for example, wireless communications system 100 and 200 of FIGS. 1 and 2—may include one or more carriers, where each carrier may be a signal made up of multiple sub-carriers (e.g., waveform signals of different frequencies).

The description set forth herein, in connection with the appended drawings, describes example configurations and does not represent all the examples that may be implemented or that are within the scope of the claims. The term “exemplary” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, well-known structures and devices are shown in diagram form in order to avoid obscuring the concepts of the described examples.

Information and signals described herein may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

The various illustrative blocks and modules described in connection with the disclosure herein may be implemented or performed with a general-purpose processor, a DSP, an ASIC, an FPGA or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope and spirit of the disclosure and appended claims. For example, due to the nature of software, functions described above can be implemented using software executed by a processor, hardware, firmware, hardwiring, or combinations of any of these. Features implementing functions may also be physically located at various positions, including being distributed such that portions of functions are implemented at different physical locations. As used herein, including in the claims, the term “and/or,” when used in a list of two or more items, means that any one of the listed items can be employed by itself, or any combination of two or more of the listed items can be employed. For example, if a composition is described as containing components A, B, and/or C, the composition can contain A alone; B alone; C alone; A and B in combination; A and C in combination; B and C in combination; or A, B, and C in combination. Also, as used herein, including in the claims, “or” as used in a list of items (for example, a list of items prefaced by a phrase such as “at least one of” or “one or more of”) indicates a disjunctive list such that, for example, a list of “at least one of A, B, or C” means A or B or C or AB or AC or BC or ABC (i.e., A and B and C).

Also, as used herein, the phrase “based on” shall not be construed as a reference to a closed set of conditions. For example, an exemplary step that is described as “based on condition A” may be based on both a condition A and a condition B without departing from the scope of the present disclosure. In other words, as used herein, the phrase “based on” shall be construed in the same manner as the phrase “based at least in part on.”

Computer-readable media includes both non-transitory computer storage media and communication media including any medium that facilitates transfer of a computer program from one place to another. A non-transitory storage medium may be any available medium that can be accessed by a general purpose or special purpose computer. By way of example, and not limitation, non-transitory computer-readable media may comprise RAM, ROM, electrically erasable programmable read only memory (EEPROM), compact disk (CD) ROM or other optical disk storage, magnetic disk storage or other magnetic storage devices, or any other non-transitory medium that can be used to carry or store desired program code means in the form of instructions or data structures and that can be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, digital subscriber line (DSL), or wireless technologies such as infrared, radio, and microwave are included in the definition of medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

The description herein is provided to enable a person skilled in the art to make or use the disclosure. Various modifications to the disclosure will be readily apparent to those skilled in the art, and the generic principles defined herein may be applied to other variations without departing from the scope of the disclosure. Thus, the disclosure is not limited to the examples and designs described herein, but is to be accorded the broadest scope consistent with the principles and novel features disclosed herein.

What is claimed is:

1. A method for wireless communication, comprising:
identifying a data flow containing real-time data;
identifying traffic within the data flow with a first priority level and traffic within the data flow with a second priority level, the second priority level being greater than the first priority level;
setting a first coverage enhancement level of the traffic with the first priority level to be lower than a second coverage enhancement level of the traffic with the second priority level; and
transmitting data for the data flow based at least in part on the first coverage enhancement level and the second coverage enhancement level.

2. The method for wireless communication of claim 1, wherein the real-time data comprises voice data of a voice call, and wherein the traffic with the first priority level within the data flow comprises non-voice data and the traffic with the second priority level within the data flow comprises the voice data.

3. The method for wireless communication of claim 2, wherein the traffic with the first priority level comprises one or more of a silence indicator description (SID) packet, real-time transport control protocol (RTCP) data, or in-call signaling.

4. The method for wireless communication of claim 2, wherein setting the first coverage enhancement level comprises:
identifying one or more of an amount of other traffic other than the data for the data flow or a non-voice data metric based at least in part on one or more of: a packet size of the non-voice data, a differentiated services code point (DSCP) value of the non-voice data, finding a match with a partial set of data to deduce the presence of non-voice data, or an out-of-band indication from one or more upper layers of a protocol stack or an application layer; and one or more of: a quality-of-service class identifier (QCI), a user equipment (UE) category, an access point name (APN), an IP address, an IP subnet associated with the non-voice data, a silence indicator description (SID) packet, real-time transport control protocol (RTCP) data, or in-call signaling;
setting the first coverage enhancement level based at least in part on the identified amount of other traffic or the non-voice data metric; and
setting a DSCP value in at least one packet of the traffic within the data flow to indicate that the at least one packet comprises the traffic with the first priority level.

5. The method for wireless communication of claim 2, wherein the first coverage enhancement level has a lower number of repetitions than the second coverage enhancement level.

6. The method for wireless communication of claim 1, further comprising:
bundling two or more real-time data frames into a bundled packet to be transmitted in the data flow; and
configuring a base station to assign an initial scheduling request (SR) grant of a minimum size to meet a transport block size of the bundled packet.

7. The method for wireless communication of claim 1, further comprising:
signaling to one or more receivers of the data flow to indicate the data flow contains the traffic with the first priority level and the traffic with the second priority level, wherein the signaling is transmitted to one or more of a receiving base station or a far-end user equipment (UE) that is to receive the data flow; and
adjusting an expected reception time of a real-time transport control protocol (RTCP) data packet or a silence indicator description (SID) packet based at least in part on the second coverage enhancement level.

8. The method for wireless communication of claim 1, further comprising:
adjusting a size of a receive buffer associated with the data flow to accommodate a delay associated with the first coverage enhancement level or the second coverage enhancement level.

9. The method for wireless communication of claim 1, further comprising:
determining that a user equipment (UE) that is to communicate using the data flow containing the real-time data is a bandwidth restricted UE operating in a coverage enhancement mode or power limited mode, or that the UE is a bandwidth unrestricted UE with a channel quality metric that is less than a threshold value; and
identifying the traffic with the first priority level and the traffic with the second priority level based at least in part on the determining.

10. The method for wireless communication of claim 1, further comprising:
determining that an amount of the traffic of the data flow is below a threshold value; and
setting the first coverage enhancement level to be the same as the second coverage enhancement level.

11. The method for wireless communication of claim 1, further comprising:
opportunistically transmitting a real-time transport control protocol (RTCP) data packet during a period within the data flow that is unoccupied by one or more of a real-time data packet or an indicator description (SID) packet.

12. The method for wireless communication of claim 2, comprising:
detecting a silence period in the voice data in a first direction and a talk period in the voice data in a second direction; and
transitioning to a discontinuous transmission mode based at least in part on detecting the silence period.

13. The method of claim 12, wherein the detecting the silence period comprises:
detecting one or more packets having a specific differentiated services code point (DSCP) value that indicates the one or more packets belong to the data flow associated with the voice call, or having one or more of a specific quality-of-service class indicator (QCI), or a specific access point name (APN), or finding a match with a partial set of data to deduce the presence of the non-voice data, or an out-of-band indication from one or more upper layers of a protocol stack or an application layer.

14. The method of claim 12, further comprising:
signaling that one or more silence indicator description (SID) packets may be omitted upon detecting the silence period, wherein the transitioning to the discontinuous transmission mode comprises:
discontinuing periodic transmissions of one or more of the SID packets or a real-time transport control protocol (RTCP) packet; and
skipping a scheduling request (SR) transmission.

15. The method of claim 12, further comprising:
dropping one or more packets of the first priority level in the first direction or the second direction based at least in part on detecting the silence period.

16. The method of claim 12, further comprising:
dropping one or more packets in the first direction or the second direction having a packet size that is below a threshold value based at least in part on detecting the silence period.

17. The method of claim 12, further comprising:
detecting, following detecting the silence period, a talk period in the voice data;
transitioning to a transmit/receive mode from the discontinuous transmission mode; and
resuming transmitting the voice data.

18. The method of claim 12, further comprising:
determining, based at least in part on one or more of ongoing communication with a base station or on a measured channel quality that the data flow is to be maintained in an absence of receiving one or more voice packets from the base station for a predetermined time period as a result of the discontinuous transmission mode during the data flow;
determining that a silence indicator description (SID) packet is omitted from a plurality of received voice packets;
adjusting an inactivity timer to account for the omitted SID packet; and
generating comfort noise based at least in part on the determining that the SID packet is omitted from the received voice packets.

19. The method of claim 12, further comprising:
receiving a semi-persistent scheduling (SPS) resource allocation for transmitting the voice data;
transmitting, based at least in part on detecting the silence period, an indicator in an SPS uplink transmission that the SPS resource allocation can be released;
receiving a release of the SPS resource allocation; and
transmitting a null data indication in a buffer status report based at least in part on detecting the silence period.

20. The method of claim 2, further comprising:
identifying a simultaneous talk period in the voice data; and
dropping one or more of voice packets of the voice data in a first direction or a second direction based at least in part on detecting the simultaneous talk period.

21. The method of claim 20, wherein dropping the one or more voice packets is based at least in part on one or more of:
a specific differentiated services code point (DSCP) value indicating which voice packets to drop;
a prioritization of voice packets in the first direction relative to voice packets in the second direction for at least one period of time;
a proportion of voice packets in the first direction relative to voice packets in the second direction; and
a random selection of voice packets.

22. A method for wireless communication, comprising:
identifying a data flow containing real-time data;
identifying a first coverage enhancement level for traffic with a first priority level within the data flow and a second coverage enhancement level for traffic with a second priority level within the data flow, the second priority level being greater than the first priority level;
adjusting an expected reception time of the traffic with the first priority level based at least in part on the first coverage enhancement level; and
receiving data for the data flow based at least in part on the first coverage enhancement level and the second coverage enhancement level.

23. The method for wireless communication of claim 22, wherein the real-time data comprises voice data, and wherein the traffic with the first priority level within the data flow comprises non-voice data and the traffic with the second priority level within the data flow comprises the voice data.

24. The method for wireless communication of claim 22, wherein the traffic with the first priority level comprises one or more of a silence indicator description (SID) packet, real-time transport control protocol (RTCP) data, or in-call signaling.

25. The method for wireless communication of claim 22, wherein identifying the first coverage enhancement level and the second coverage enhancement level comprises:
receiving signaling that indicates the data flow contains the traffic with the first priority level and the traffic with the second priority level.

26. The method for wireless communication of claim 22, wherein identifying the first coverage enhancement level and the second coverage enhancement level further comprises:
determining that a user equipment (UE) that is to communicate using the data flow containing the real-time data is a bandwidth restricted UE operating in a coverage enhancement mode or a power limited mode, or that the UE is a bandwidth unrestricted UE with a channel quality metric that is less than a threshold value; and
identifying the traffic with the first priority level and the traffic with the second priority level based at least in part on the determining.

27. The method of claim 22, wherein adjusting the expected reception time comprises:
adjusting an expected reception time of a real-time transport control protocol (RTCP) data packet or a silence indicator description (SID) packet based at least in part on the second coverage enhancement level.

28. An apparatus for wireless communication, in a system comprising:
a processor;
memory in electronic communication with the processor; and
instructions stored in the memory, the instructions being executable by the processor to:
identify a data flow containing real-time data;
identify traffic within the data flow with a first priority level and traffic within the data flow with a second priority level, the second priority level being greater than the first priority level;
set a first coverage enhancement level of the traffic with the first priority level to be lower than a second coverage enhancement level of the traffic with the second priority level; and
transmit data for the data flow based at least in part on the first coverage enhancement level and the second coverage enhancement level.

29. The apparatus for wireless communication of claim 28, further comprising instructions executable by the processor to:
determine that a user equipment (UE) that is to communicate using the data flow containing the real-time data is a bandwidth restricted UE operating in a coverage enhancement mode or power limited mode, or that the UE is a bandwidth unrestricted UE with a channel quality metric that is less than a threshold value; and
identify the traffic with the first priority level and the traffic with the second priority level based at least in part on the determining.

30. An apparatus for wireless communication, in a system comprising:
a processor;
memory in electronic communication with the processor; and
instructions stored in the memory, the instructions being executable by the processor to:
identify a data flow containing real-time data;
identify a first coverage enhancement level for traffic with a first priority level within the data flow and a second coverage enhancement level for traffic with a second priority level within the data flow, the second priority level being greater than the first priority level;
adjust an expected reception time of the traffic with the first priority level based at least in part on the first coverage enhancement level; and
receive data for the data flow based at least in part on the first coverage enhancement level and the second coverage enhancement level.
